(19) United States
(12) Patent Application Publication
(10) Pub. No.: US 2015/0058059 A1
(43) Pub. Date: Feb. 26, 2015

(54) SYSTEMS AND METHODS FOR FACILITATING AND COORDINATING ONLINE AND OFFLINE RELATIONSHIPS

(71) Applicant: KB Cubed, LLC, Los Angeles, CA (US)

(72) Inventors: Dennis Allen Kahan, Los Angeles, CA (US); Ilana Jacqueline Dreicer, Encino, CA (US); David Gregoire, Las Vegas, NV (US); Jessica S. Kimiabakhsh, Beverly Hills, CA (US); Christian Kroger, Las Vegas, NV (US); Robert Joshua Ravanshenas, Los Angeles, CA (US)

(21) Appl. No.: 14/527,658

(22) Filed: Oct. 29, 2014

Related U.S. Application Data
(63) Continuation-in-part of application No. 13/973,612, filed on Aug. 22, 2013.

(51) Int. Cl. G06Q 10/10; H04L 29/06; G06Q 50/00; G06F 3/0484

(52) U.S. Cl. CPC G06Q 10/1095; G06F 3/04842; H04L 65/403; G06Q 50/01
USPC 705/7.19

(57) ABSTRACT

A date posting search is conducted and a first plurality of users are identified to a second user. The posting of a first user is provided to the second user in association with an invitation control. If the invitation control is activated, an invitation is presented to the first user. If the first user accepts the invitation, the second user is notified. A first calendar entry is generated for a calendar of the first user, providing the first user with access to a time and calendar day for the date, at least one image of the second user, and an identifier associated with the second user. A second calendar entry is generated for a calendar of the second user, wherein the second calendar entry provides the second user with access to the time and calendar day for the date, at least one image of the first user, and an identifier associated with the first user.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference in their entirety under 37 CFR 1.57.

### BACKGROUND OF THE INVENTION

1. Field of the Invention

The present invention is related to searching, data matching, and facilitating relationships.

2. Description of the Related Art

Certain conventional dating systems focus on identifying users that may be romantically compatible based on their values, character traits, and locations. Such conventional dating systems tend to require an undue amount of user interaction and tend to result in unsatisfactory numbers of dates.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect provides a posting module that enables a user to specify information for a first date posting, including a first date venue. Optionally, a database is accessed and information related to the first date venue is received. The first date posting is optionally populated with information specified by the first user and at least a portion of the information received via the database. A search engine may identify the first date posting at least partly in response to an action of a second user, and provide the first date posting for display to the second user. A module causes an invitation control to be displayed to the second user in association with the first date posting, detects the second user activating the invitation control, and causes an invitation, to go on a date corresponding to the first date posting of the first user, to be presented to the first user.

An example aspect provides a system configured to facilitate relationships, the system comprising: at least one processing device; a posting module stored in non-transitory memory and executable by the at least one processing device, the posting module configured to enable a user to specify via a first interface information for a date posting, including at least a date venue, calendar day, and time to be included in the date posting; a first application programming interface configured to: access at least a portion of the information specified by a first user for a first date posting, including at least a first date venue specified by the first user, access a database associated with the first date venue specified by the first user, or access a database associated with a third party service provider storing information related to the first date venue, or access the database associated with the first date venue specified by the first user and the database associated with a third party service provider storing information related to the first date venue; receive information related to the first date venue from the database associated with the first date venue, or the database associated with a third party service provider, or the database associated with the first date venue specified by the first user and the database associated with a third party service provider storing information related to the first date venue; a date posting population module, stored in non-transitory memory and executable by the at least one processing device, configured to populate the first date posting with at least a portion of the information specified by the first user and at least a portion of the information received via: the application programming interface from the database associated with the first date venue, or the database associated with a third party service provider, or the application programming interface from the database associated with the first date venue and the database associated with a third party service provider; a search engine configured to identify the first date posting at least partly in response to an action of a second user, and to provide the first date posting, including at least a portion of the information received via the application programming interface, for display to the second user; a module, stored in non-transitory memory and executable by the at least one processing device, configured to: cause an invitation control to be displayed to the second user in association with the first date posting; detect whether the second user activated the invitation control; at least partly in response to detecting that the second user activated the invitation control, cause an invitation, to go on a date corresponding to the first date posting of the first user, to be presented to the first user; detect whether the first user accepted the invitation; at least partly in response to detecting that the first user accepted the invitation: notifying the second user regarding the acceptance, and charging the first user or the second user, or both the first user and the second user.

An example aspect provides a method, comprising: receiving at a computer system from a terminal associated with a first user a date posting, including at least a date venue, a calendar day, and a time to be included in the date posting; accessing, by the computer system, at least a portion of the information specified by a first user for a first date posting, including at least a first date venue specified by the first user, accessing: a database associated with the first date venue specified by the first user, or a database associated with a third party service provider storing information related to the first date venue, or the database associated with the first date venue specified by the first user and the database associated with a third party service provider storing information related to the first date venue; receiving information related to the first date venue from the database associated with the first date venue, or the database associated with a third party service provider, or the database associated with the first date venue specified by the first user and the database associated with a third party service provider storing information related to the first date venue; populating, by the computer system, the first date posting with at least a portion of the information specified by the first user and at least a portion of the information received from: the database associated with the first date venue, or the database associated with a third party service provider, or the database associated with the first date venue and the database associated with a third party service provider; identifying, using a first search engine executing on at least one computer system, the first date posting at least partly in response to an action of a second user; providing the first date posting, including at least a portion of the information received via the database associated with the first date venue, or the database associated with a third party service provider, or the database associated with the first date venue and the database associated with a third party service provider, for display to the second user; causing an invitation control to be displayed to the second user in association with the first date posting; detecting whether the second user activated the invitation control; at least partly in response to detecting that the second user activated the invitation control, causing an invitation, to go on a date corresponding to the first date posting of the first user, to be presented to the first user; detecting whether the first user accepted the invitation; at least partly in response to detecting that the first user accepted the invitation: notifying the second user regarding the acceptance, and charging the first user or the second user, or both the first user and the second user.

An example aspect provides a system comprising: at least one processing device; a first module stored in non-transitory memory and executable by the at least one processing device, the first module configured to enable a user to specify via a first interface information for a date posting, including at least a date venue. Optionally, a first application programming interface is provided that is configured to: access at least a portion of the information specified by a first user for a first date posting, including at least a first date venue specified by the first user. Optionally, the first module is configured to access a database associated with the first date venue specified by the first user, or access a database associated with a third party service provider storing information related to the first date venue, or access the database associated with the first date venue specified by the first user and the database associated with a third party service provider storing information related to the first date venue, or receive information related to the first date venue from the database associated with the first date venue, or the database associated with a third party service provider, or the database associated with the first date venue specified by the first user and the database associated with a third party service provider storing information related to the first date venue. Optionally, second module is provided configured to populate the first date posting with at least a portion of the information specified by the first user and at least a portion of the information received via: the application programming interface from the database associated with the first date venue, or the database associated with a third party service provider, or the application programming interface from the database associated with the first date venue and the database associated with a third party service provider. Optionally, a search engine is provided or utilized that is configured to identify the first date posting at least partly in response to an action of a second user, and to provide the first date posting, including at least a portion of the information received via the application programming interface, for display to the second user. Optionally, a third module is provided, stored in non-transitory memory and executable by the at least one processing device, and configured to: cause an invitation control to be displayed to the second user in association with the first date posting; detect whether the second user activated the invitation control; at least partly in response to detecting that the second user activated the invitation control, cause an invitation, to go on a date corresponding to the first date posting of the first user, to be presented to the first user; detect whether the first user accepted the invitation; at least partly in response to detecting that the first user accepted the invitation: notifying the second user regarding the acceptance, and optionally charging the first user or the second user, or both the first user and the second user.

Optionally, a date posting search is conducted and a first plurality of users are identified to a second user. The posting of a first user is provided to the second user in association with an invitation control. At least partly in response to the invitation control being activated, an invitation is presented to the first user. At least partly in response to detecting that the first user has accepted the invitation, the second user is notified. A first calendar entry is generated for a calendar of the first user, providing the first user with access (e.g., via a link or by direct inclusion in the calendar entry) to a time and calendar day for the date, at least one image of the second user, and an identifier associated with the second user. A second calendar entry is generated for a calendar of the second user, wherein the second calendar entry provides the second user with access (e.g., via a link or by direct inclusion in the calendar entry) to the time and calendar day for the date, at least one image of the first user, and an identifier associated with the first user.

An example aspect provides a matching and calendaring system, comprising: at least one processing device; a posting module stored in non-transitory memory and executable by the at least one processing device, the posting module configured to enable a user to specify via a first interface information for a date posting, including at least date posting information for a first date comprising one or more of: a first date venue; or scheduling information for the first date; or an indication as to whether the first user is to cover expenses for the first date, whether a second user that agrees to be a second participant to the first date is to cover the expenses for the first date, or whether the first user and the second user will each pay for a portion of the first date; or an indication as to whether the first user will be accompanied by friends on the first date. The system may comprise a date posting population module, stored in non-transitory memory and executable by the at least one processing device, configured to populate the first date posting with at least one image of the first user and at least a portion of the date posting information specified by the first user. The system may comprise a search engine configured to identify a first plurality of users, each having a date posting, wherein the first plurality of users includes the first user associated with the first date posting, at least partly in response to an action of the second user, and to provide at least the first date posting, including at least a portion of the date posting information specified by the first user, and at least the image of the first user, for display to the second user. The system may comprise a module, stored in non-transitory memory and executable by the at least one processing device, configured to: cause an invitation control to be displayed to the second user in association with the first date posting; detect whether the second user activated the invitation control; at least partly in response to detecting that the second user activated the invitation control, cause an invitation, to go on the first date corresponding to the first date posting of the first user, to be presented to the first user; detect whether the first user accepted the invitation; at least partly in response to detecting that the first user accepted the invitation: notify the second user regarding the acceptance, and generate a first calendar entry for the first date for a calendar of the first user, wherein the first calendar entry provides the first user with access to: a time and calendar day for the first date; at least one image of the second user; an identifier associated with the second user; an indication as to whether the first user is to cover expenses for the first date, whether a second user is to cover the expenses for the first date, or whether the first user and the second user will each pay for a portion of the first date; an indication as to whether the first user will be accompanied by friends on the first date; generate a second calendar entry for the first date for a calendar of the second user, wherein the second calendar entry provides the second user with access to: the time and calendar day for the first date; at least one image of the first user; an identifier associated with the first user; an indication as to whether the first user is to cover expenses for the first date, whether a second user is to cover the expenses for the first date, or whether the first user and the second user will each pay for a portion of the first date; an indication as to whether the first user will be accompanied by friends on the first date; cause the first calendar entry to appear in the calendar of the first user; cause the second calendar entry to appear in the calendar of the second user.

An example aspect provides a computer implemented method, the method comprising: generating, by a computer system comprising hardware, a first user interface to enable a first user to specify information for a date posting, including at least date posting information for a first date comprising: a first date venue; scheduling information for the first date; an indication as to whether the first user is to cover expenses for the first date, whether a second user that agrees to be a second participant to the first date is to cover the expenses for the first date, or whether the first user and the second user will each pay for a portion of the first date; providing the first user interface for display on a terminal of the first user; populating, by the computer system, the first date posting with at least one image of the first user and at least a portion of the date posting information specified by the first user via the first user interface; at least partly in response to an action of the second user, identifying, by a search engine comprising hardware, a first plurality of users, each having a date posting, wherein the first plurality of users includes the first user associated with the first date posting; providing, by the computer system, at least the first date posting, including at least a portion of the date posting information specified by the first user, and at least the image of the first user, for display to the second user; causing an invitation control to be displayed to the second user in association with the first date posting; detecting, by the computer system, whether the second user activated the invitation control; at least partly in response to detecting that the second user activated the invitation control, causing, by the computer system, an invitation, to go on the first date corresponding to the first date posting of the first user, to be presented to the first user via the user terminal; detecting, by the computer system, whether the first user accepted the invitation; at least partly in response to detecting that the first user accepted the invitation: notifying the second user regarding the acceptance, and generating, by the computer system, a first calendar entry for the first date for a calendar of the first user, wherein the first calendar entry provides the first user with access to: a time and calendar day for the first date; at least one image of the second user; an identifier associated with the second user; an indication as to whether the first user is to cover expenses for the first date, whether a second user is to cover the expenses for the first date, or whether the first user and the second user will each pay for a portion of the first date; generating, by the computer system, a second calendar entry for the first date for a calendar of the second user, wherein the second calendar entry provides the second user with access to: the time and calendar day for the first date; at least one image of the first user; an identifier associated with the first user; an indication as to whether the first user is to cover expenses for the first date, whether a second user is to cover the expenses for the first date, or whether the first user and the second user will each pay for a portion of the first date.

An example aspect provides a non-transitory computer-readable storage medium storing computer executable instructions that when executed by a processor perform operations comprising: generating a first user interface to enable a first user to specify information for a date posting, including at least date posting information for a first date comprising: a first date venue; scheduling information for the first date; an indication as to whether the first user is to cover expenses for the first date, whether a second user that agrees to be a second participant to the first date is to cover the expenses for the first date, or whether the first user and the second user will each pay for a portion of the first date; providing the first user interface for display on a terminal of the first user; populating the first date posting with at least one image of the first user and at least a portion of the date posting information specified by the first user via the first user interface; at least partly in response to an action of the second user, identifying a first plurality of users, each having a date posting, wherein the first plurality of users includes the first user associated with the first date posting; providing at least the first date posting, including at least a portion of the date posting information specified by the first user, and at least the image of the first user, for display to the second user; causing an invitation control to be displayed to the second user in association with the first date posting; detecting whether the second user activated the invitation control; at least partly in response to detecting that the second user activated the invitation control, causing an invitation, to go on the first date corresponding to the first date posting of the first user, to be presented to the first user via the user terminal; detecting whether the first user accepted the invitation; at least partly in response to detecting that the first user accepted the invitation: notifying the second user regarding the acceptance, and generating a first calendar entry for the first date for a calendar of the first user, wherein the first calendar entry provides the first user with access to: a time and calendar day for the first date; at least one image of the second user; an identifier associated with the second user; an indication as to whether the first user is to cover expenses for the first date, whether a second user is to cover the expenses for the first date, or whether the first user and the second user will each pay for a portion of the first date; generating a second calendar entry for the first date for a calendar of the second user, wherein the second calendar entry provides the second user with access to: the time and calendar day for the first date; at least one image of the first user; an identifier associated with the first user; an indication as to whether the first user is to cover expenses for the first date, whether a second user is to cover the expenses for the first date, or whether the first user and the second user will each pay for a portion of the first date.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates an example architecture and operating environment.

FIG. 2 illustrates a first example process.

FIG. 3 illustrates a second example process.

FIGS. 4A-14 illustrate various example user interfaces.

FIG. 15 illustrates a third example process.

FIGS. 16A-19I illustrate additional example user interfaces.

### DETAILED DESCRIPTION OF EMBODIMENTS

Many conventional dating systems suffer from significant drawbacks. For example, many conventional dating systems are subscriber based, and operate primarily on the principle of identifying compatible matches based on subscriber demographics and other characteristics.

By way of illustration, conventional systems typically require that users pay a periodic subscription fee in order to utilize dating services of the dating system. Once a user agrees to be a subscriber, the subscriber then needs to enter subscriber characteristics as well as the characteristics desired in a potential match. For example, a subscriber may indicate subscriber characteristics such as some or all of the following: gender, age, birthdate, sexual preference(s), religion, political leanings, hobbies, etc. Often based solely on subscriber characteristics and the desired characteristics of potential matches, the system identifies potential matches to the subscriber. Such matching is often performed using complex, difficult to maintain algorithms, and requires a large computer-based architecture in order to simultaneously process large numbers of match requests.

Using certain of such conventional dating systems, once potential matches are identified to subscribers, the matching subscribers need to communicate with each other to determine if they wish to actually meet for a date, and if so, to arrange a meeting place and time. Often left unsaid is who will pay for the date (e.g., whether one of the subscribers will pay for both, or whether each subscriber will pay for their portion of the date expenses, etc.), which may result in awkwardness and disappointment when the date actually takes place.

Thus, many conventional approaches are resource intensive, require significant manual interaction between subscribers in order to arrange a date, and require that subscribers pay periodic (e.g., monthly or yearly) fees. Often, using conventional systems, it can take weeks for a subscriber to arrange a single date.

Certain embodiments described herein may address one or more of the foregoing deficits of conventional dating systems.

Certain embodiments described herein facilitate the efficient, quick arrangement of dates, without requiring complex matching algorithms (although such may be used in conjunction with one or more features described herein). Certain embodiments enable a user to post a date, and another user viewing the posting may invite the posting user on the date.

As discussed in greater detail herein, certain embodiments optionally provide a fast match feature that provides a quick centralized mechanism enabling a user to quickly check the status with respect to dates that have been posted by the user. Certain embodiments optionally provide a daily dates user interface that enables a user to quickly identify posted dates that are available on short notice (e.g., for the current day). Certain embodiments optionally provide a “favorite dates” user interface that enables users to specify certain date venues or activity as favorites (without having to specify a particular day or time for a date), wherein matching posted dates are identified and a cumulative listing of matching posted dates is provided for display to the user. Certain embodiments optionally enable a user to define a watch list specifying people, venues and/or activities the user is interested in, but may not have decided to issue an invitation to or for, wherein dates posted by people on the watch list or for venues/activities on the watch list, are presented to the user. The various date and user information identified for presentation to the user may optionally be updated in substantially real-time and/or in response to the user accessing a corresponding user interface (e.g., a fast match, daily dates, favorite dates, and/or watch list user interface).

Certain embodiments are optionally date-centric rather than personality compatibility centric. For example, in certain embodiments, a dating event posting and matching system is provided. A user can specify and post a date event that a user is willing to participate in, and the system may store the date posting/specification for later use as described herein. For example, a user may post a date event category/type, a date event location, and/or a date event time. Optionally, the user may specify the number of date participants (e.g., 2 participants, or more than 2 participants for a group date). By way of illustration, a date event category may be one or more of the following (although it is understood that the following list is by way of example, and is not intended to be comprehensive):

having coffee together;

having a meal together (e.g., breakfast, brunch, lunch, dinner);

having drinks together;

going for a walk together;

attending to a movie together;

attending a concert together;

attending a sporting event together;

participating in a sporting event together (e.g., going golfing together, playing tennis together, going bowling tougher, etc.);

attending a lecture together;

going to a museum together;

going dancing together;

attending a religious service together;

meeting at a recreational facility (e.g., a park, beach, promenade, amusement park etc.).

The specified date event location may be a specific location/facility for the date. For example, if the date event category is “coffee” the user may specify a specific coffee house at a specific address, or may provide a list of specific coffee houses at respective specific addresses, that the user is willing to meet at for a date. By way of further example, the user may simply specify a region or city in which the user is willing to meet for date. Optionally, the user is required to specify a specific location (e.g., a specific coffee house at a specific address or location) to avoid requiring a great deal of interaction to arrange the date venue between prospective participants to a date.

A user may specify one or more specific calendar days and/or time or a range of calendar days and/or a time range. For example, the user may specify that the user is willing to meet on April 22 for a date. By way of further example, the user may specify that the user is willing to meet on April 22, April 26, or April 28 for a date. By way of yet further example, the user may specify that the user is willing to meet between April 22 and April 28. Similarly, the user may specify date time(s) and date length(s) (or ranges thereof) for the respective date days. Optionally, the user need not specify a time at all.

By way of further example, the user may specify a specific event, at a specific date, at a specific time. By way of illustration, the user may specify that the date the user is willing or interested in attending is a Laker v. Clipper game (without specifying which date or time), or may specify that the date the user is willing or interested in attending is a Jan. 14, 2014 Laker v. Clipper game at 8:00 PM at the Staples Center. The user may also post an expiration date/time for the date posting (or a fixed expiration time period may be set by the system), wherein if the date is not accepted by the expiration deadline, the date is to be delisted and no longer considered available.

A user may also specify date payment terms. For example, the user may specify that the user is willing to pay expenses for both parties to the date (e.g., for a meal at a restaurant, tickets to a ticketed event, etc.), or that the user expects that the other party will pay for both parties to the date, or that the user wants each party to the date pay for their share of date. Thus, colloquially, a user may specify that the user will treat the other date participant, expects to be treated by the other date participant, or each participant will pay their own way. Similarly, a user may in addition or instead specify that the user will pay a system related fee for the other date participant (e.g., a fee for issuing a date invitation for the date), or that the user expects the other date participant to pay a system related fee on behalf of the user (e.g., a fee for posting the date).

The user may also specify if one or more people (e.g., friends of the user who will act as “wingman” providing moral support and safety for the user) will be accompanying the user on the date.

Once the user has completed specifying the date, the user may activate a posting control provided via a user interface, and the date posting is recorded in a data store. The date posting may then be searched for, and viewed by others as described elsewhere herein. The date posting may be displayed to other users in association with an invite control, where other users can invite the posting user to go on the posted date by activating the invite control. The posting user may then accept or decline the invitation. Optionally, the inviting user may specify an invitation expiration time (e.g., a date and time, or a number of hours or days from the time the invitation is issued) indicating how long the posting user has to accept the invitation, wherein if the invitation is not accepted before the specified expiration time, the invitation will expire and may no longer be accepted (or a fixed expiration time period may be set by the system as discussed elsewhere herein). This feature may encourage the posting user to accept the date quickly, thereby resulting in more dates between users. Optionally, as discussed elsewhere, the inviting user may issue multiple invitations to several users that have posted substantially the same date, wherein the first user that accepts the invitation will get to go on the date, and the invitations to other posting users will then automatically expire and can no longer be accepted. This feature may also encourage the posting user to accept the date quickly.

Optionally, if the posting user declines the invitation or does not respond to the invitation within a specified period of time, in response to detecting the foregoing, the system may identify to the inviting user similar posted dates and/or posting users, enabling the inviting user to issue an invitation to one of the suggested similar dates/posting users. This feature may encourage the inviting user to quickly invite another user on a date, and reduce the disappointment at not having the first invitation accepted.

Optionally, the expiration time period deadline for a date posting and/or invitation acceptance may be set by the system operator so that it is the same for all or certain classes of users. For example, the expiration deadline may be set to be 24 or 48 hours (or other time period) after the date is posted or the invitation is sent.

Having a fixed expiration time period may offer certain advantages over having a user set the expiration time period. For example, with a preset deadline time period, the user will not have to take the extra step of setting a time period deadline for each date posting or invitation. Further, a viewer of a date posting or a recipient of an invitation will know what the time period deadline is, as it will be the same for each date posting or invitation. In addition, viewers of a date posting or recipients of an invitation will know how much time other viewers of the date posting or recipients of the invitation will have to respond. For example, if a user sends multiple invitations out for the same date and time (e.g., Aug. 1, 2014 at 9:00 am), the invitees have more information at their disposal regarding the amount of time other invitees have to accept the invitation, and may be more motivated to quickly accept the invitation.

Optionally, a timer may be presented to an invitation recipient indicating how much time is left to accept the invitation before the invitation expires. For example, a countdown timer may be provided that numerically countdowns the amount of time remaining until the invitation expires. By way of illustration, the countdown timer may optionally display the number of days, hours, minutes, and/or seconds until the invitation expires. Optionally, in addition or instead, the countdown timer may graphically indicate (e.g., via an animated hourglass or a bar that “fills” with a color to indicate time passage) approximately how much time is remaining until the invitation expires. The countdown timer may be continuously or incrementally updated when being displayed. The timer may be displayed in conjunction with the invitation, in a calendar/datebook entry corresponding to the invitation, via any of the user interfaces discussed herein, or otherwise.

Optionally, rather than having to specify a date posting from scratch, a user may be able to copy and edit a previously posted date, and then post the copied and edited date. This technique may be useful to users, such as users that do not know where or when they wish to go out on a date. For example, when a user views search results for dates that have already been posted (e.g., the results of user text searches, searches conducted to identify dates posted for the current calendar day, or searches conducted to identify popular dates, as described elsewhere herein), the user may see a posted date for an event (coffee at Acme Café, dinner at Acme Dinner, an Adele concert) that the user would like to attend, but may not identify an individual who has posted the date the user would like to invite on the date. Instead of abandoning going on a date to the event, the user can activate a copy control provided via a user interface, and a copy of the date posting will automatically be presented to the user in an editing interface which provides the user with the ability to edit the posting. The user may then change some or all of the date parameters, and post the edited date so that others can view the user's posted date and invite the user to go on the date. The optional date copying feature simplifies the date creation/posting process and provides an alternative method for user to express an interest in an event without inviting another member out on the date.

A date posting may be treated as an expression of interest in going on the specified date, but not an invitation to others that they may accept to establish the date. In other words, the posting user is optionally not obligated to go on a date posted by the user. Instead, another user viewing the posting may express an interest in going on the posted date (e.g., by sending an invitation to the posting user), and the posting user may decide whether or not to go on the date with such user, and activate an accept control to accept the invitation, and optionally a decline control to affirmatively decline the invitation.

Optionally, the system enables a user to post multiple dates via a calendaring system. For example, a user may post 81 dates, one for each local baseball team home game. Optionally, a user needs to manually specify that an invitation is to be sent to a specifically selected posting user, and the system will not automatically send out invitations, and will not automatically send invitations to prospective participants to a date. This provides users with enhanced control over the invitation process.

The user may optionally also provide, via an optional interface, user characteristic data (e.g., profile data) and the desired characteristics in a potential dating partner, which is recorded by the system in association with the user's account. For example, the user may specify some or all of the following: the user's gender, age, sexual orientation, education level, type of car owned, income level, profession, physical characteristics (e.g., height, weight, color hair, color eyes, physical condition, etc.), religion, political affiliation, location (e.g., address, city, neighborhood, region, etc.), race, marital status, drug and drinking habits, self-defined-type (e.g., hipster, sophisticate, music lover, athlete, casual, etc.), contact information (e.g., email address, cell phone number, home phone number, instant messaging address), etc. Similarly, the user may specify such characteristics desired in a potential date. The system may enable the user to upload one or more photographs of the user or other subjects. Optionally, photograph editing tools may be provided (e.g., to crop out extraneous portions of a photograph). The user interface may also be configured to receive from the user a narrative self-description, where, for example, the user can optionally describe his or herself, and what they are looking for in a relationship and potential date.

Optionally, the user interface may enable the user to specify favorite date types and/or venues (e.g., loves to meet for walks, favorite specific restaurants for dates, favorite restaurant-types for dates (e.g., Thai restaurants), favorite specific bars for dates, favorite sporting events for dates, etc.). Some or all of the foregoing user-provided data may be stored by the system in association with a user profile/account.

Optionally, a user interface (e.g., provided by the system or a phone app) may enable the user to indicate which items of the user's profile may be shown to other users, and under what circumstances such user profile information may be shown. Optionally, the system may provide the user with a control via which the user can indicate whether the user wants their dating system profile data to be synchronized with profiles of the user on one or more user-specified other sites (e.g., social networking sites, microblog sites, etc.). If the user indicates the user wants to synchronize the user's profiles, the system will then access profile information from and provide to the selected other sites.

Once a user has posted a date, the dating system may then identify matching other users that have indicated they are interested in or willing to go on a date with the same date specifications (and/or optionally with similar date specifications). For example, the dating event may identify other users that have specified (e.g., via a date posting of their own) that they are willing to go on a date with the same event category, at the same event location, and at the same event date(s)/time(s). For example, the other users may have posted such a date or created a date filter to identify such a date.

Optionally, the system may then present some or all of the matching users to the user. Optionally, the presented matching users may be filtered based at least in part on the user characteristics and/or some or all of the desired characteristics specified by the user, examples of which are described elsewhere herein. For example, if the user specifies that the user is interested in women, with a height between 5′2″ and 5′5″, that live or work within 5 miles of the user's location, the system will filter the presentation to present women with such criteria that have matching date specifications (e.g., as reflected in a date posting by such potential date partners or by a filter set up by such potential date partners). Optionally, not all of the user specified criteria need to be met in order for another user to be identified as a potential date partner. Optionally, the filtering can be performed in whole or in part in response to a user instruction after an initial list of users with matching date specifications are presented to the user. Optionally, some or all of the user characteristics and/or desired characteristics are not used in performing the filtering (e.g., political affiliations, hobbies, etc.).

Optionally, partial matches may be identified and presented by the system. For example, posted dates that match the user's posted date, except that a specified item is slightly different (e.g., the calendar day is slightly different (e.g., 1 or 2 days before or after the date specified in the user's posted date), or the location is slightly different, or is slightly outside a specified geographical area) may be identified and presented to the user. Optionally, partial matches are presented only if there are no full matches. Optionally, partial matches are presented even if there are full matches, but the partial matches are distinguished by being placed lower down in the match results, via color coding, text, an icon, and/or otherwise distinguished.

Information regarding the presented users with matching/similar date specifications may also be provided. For example, some or all of the characteristic information provided by the presented user that the presented user indicated may be provided to others, such as age, hair color, eye color, height, etc., may be presented. Such information may be retrieved by the dating system from an account data store record for the presented user.

The user can then select which of the presented users with matching date specifications the user is willing to go on the date with. The selected user may then be notified that the user is interested in going on the date (with the matching date specifications). The selected user may be presented with some or all of the characteristic information provided by the user that the user indicated may be presented to others. In addition, some or all of the date specifications of the user may be presented to the selected user in conjunction with the notification (e.g., date category(s), location(s), date(s), time(s), etc.). If the selected user indicates (e.g., by activating an accept invitation control) a reciprocal interest in going out with the user (on the date with the matching date specifications), the user is so notified.

At least partly in response to the interest indicated by the selected user, a communication channel is optionally provided via which the user and the selected user can coordinate their date if so desired. For example, the communication channel may be a text messaging, voice, and/or video call channel, enabling the user and the selected user to communicate in real-time. Optionally, the user and/or selected user may select which communication channel they want to use via a menu of communication channels. Optionally, the system records a record of the communication(s), for later retrieval and playback/review by the user, the selected user and/or a system administrator (e.g., to review compliance with usage guidelines, to ensure that safety of participants, etc.). The system may then report some or all of the monitoring results, optionally broken down by user type(s) or otherwise.

The date-centric approach described herein enables the pairing/matching of users who have a general idea of where to go or what to do for a date, but do not have a specific location in mind. For example, a user may post a date indicating that the user is interested in going to a bar or coffee shop in a particular neighborhood. By way of illustration, if the user expresses an interest in coffee shops located in Culver City, the system optionally:
identifies and sends to a terminal of the user pictures/profile information of individuals who have posted dates for coffee shops in Culver City, or
sends to the user terminal information regarding the dates, or
sends to the user terminal both pictures/profile information of the individuals that posted the dates, and information regarding the actual date.

Information regarding a date can be broken down into discrete dates and/or can be combined together in an aggregated list. For example, all coffee shop dates in Culver City can be broken down individually by date, time location etc., or such dates can be combined into logical groups. By way of illustration, dates for the Ace Coffee shop on Washington and Overland in Culver City may be grouped together, and dates for Beta Coffee may be group together, etc.

Optionally, certain embodiments enable users to bypass the traditional invitation/acceptance model of conventional dating sites. For example, as similarly discussed above, if the system determines that two or more users have posted a similar date for an event, the system may automatically, or in response to user instructions, transmit profile information (optionally including photographs) to such users, enabling the users to indicate if they would to attend the event with another user. As similarly discussed above, optionally each user has to indicate they are interested in going on the date with the other user in order for there to be a match. If only one user indicates that they are interested in going on the date, no date will be created. For example, assume that a user “Sara” wants to go to an Adele concert on Sunday night. If there are 10 individuals that are also interested in going to the Adele concert, Sara will receive from the system their photos/profiles, and these 10 individuals will receive Sara's photo(s)/profile. Sara can express positive interest in one or more of the individuals and one or more of the individuals may express positive interest in Sara, and such expressions are received and stored by the system. Optionally, neither party is informed of a match unless both parties express interest. A date may be created with the first matching pair.

Certain embodiments enable users to assume the rolls of host and guest, where a host is a user that agrees to pay for both parties to a date and a guest is the treated party to the date. Optionally, the host may extend a date invitation to a potential guest, and the potential guest may accept or decline the date. As similarly discussed in greater detail elsewhere herein, optionally a user can search for date postings where the posting user has agreed to be a host.

Optionally, a user may issue several invitations, optionally at substantially the same time, to respective different users that have posted dates for the same event, where the first posting user to accept the invitation “wins”, and is matched with the user to go on the date. Optionally, the number of invitations a user may send for a particular event may be limited to a certain threshold (e.g., 2, 5, or 10 invitations).

For example, often there will be a number of individuals that have posted similar or identical dates for a particular event or venue (coffee at the Acme Cafe, an Adele concert, a particular movie), which may be at a specified time. The system enables a user to invite out more than one of these individuals (via their respective date postings) for the particular event or venue. For example a user may invite several other individuals to an Adele concert. In response to the user activating a corresponding “invite” control, the system will transmit to the respective individuals' terminals an invitation (where optionally each recipient receives a respective invitation, which may optionally be unique and have unique decorative features) to the event. The invitation may optionally also indicate that other individuals have also been invited on the same date and that the first individual to accept the invitation will be the individual that goes on the date. This efficient technique enables users to “invite” more than one person to an event, and so increases the likelihood the user will actually go on the date. In addition, because the individuals have been invited to the event (e.g., the Adele concert) know that others have also been invited, there is an incentive to act quickly and accept the invitation (where the acceptance may be transmitted back to the system and on to the user posting the date).

Optionally, the system and/or user may configure variable and/or fixed exclusionary time windows with respect to issuing or accepting invitations. Such an exclusionary window may be configured to prevent or inhibit a user from scheduling two or more dates at the same time or as too close in time (e.g., where the dates may result in an overlap of time). For example, if a user is interested in dates that have been posted by the user or by another person for (1) Acme Bean on Sunday, August 1 at 9:00 AM, (2) Beta Bean, Sunday August 1 at 9:30 AM, (3) Gamma's Coffee, Sunday August 1 at 11:00 AM, and (4) Zed Bean, Sunday August 1 at 2:00 PM, the user may want to make sure that he or she does not go on all of these dates, occurring on the same day.

By way of further example, if a user sends out invitations for dates scheduled within a narrow time period, the dates posted by other individuals, all of the invitations may be accepted thereby causing a timing conflict for one or more dates. By way of yet further example, if a user posts dates that conflict or overlap by calendar date and time, and the user receives multiple invitations for these dates, the user may inadvertently accept multiple invitations thereby causing a timing conflict. By way of still further example, the user may send out invitations for dates posted by other individuals and the user may also receive invitations to dates that the user has posted. The times and calendar dates of the received invitations that have been accepted by the user and the sent invitations that a third party accepts may conflict.

Thus, for example, the exclusionary window may be set to any time frame or within a limited time frame. For example, the exclusionary window may be set to a 24 hour period (to ensure the user does not go on more than one date in a 24 hour period), 4 hours (to enable the user to schedule more than one date each day, but to ensure that a date does not have to be cut short), 1 hour, or other time period. Optionally, a default exclusionary window is set by the system, but the user can override the default exclusionary window via a user interface to set a narrower window or a broader window. The system will receive and store the user specified setting and will use the user specified setting accordingly. Optionally, the user can set, via a user interface, different exclusionary windows (which may optionally be used as default exclusionary windows for future dates) based on type of date, or the location of the date, and/or a desire of the user to have either a great number or a smaller number of dates on the same calendar day.

The system may prevent the user from scheduling two dates within an exclusionary window and/or may generate an alert to the user warning the user of that user's is attempting to schedule date that would result in a violation of the exclusionary window.

Because the system keeps track of invitations and acceptances, the system automatically knows the identity of the first individual to accept the invitation. The system may also detect and notify other individuals who later accept the invitations that they have responded too late, and that the date is no longer available (optionally, such a notification may be sent substantially as soon as someone accepts the date). Individuals that have missed on the particular date opportunity because of a slow response to the invitation will be incentivized to respond more quickly the next time they are invited out.

As noted above, the system keeps track of date postings, invitations and acceptances, and the details of the foregoing. For example, the system may record who has issued and who has accepted a date invitation, the calendar date and time for the corresponding date, the date location, etc. Optionally, the system is configured to prevent or inhibit a user from sending more than one invitation to the same person for the same date. For example, when a user issues an invitation for a date, the system may compare some or all of the related information to other invitations issued by the user to determine if the user is issuing more than one invitation to a given person for the same date. If the user is issuing more than one invitation to a given person for the same date, the system may cause a notification to be presented to the user (e.g., an icon, text, and/or sound notification). By way of illustrative example, if a user issues twenty invitations out on a single night, the user may not recall if the user has already sent someone an invitation, and so may send someone two invitations to the same date. In order to prevent such duplicative invitations, if the system detects that the user is attempting to send the same person two (or more) invitations to the same date, the system may notify the user of the duplication, and will optionally prevent such duplicate invitations from being sent.

Similarly, optionally when the user is sending an invitation for a date to a person, the system may determine if the user has sent invitations to this person in the past for other dates (whether or not the date actually occurred, and whether or not they are for the same location), whether the user already has a scheduled future date with the potential invitee, and/or if the user has actually previously gone on a date with the person (where the date was arranged via the system). For example, the system may compare the identity of the potential invitee with historical records of invitations sent by the user and/or date records of the user to determine if the user had previously sent the potential invitee an invitation for a different date, if the user is already scheduled to go on a date with the potential invitee and/or if the user has gone on a date with the potential invitee. If the system determines that the user has previously issued the potential invitee on a different date, is already scheduled to go on a date, and/or has actually gone on a date with the potential invitee, the system may so notify the user (e.g., via an icon, text, or sound).

For example, if John has sent an invitation to Sally for a date to Beta Leaf for Sunday, September 21 at 9:00 AM, the system may inform John that he has also sent out invitations to Sally in the past (March 31) or for the future (September 26), or that John already has a confirmed date with Sally for September 28. The system can inform John if any past invitations were accepted or if John and Sally went on a date in the past. The system may also provide details regarding any previous invitations or dates (e.g., the calendar date, the location, whether there were other attendees, etc.).

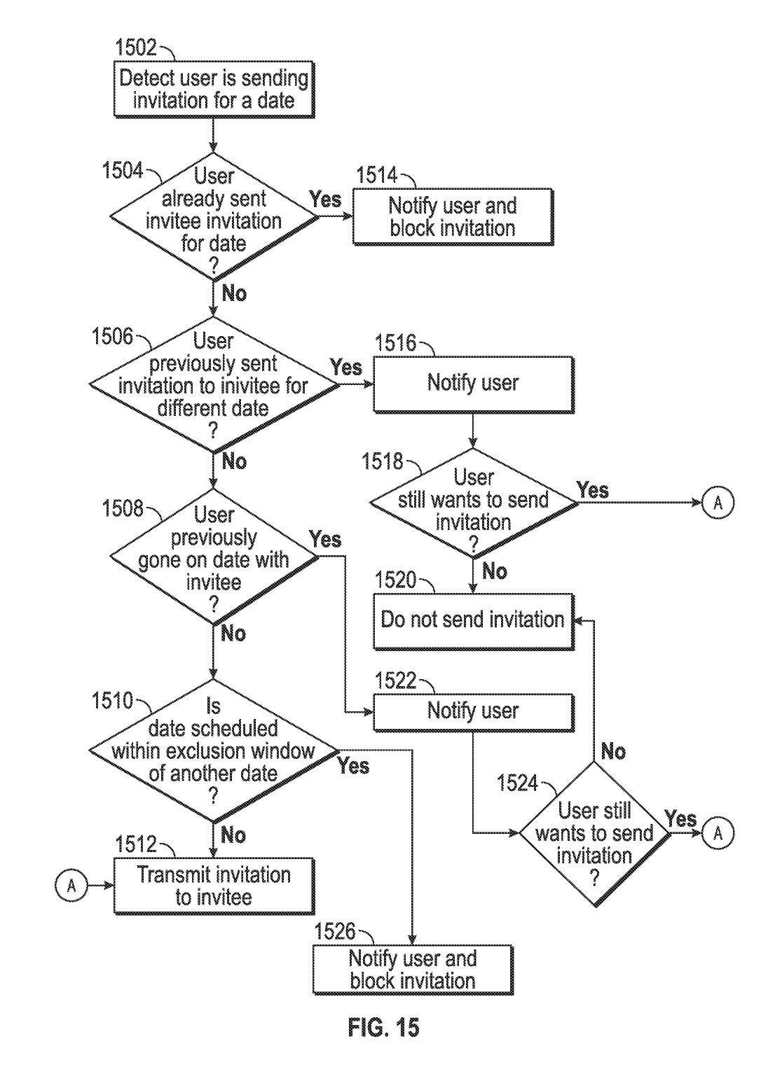

FIG. 15 illustrates an example date invitation issuing process. As discussed elsewhere herein, the process may have fewer or additional steps or states and the steps or states may be performed in a different order. Not all steps or states need to be reached. The various states or steps, or aspects thereof, may be performed via an application executing locally on a user device (e.g., a phone app executing on a mobile phone), via a remote system, or via the application and remote system acting in concert.

Referring to FIG. 15, at block 1502, the user is attempting to issue an invitation for a date to an intended invitee (e.g., using one or more of the techniques and/or user interfaces discussed herein), and the process detects the attempt by receiving an indication that the user is attempt to issue the invitation. In order to avoid a user sending multiple invitations to the same person for the same date, at block 1504 the process accesses a data store that stores indications as to invitations the user has sent, for which dates, to which invitees, and determines whether the user has already sent the intended invitee and invitation for the date. If the process detects that the user has already sent the intended invitee an invitation for the date, the process provides a corresponding notification to the user (e.g., via the user device by way of a text, an icon, an audible alert, or otherwise), and optionally block the invitation from being transmitted to the intended invitee.

If, at block 1504, the process determines that the user has not already sent the intended invitee and invitation for the date, the process proceeds to block 1506. At block 1506, the process determines whether the user had previously sent the intended invitee an invitation for another date. If it is determined that the user had previously sent the intended invitee an invitation for another date (e.g., and the date has not yet occurred), the process proceeds to block 1516, and the user is so notified (e.g., via the user device by way of a text, an icon, an audible alert, or otherwise). This enables the user to avoid inadvertently inviting the same person to two different dates. The notification requests that the user indicate whether the user wants to proceed with sending the intended invitee the invitation or wants to cancel the request to send the invitation (although optionally, the process simply prohibits the user from sending an invitation for a second date to the same invitee). At block 1518, the process determines, from a received user indication, whether the user wants to proceed with sending the intended invitee the invitation or wants to cancel the request to send the invitation. If the user wants to proceed with sending the invitation, the process proceeds to block 1512, and the date invitation is sent to the intended invitee. If the user does not want to proceed with sending the invitation, the process proceeds to block 1520, and the date invitation is not sent to the intended invitee, and the invitation request is cancelled.

If it is determined, at block 1506, that the user has not previously sent the intended invitee an invitation for a previous date, the process proceeds to block 1508, and a determination is made (e.g., via dating records stored in a data store) as to whether the user had previously gone on a date with the intended invitee. If it is determined that the user had previously gone on a date with the intended invitee, the process proceeds to block 1522, and the user is so notified (e.g., via the user device by way of a text, an icon, an audible alert, or otherwise). This enables the user to avoid inadvertently inviting a person to go on a date via the dating system, when the user has already gone on a date with the person. The notification requests that the user indicate whether the user wants to proceed with sending the intended invitee the invitation or wants to cancel the request to send the invitation (although optionally, the process simply prohibits the user from sending an invitation). At block 1524, the process determines, from a received user indication, whether the user wants to proceed with sending the intended invitee the invitation or wants to cancel the request to send the invitation. If the user wants to proceed with sending the invitation, the process proceeds to block 1512 and the date invitation is sent to the intended invitee. If the user does not want to proceed with sending the invitation, the process proceeds to block 1520 and the date invitation is not sent to the intended invitee, and the invitation request is cancelled.

If it is determined, at block 1508, that the user has not previously gone on a date with the intended invitee (e.g., as determined from the dating record data store), the process proceeds to block 1508, and a determination is made as to whether the calendar date and time of the date falls within a pre-specified exclusion window (e.g., accessed from memory by the process) of another date for which the user sent an invitation or for a date that has already been confirmed. The exclusion window may be a default exclusion window with a default time period, or the exclusion window may have been set by the user. If the calendar date and time of the date falls within a pre-specified exclusion window, the process proceeds to block 1526, and the user is so notified and the invitation is blocked from being transmitted to the intended recipient. Optionally, the process may enable the user to override the exclusion window by activating an override control. In this case, if the process detects that the user has overridden the exclusion window by activating the override control, the invitation is transmitted to the intended invitee. Optionally, there may be two exclusion windows, a minimum exclusion window set by the system and a n exclusion window set by the user. Optionally, if the user-set exclusion window is greater than that minimum exclusion window, the user may be enabled to override the user-set exclusion window. However, optionally the process may inhibit the user from overriding the minimum exclusion window to ensure that a minimum amount of time is provided for each date.

Further, because the system tracks and records date postings and acceptances, the system may process such information (e.g., to determine which events/locations/days are popular for dates) and may provide useful related information to users of the system. For example, the system may access date posting information to determine the relative popularity of days for dates. Optionally, using such information, the system may display a calendar for a given week, month, or other time period, with a given day in the calendar coded (e.g., color coded, icon coded, text coded, etc.) to indicate the relative popularity among system users of the given day for a date. By way of further example, if a user is searching for a date at a specific location, the system may determine from stored active date postings which days and/or times are the most popular for date postings for that location and/or rank the relative popularity of dates and/or times (e.g., based at least in part on the quantity dates posted for the location on a given day and/or time).

If color coding is used to reflect popularity, optionally the color or the deepness of shade or intensity of color may be used with respect to the calendar to indicate popularity. Thus, the system may generate and provide for display a form of heat map indicating popularity of calendar days for dates. For example, days that have relatively more posted dates for a venue may be displayed by progressively deeper shades of color, where the day with the greatest number of posted dates for the venue may display the darkest shade and the date with the fewest posted dates will display the lightest shade. Optionally in addition or instead, the system may display a number that indicates the number of posted dates for the location or event for a given calendar day.

The system may provide a user controllable filter interface when viewing the calendar for a specific event, category, or keyword, which enables the user to narrow or expand the number of posted dates displayed to the user by specifying desired filter conditions. The filter may be used to filter the profiles of individuals being presented to the user that the user may potentially be interested in inviting on a date. For example, the filter may enable the user to specify filter criteria including, by way of example, and not limitation, sex, age, religion, marital status, income, profession, education, physical characteristics, drug and drinking habits, and/or other characteristics of a potential date partner.

Optionally, a search engine may be included in or accessed via the system which enables a user to search for dates specified by other users. Optionally, the user may be able to specify one or more search filter conditions (e.g., event category(s), location(s), date(s), time(s), tags, who is to pay for date and/or who is to pay a system fee for posting date or for issuing an date invitation (e.g., the user can specify that the system is to search for posts where the posting user agrees to pay for the date and/or posting user agrees to pay for the system fee associated with inviting the posting user on the date), etc.). Optionally, the search feature may be disabled by the system for a given user if the system determines that the user lacks one or more eligibility criteria to utilize the search feature. For example, a user may optionally be required to post and/or go on a specified number of dates (e.g., 1 date, more than 1 dates, 3 dates, or other number of dates) prior the system enabling the user to access to the search function and/or certain enhanced search function features (e.g., the search filter feature). Optionally, the user does not have to post any date in order to utilize the search engine and perform searches for posted dates. Optionally, the user may be charged a separate fee to use the date search function (e.g., 10 cents/search, 50 cents/day, etc.).

If an eligible user enters a date search query, then the system may identify active posted dates (e.g., dates that have not expired or for which an invitation has not been accepted) that match or substantially match the date search query (e.g., by accessing and analyzing posted date information stored in a system data store, such as a database), and may present some or all of the identified active posted dates to the user. The user may then select one or more of the presented dates, view additional information regarding the date and/or posting user (as similarly described elsewhere herein), and indicate whether or not the user wants to go on the selected date (e.g., by issuing an invitation), as similarly described elsewhere herein.

Optionally, the system may be configured to monitor site use, frequency of use, time spent on site, and other statistics for each user, a subset of users, and/or all users in the aggregate to facilitate determining which dates or types of dates are popular and/or to select advertising promoting a popular date location, wherein the advertising may be presented to users interested in going to dates in the area of the popular date location.

Optionally, the dating system may track and report trends. For example, the system may monitor which date types, locations, days, and/or times are being specified by users in general, and/or for specific user types. For example, the system may monitor which date types, locations, days, and/or times are being specified by women, by men, straight users, gay users, by users within a specified age range (e.g., 18-22, 22-29, 30-35, 35-40, 40-50, 50-60, etc.), within a specified location (e.g., within a specific city, neighborhood, zip code, etc.), having a specified range of income, having a specified profession, by self-defined type(s) (e.g., hipsters, sophisticates, music lovers, athlete, casual, etc.), and/or by type assigned by the system (e.g., hipsters, sophisticates, music lovers, etc.), and combination of user types (e.g., women between the age of 22-29, that are self-described as a hipster), etc.

Optionally, the system may process the monitoring results further to identify (and optionally report to users, administrators, advertisers, etc.) certain information that may be of particular interest. For example, the system may determine a certain number (e.g., 10) of the most popular event categories, locations, dates, and/or times, specified by certain types of users, such as women between the ages of 22-30 in West Hollywood, Calif. This information may, for example, be presented to men between the ages of 22-30 in West Hollywood, Calif. that have indicated they are interested in dating women. Such men may then specify and post dates with similar characteristics, making it more likely that the posted date will be of interest to women between the ages of 22-30 in West Hollywood, Calif., and hence more likely that such women will be presented with and agree to go on the date (e.g., by sending an invitation to the posting user which the posting user may or may not accept at his discretion). Optionally, the most popular date information presented to a user may be modified if the user selects a different geographical area or otherwise specifies different user characteristics. Optionally, the most popular date information may be updated in substantially real time as new date postings are received by the system (e.g., within 1 second, 10 seconds, 1 minute, 10 minutes, 1 hour, or other time frame with respect to a new date posting).

The system may identify the most popular dates and/or users that have posted dates that correspond to the most popular dates in a popular date user interface, which may be provided on, or accessible via a user's dating system home page and/or elsewhere. A viewing user may view the listing of the most popular dates, view information regarding users that have posted dates that correspond to the selected most popular date, and then optionally select a date posted by a specific user. By way of illustration, the ten most popular dates may include brunch at Acme Café on April 30, a Dodger game on April 29, etc. If the user selects the April 29 Dodger baseball game date, the system may display information regarding some or all of the users that posted the date for the April 29 Dodger baseball game. Optionally, the display of the posting users may be filtered and/or ordered in accordance with the viewing user's specification of characteristics desired in a potential match and/or the posting users' specification of characteristics desired in a potential match, as described elsewhere herein. The user can then select a posting user and indicate that the user is interested into going on the April 29 Dodger baseball game date with the selected posting user.

Optionally, the system may automatically identify to a viewing user other users that have posted dates that are scheduled to take place on the current day (or other specified time period, such as the current week or the next 3 days) within a given geographical area (e.g., within a specific city or neighborhood of a viewing user), sometimes referred to herein as “daily dates”. Optionally, the daily date information may be updated in substantially real time as new date postings dates on the current day are received by the system (e.g., within 10 second, 1 minute, 1 hour, or other time frame with respect to a new date posting for the current day). The daily dates user interface may be presented on the user's home page and/or elsewhere.

The daily dates user interface enables a user to quickly identify dates that are available on short notice. A viewing user may view the cumulative listing of the dates that are scheduled to take place on the current day, view information regarding the respective posting users, and then optionally select one or more dates posted by respective users. By way of illustration, dates that are scheduled to take place on the current day may include dinner at Acme Diner, a Lakers basketball game, etc. If the user selects the Lakers basketball game date, the system may display information regarding some or all of the users that posted the Lakers basketball game date for the current day. Optionally, the display of the posting users may be filtered and/or ordered in accordance with the viewing user's and/or the posting users' specification of characteristics desired in a potential match, as described elsewhere herein. The user can then select and indicate (e.g., by issuing an invitation) that the user is interested into going on the Lakers basketball game date for the current day with the selected posting user and the selected user is so notified and may accept or decline the date invitation. If the user extended an invitation to multiple posting users for the same day at the same time or time range, then once a posting user accepts the invitation, the other invitations are cancelled, and the other posting users to whom the invitation was sent are so notified, as similarly discussed above.

Optionally, the system may prompt the user each time (or the first time on a given day) the user accesses the system to indicate if the user is available for a date that day to further encourage users to date.

The daily dates and/or popular dates listings may be ordered and/or filtered using one or more criteria. For example, the daily dates and/or popular dates listings may be filtered to show the most popular dates in a defined area (e.g., a city) or a subarea (e.g., a neighborhood within the a city), and the listing may indicate which activities/events are trending up or down in popularity (e.g., based on the number of corresponding postings, the number of issued invitations, and/or the number of accepted invitations).

The listings of activities/events can be ordered by event name, venue name, keyword, by category, or by time. As similarly discussed elsewhere herein, the daily dates and/or popular dates listings can be further filtered by gender, age, religion, marital status, income, profession, education, physical characteristics, drug and drinking habits and/or other criteria, optionally including other criteria discussed elsewhere herein. The user may then extend an invitation to one or posting users whose posted date remained in the search results. As similarly discussed above, if the user extended an invitation to multiple posting users for the same event, then once a posting user accepts the invitation, the other invitations are cancelled, and the other posting users to whom the invitation was sent are so notified.

Thus, for example, a user that does not know or is uncertain as to what dates to post or does not have a strong preference as to a date activity can access the popular dates or daily dates user interfaces to view respective cumulative lists of popular dates and date posted by other users for the current day.

Optionally, a user may specify one or more favorites date activities or venues, without having to post a date, or specify a calendar day and/or time for a posted date. By way of example, if a user has several favorite bars or restaurants that are located in the vicinity where the user lives, the user can determine the respective name, location, telephone number and categories for such favorite bars or restaurant (which may be optionally accessed via an API as discussed elsewhere herein). At the same time the member can post dates for such favorite bars or restaurants, and can designate them as “Favorites”. By way of further illustration, a user may specify that dinner at the Acme Grill is a favorite date location and activity. The system may then display to the user, on the user's dating system home page or elsewhere, a favorite date section, which provides access to a cumulative listing of matching posted dates. For example, the user can click on or otherwise select the favorite date section, and the system will search for and identify dates (or used stored search results) that other users have posted at that venue and/or for that event, optionally without reference to the day and/or time for the posted dates. The user can then select and view one or more of the posted dates (including the specified date(s)/time(s)), view information regarding the posting user of the selected posted date, and indicate whether the user is or is not interested in the posted date, as similarly described elsewhere herein. A filter may be provided that enables the user to specify filter criteria including, by way of example, and not limitation, sex, age, religion, marital status, income, profession, education, physical characteristics, drug and drinking habits, and/or other characteristics. Thus, using the “favorites” process, the user does not have to constantly post dates for the user's favorite date, but can instead, conveniently provide a single favorite date specification for a favorite event or venue, and at the user's leisure can view corresponding posted dates.

Certain embodiments optionally provide a fast match feature (sometimes termed herein an “instant match”), which may optionally be accessible via a user's home page. The fast match feature provides a quick centralized mechanism that enables a user to quickly check on each date that has been posted by the user. For example, if dates have been posted to 5 Lakers Games, 5 Dodger Games, 5 different restaurants and 10 different bars, the potential matches identified by the system can be easily and quickly reviewed in one location.

Optionally, the dating system may enable users to make reservations at and/or purchase tickets for a date location/event. For example, if a user posts a date for a given location, at a specified date, and time (e.g., brunch at the Acme Café, on Apr. 19, 2013, at 11:00 AM), the system may present a reservation form for Acme Café(which may optionally be accessed via an API as discussed below), optionally prepopulated by the system to correspond to the date venue, date day and time, and/or number of attendees (e.g., to indicate that the reservation is for the Acme Café, for two people, on Apr. 19, 2013, at 11:00 AM), as specified in the date posting. Optionally, the system may enable the user to modify the prepopulated information, or if certain or all the information is not prepopulated, to enter the corresponding date day and time, etc. The user may then activate a booking control to book the reservation and the date location/venue is notified of the reservation (e.g., via the API). Similarly, if the date is for a movie (e.g., the Great Train Robbery, at Acme theaters, on May 1, 2014 at 8:00 PM), the system may enable a user to purchase tickets for the movie.

Optionally, the reservation form/ticket purchase may be provided by the date venue (e.g., the Acme Café) or via a third party reservation/ticket purchase service, optionally accessed via an application program interface (API). Optionally, the reservation/ticket purchase form is presented when the user is posting the date and/or after the date has been accepted by another user. Optionally, a fee is paid to the dating system operator with respect to the reservation/ticket purchase by the date venue, the third party reservation/ticket purchase service, and/or one or more of the users participating on the date. Optionally, a fee is paid to the dating system operator at least partly in the response to the reservation being made. Optionally, a fee is paid to the dating system operator at least partly in the response to determining that the reservation was actually utilized (e.g., the user and the user's date attending the venue as indicated by the venue).

An API may be provided to other sites and data sources as well, such as event/venue review sites, via which event/venue review information may be accessed, some or all of which may be displayed to users. Because data is accessed via an API from a venue or event system, the use of such APIs may reduce or eliminate the possibility of errors with respect to the spelling or entry of a venue, event or activity name/identifier; the specific address of venue, event or activity; the date or time of the venue, event or activity; the telephone number of the venue, event or activity; the cost or cost range for the venue, event, or activity; the correct category for the event (e.g. sports, concert, play, restaurant, bar, night life). In addition, optionally an API may be used to access (and provide to the user) a map showing the precise location of a venue or event. Optionally, venue information (e.g., some or all of the following: name, category, food type, ambiance, address, location, map, operating hours, cost ratings, reviews, etc.) may be stored in a local data store, and the local data store may be utilized to provide date venue information and recommendations to users (as disclosed herein), instead of or in addition to utilizing venue information from a third party data store or from a venue data store.

For example, an initial posting for a Dodger game on Jul. 29, 2013 by a user may include information populated by the system using data accessed via an API from a reliable source's database, such as an authorized ticket seller for the event. Because the reliable source's database typically has the correct spelling, date, time, telephone number and location for Dodger games, as well as the correct category and the price for tickets, seat information, the initial date posting for the Dodger game on Jul. 29, 2013 will include the correct information regarding the foregoing. Optionally, subsequent postings by other users for the Jul. 29, 2013 Dodger game can be made by re-accessing information from the source's database using the API, or by utilizing and replicating the information regarding the Dodger game previously retrieved for the first posting for the new posting.

Optionally, the user does not need to specify a day and/or time for an event being posted, but instead just specifies an event identifier. For example, the user may specify that the event is a Bruins v. Trojans football game, and the system may access the date and/or time information for the game via the API from a reliable source (e.g., a ticket seller database), which will locate the information using the event identifier. An API may be used to access a variety of other types of information for a venue or event. For example, for a restaurant or bar, an API may be used to access information regarding the type of food, the cost, the ambiance, reviews etc. This information may optionally be provided to a user prior to the user posting the date to determine whether the user does or does not want to post the date based at least in part on such information accessed via the API and presented to the user.

Some or all of the data accessed via an API may also be used as tags/metadata stored in association with a date posting. Such tags/metadata may be used to identify matches when performing searches. For example, for the Acme Caférestaurant, the tags may indicate, based on information accessed via the API, that the restaurant is expensive, Italian, and located in Beverly Hills, Calif. If a user then searches for an expensive restaurant located in Beverly Hills or for a posted date taking placed at an expensive restaurant located in Beverly Hills, the search may identify, based on the API-derived tags, the Acme Café(or dates for the Acme Café) in the search results.

Certain embodiments enable a user to search for date events using an electronic map. For example, a user may specify certain date criteria (e.g., sushi restaurants in a specified price category). The user can then select (e.g., via touch using a finger or stylus, or via a mouse) a region of the map, and the displayed map will be zoomed to magnify the selected area and/or provide an icon, text, or other indicator indicating venues that match the date criteria. Certain embodiments enable a user to search for date postings using an electronic map. The user can select (e.g., via touch or via a mouse) a region of the map, and the displayed map will be zoomed to magnify the selected area and/or provide an icon, text, or other indicator indicating date postings for date to occur in the selected area.

Certain embodiments provide an API to the dating system that enables date venues, such as restaurants, movie theaters, or service providers for date venues, such as ticket sites, to provide users with access, via the venues' networked sites (e.g., websites), to some or all of the functionality provided directly to users by the dating system, such as the functionality described elsewhere herein. Thus, for example, the API (providing an interface to the dating system) may access from the dating system date postings for a given date venue (e.g., optionally only active postings that have not expired) and provide such postings to the system hosting the venue site, and the venue site may then display some or all of the date postings.

Users visiting the venue's website or accessing data via the venue's site (e.g., via a browser or a dedicated application, such as phone application or “app”) can then view the date postings, and can issue invitations to the date poster, as similarly described elsewhere herein. Optionally, such invitations may be transmitted from the venue operator's site to the dating system, which may then relay the invitation to the user that posted the date, as described elsewhere herein. Optionally, users may also be enabled to post dates via the operator's site, and the date posting is then communicated to and stored by the dating system. This technique will further encourage users to go on dates, and may benefit the venue operator as the dates are more likely to occur at the operator's venue(s).

Optionally, the venue operator can specify (e.g., via a user interface provided for display by the dating system or otherwise) what type of information is to be provided by the dating system via the API. For example, the venue operator may specify that only date postings for the venue are to be provided. If, for example, the venue operator operates multiple venues (e.g., a coffee shop chain), the venue operator can specify that only date postings for venues of the operator in the neighborhood of the user accessing the venue operator's site are to be provided. By way of illustration, the user's location may be estimated or determined by the operator's site and/or the dating system based on location information provided by the user's internet protocol address, by GPS, WiFi, or cell tower information provided by the user's terminal (e.g., a mobile cell phone), via information provided by the user (e.g., when registering for an account with the venue operator or the dating system), or otherwise. At least partly in response to the venue operator's specifications (which may specify a city, neighborhood, area code, distance, etc.), the dating system may then identify venues of the venue operator within the same area code, neighborhood and/or city as the user, or within a specified distance from the user, and provide active date postings for such identified venues. Thus, users in different locations accessing the venue operator's website may be presented with different date postings, even when viewing the operator's website from their respective terminals at the same time.

Optionally, the dating system may identify and provide all date postings (or all active date postings) for the venues operated by the operator, and the operator system can filter the date postings and display the postings that meet the operator's filter conditions (e.g., display only date postings for the operator's venues within 5 miles of the user).

Optionally, the API may enable users to conduct searches for date postings, as similarly discussed elsewhere herein, wherein the searches are conducted via a search interface presented via the venue operator's site. Optionally, the search engine will only return date postings specifying the operator's venue(s). Thus, the search engine may be configured to automatically filter out date postings for venues owned by a different operator from the search results, prior to providing the search results for display to the user.

Optionally, instead of or in addition to providing an API to enable the operator to receive data from, and provide data to the dating website, a link (which may appear as text and/or as an icon) may be provided via an interface (e.g., a webpage) presented by the venue operator's site, which can activated by the user (e.g., by clicking on or touching the link), causes the user's browser or other application to be navigated to an interface hosted by the dating system (e.g., a user's home page as described elsewhere herein). The interface hosted by the dating system may optionally be branded with the venue's brand and/or may be configured to appear as if it were part of the vendor's site. This technique may, in certain circumstances, be easier for the venue operator to implement as compared to the use of the API.

Optionally, the dating system may present advertisements to a user based at least in part on the user's characteristics (e.g., gender, age, religion, political leanings, hobbies, location, etc.) and/or on some or all of the specifications of a date(s) posted by the user and/or on some or all of the specifications of a date(s) accepted by the user. For example, if a date specifies that the date is for a walk on a beach boardwalk, the system (or a third party advertisement server system or other system) may select one or more advertisements for one or more venues (e.g., coffee house, restaurant, bookstore, etc.) on and/or adjacent to (e.g., within a specified distance from) the boardwalk. Optionally, the system operator may be paid for the presentation of a given advertisement by the advertiser and/or an ad server operator.

Optionally, the system may host one or more blogs accessible by users. For example, the system operator may host a blog that describes new features, publically addresses complaints about the system, provides information on how many dates users have gone on in a given period of time, etc. Optionally, the system may enable a given user to maintain and edit their own blog, which may be hosted by the system and may accessible to other users.

Certain embodiments optionally do not require subscription fees to be paid in order to utilize features of a dating system (although optionally subscription fees may be charged). Rather, a user may pay a fee for dates actually facilitated by the system (e.g., arranged and/or completed). For example, the user (and/or the other date participant) may pay a fee (e.g., optionally a small fee, such as about $1.00, $2.00, or other amount) for each date the user posts, for each date to which a subscriber agrees to participate in, and/or for each date which actually takes place. Optionally, the user is not charged for posting a date but is charged if the user actually accepts an invitation to go on a date or has an invitation accepted to go on a date. This approach greatly lowers the financial barrier for utilizing the dating services, as the user does not have to commit to paying a periodic fee. Further, users are more likely to use such embodiments of the dating system as they only need to pay if they are successful in arranging a date. Optionally, the user is not charged any fee for utilizing the dating system dating functionality and so may use issue date invitations, accept date invitations, or post dates without any fee.

Optionally, if one user or both users that have agreed to go on a date indicate that the date was cancelled (e.g., via a user interface provided by the dating system or via a dedicated application, such as a phone app), the cancellation indication is received and stored by the dating system, and the fee paid by the user(s) is refunded (e.g., credited to the user's account). Optionally, if a user cancels more than a threshold number of dates or more than a threshold number of dates over a specified period of time (e.g., 12 date cancellations in a year) as determined by the dating system from the stored data cancellation indications, the user will not receive further refunds via the dating system or from the dating system operator for future cancelled dates, and the user may be so notified by the system. Optionally, subsequently to the user being prevented from receiving further refunds for date cancellations, if the system determines from the stored data cancellation indications that the user has cancelled less than a threshold number of dates in a subsequent period of time (e.g., correcting their past bad behavior with respect to cancelling dates), the system may enable the user to again receive refunds for cancelled dates.

Certain example embodiments will now be discussed with reference to the figures.

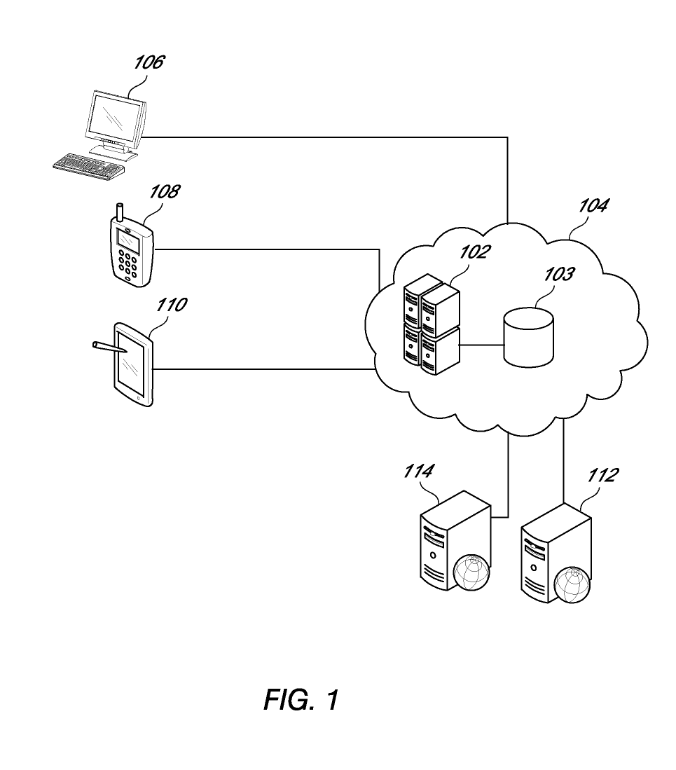

Referring now to FIG. 1, an example system architecture and environment is presented. An example dating system 102 (which may be optionally cloud based) includes one or more servers and one or more data stores 103 (e.g., databases). For example, the date stores 103 may store user account information (e.g., name, contact information (e.g., email, wireless phone number, physical address/location, etc.)), profile information, date postings and related information, date posting result information (e.g., was a given date accepted and/or completed, did the date posting expire without the date being accepted and/or occurring, ratings given by one date participant with respect to the other date participant (e.g., by giving the other date participant a point, grade or star rating indicating how good the other date participant was), etc.), user-defined date filters, date search queries of a given user, an identification of posted dates viewed by a given user, etc. The dating system 102 may be coupled via a network 104 (e.g., a wired and/or wireless network, such as wide area network (e.g., the Internet), an intranet, or other network) to one or more user terminals 106, 108, 110 which may be associated with users posting and/or accepting dates. The dating system 102 may also be coupled to one or more third party reservation systems 112 and/or one or more advertisement server systems 114. The dating system 102 may perform some or all of the functions described herein.

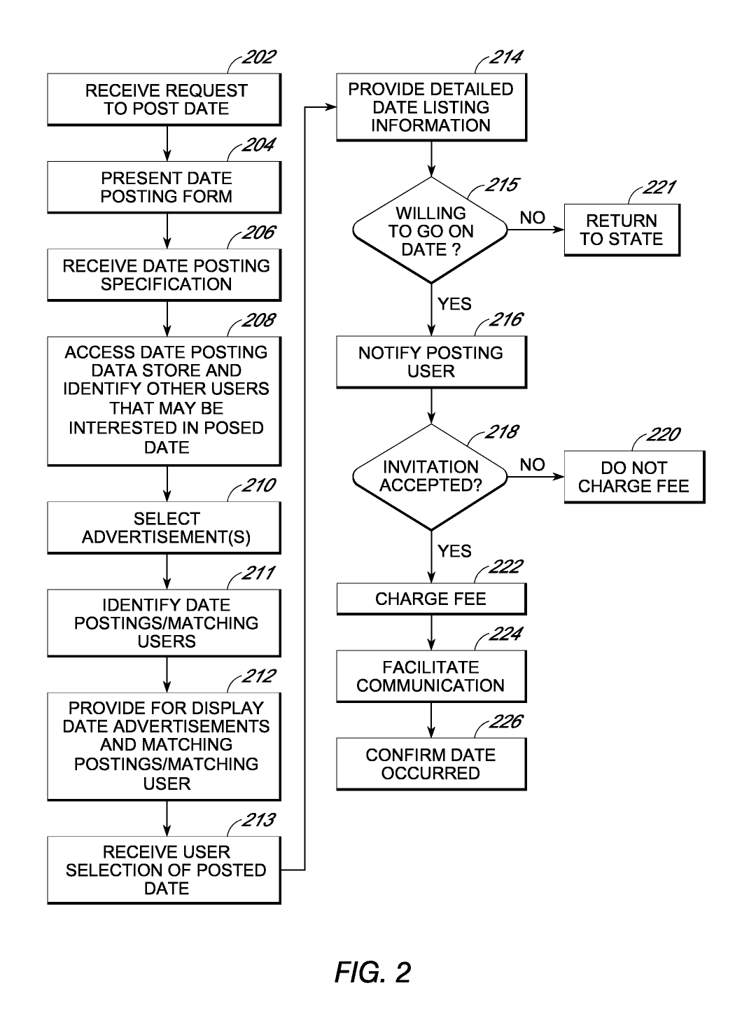

FIG. 2 illustrates an example dating process. As noted elsewhere herein, the process may include fewer or additional states, and the states may occur in a different order. At state 202, a dating system receives a user request to post a date. At state 204, a date posting form is provided for display on the user's terminal. As similarly discussed herein, the user may specify the date (e.g., date event category/type, date event location, date event time, who pays, deadline to accept date, etc.) via the posting form. At state 206, the system receives and stores the user's date specification. At state 208, the system identifies other users that may be interested in the posted date. For example, the system identify other users that have posted dates with the same and/or similar specifications, that have defined a filter to locate dates with the same and/or similar specifications, that have searched for dates with the same and/or similar specifications, etc. At state 210, the system and/or a third party advertisement server selects advertisements, optionally based at least in part on the date specification and/or on certain characteristics of the user. Optionally, the system transmits some or all of the date specification and/or certain characteristics of the user (optionally anonymized to obscure the identity of the post user) to the third party advertisement server to enable the third party advertisement server to select correspond, appropriate advertisements.

At state 211, the system identifies to the posting user other date posting(s) that match that of the posting user, as similarly described elsewhere herein. At state 212, the system provides the selected advertisements and matching postings to the user. If the user selects one of the matching posted dates, then at state 213, the system receives the selection of the matching posted date. At state 214, the system access and provides for display detailed information regarding the selected posted date. For example, the system may provide information regarding the date location, date, time, whose paying, etc. and/or characteristic information that the user that posted the selected date indicated may be shared with others. For example, a user may wish to be anonymous and so may specify that the user's actual name is not to be displayed in a date listing.

At state 215, the system receives an indication from the user as to whether the user is willing to go on (or considering going on) the selected posted date. If the user indicates the user is not interested in the selected posted date (e.g., by activating a “not interested” control, by navigating away from the selected posted date, or otherwise), the process may return to state 211, and the user may select another posted date. If the user indicated an interest in going on the selected posted date (e.g., by activating an “interested” or “invite” control or otherwise), at state 216 the user that posted the selected post date is so notified. For example, the posting user may be notified of the viewing user's interest by transmitting the invitation to the posting user by email, SMS, MMS, a dedicated phone application, a page presented in a browser, or otherwise.

At state 218, a determination is made as to whether the posting user accepted the invitation. Optionally, if the posting user did not accept the invitation to go on the date, the process proceeds to state 220, and the user(s) are not charged a fee with respect to the date. Optionally, if the posting user did accept the invitation to go on the date, the process proceeds to state 222, and the user(s) are charged a fee with respect to the date.

At state 224, a user interface is provided enabling the user and the invited posting user to communicate (optionally directly) to coordinate the date. For example, the system may provide a text, voice, and video-voice chat/call capabilities enabling the users to communicate in real time to coordinate the date as needed or desired. At state 226, the system optionally confirms whether the users actually went on the date (e.g., based on input from one or both users, from the venue the date took place, or otherwise).

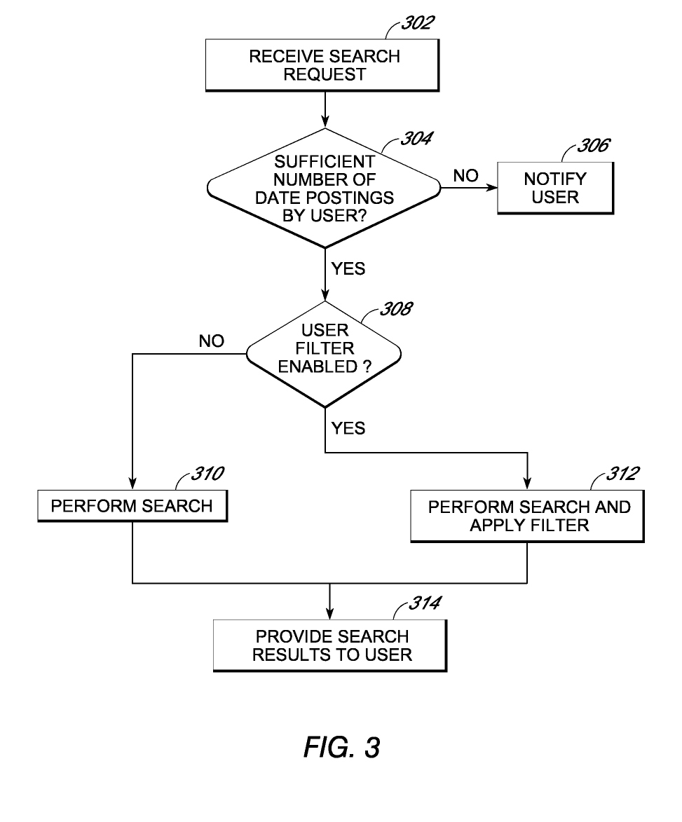

FIG. 3 illustrates an example date search process, which may optionally be performed using system 102 illustrated in FIG. 1 and optionally with a third party search system (which may be hosted on one or more remote servers). At state 302, a search request is received from a user via a user terminal. For example, the search request may be in the form of a text query including one or more search terms entered by the user into a search field and/or may be in the form of a filter where the user checks off desired and/or not desired date characteristics. Optionally, the system 102 may be configured to disable or limit a user's ability (e.g., limit the number and/or type of search terms or search tools) to perform a search for a date unless the user has posted at least a threshold number of dates and/or based on other criteria. In such an embodiment, at state 304, a determination is made as to whether the user has posted the threshold number of dates (which may be time limited, in that the user needs to have posted a threshold number of dates within a specified period of time, such as the last year or other time period). If a determination is made that the user has not posted a sufficient number of dates, the process proceeds to date 306, and the user is so notified. The system may be configured to determine and identify to the user how many more dates the user needs to post in order to utilize (or fully utilize) the date search facility, to thereby encourage and incentivize the user to post dates. Optionally, the determination as to whether the user has posted the threshold number of dates is posted before enabling the user to submit a search query (e.g., where a search field is shown in a greyed-out state to indicate that it is not functional).

If, at state 304, a determination is made that the user has posted the threshold number of dates, the process proceeds to state 308, and a determination is made as to whether the user has also specified and enabled a filter configured to filter out dates posted by users that lack certain characteristics specified by the filter as being needed, or have certain characteristics specified by the filter as being unacceptable. If the user has not specified and enabled the filter, then the process proceeds to state 310, and the search is performed without the filter. If the user has specified and enabled the filter, then the process proceeds to state 312, and the search is performed with the filter. The search engine may, for example, look for and identify posted dates whose associated key words match or partially match those of the search query. The search results are then ordered according to relevancy (closeness of match) or otherwise, and reported to the user. As discussed elsewhere herein, the search results may include detailed information regarding the matching posted dates and regarding the user that posted to the matching date. A control may be provide in conjunction with a given search result enabling the searching user to send an invitation to the user that posted the corresponding date in the search results.

Certain example user interfaces will now be described. The user interfaces may be provided via a website hosted by a dating system, a dedicated phone or computer application, or otherwise.

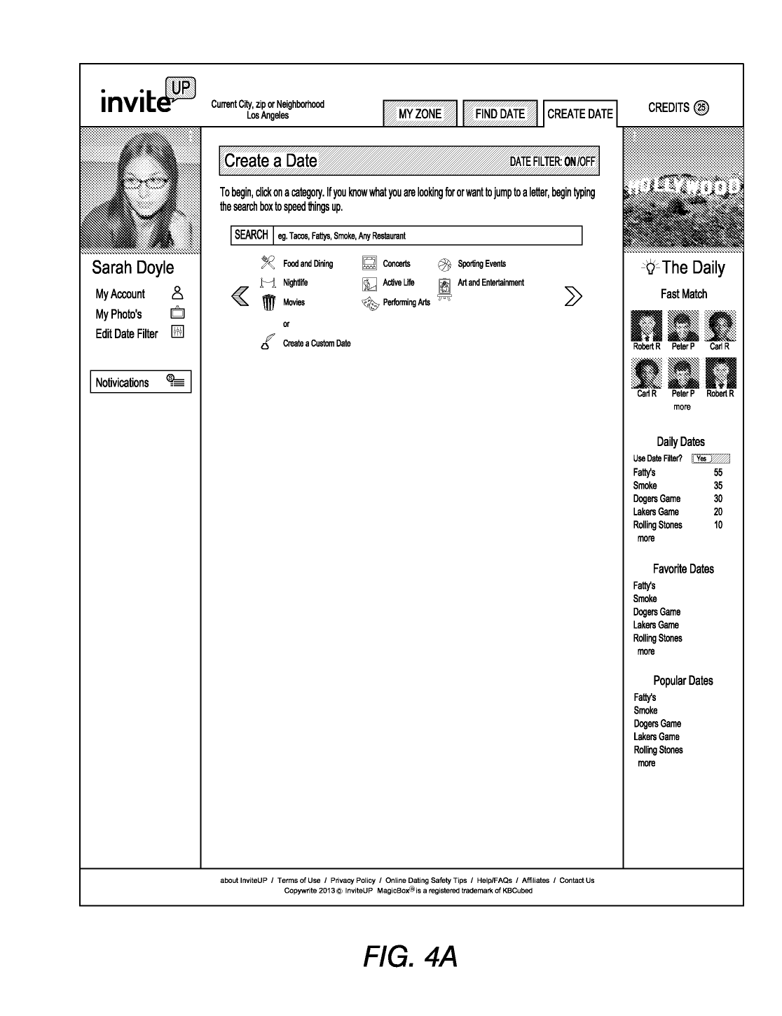

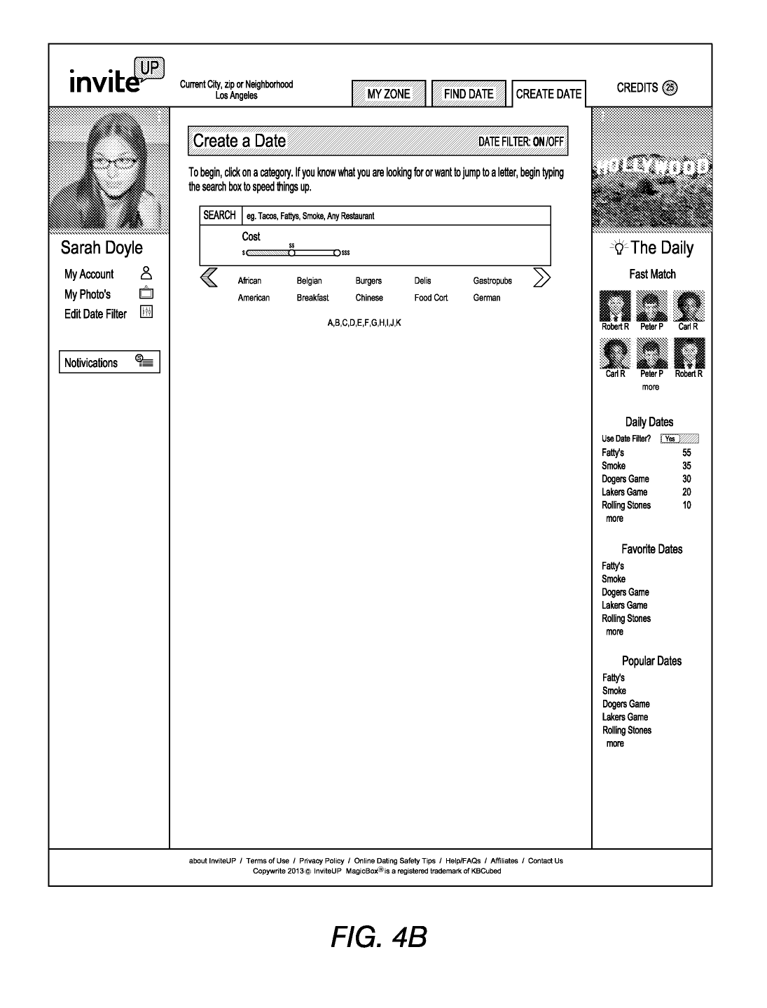

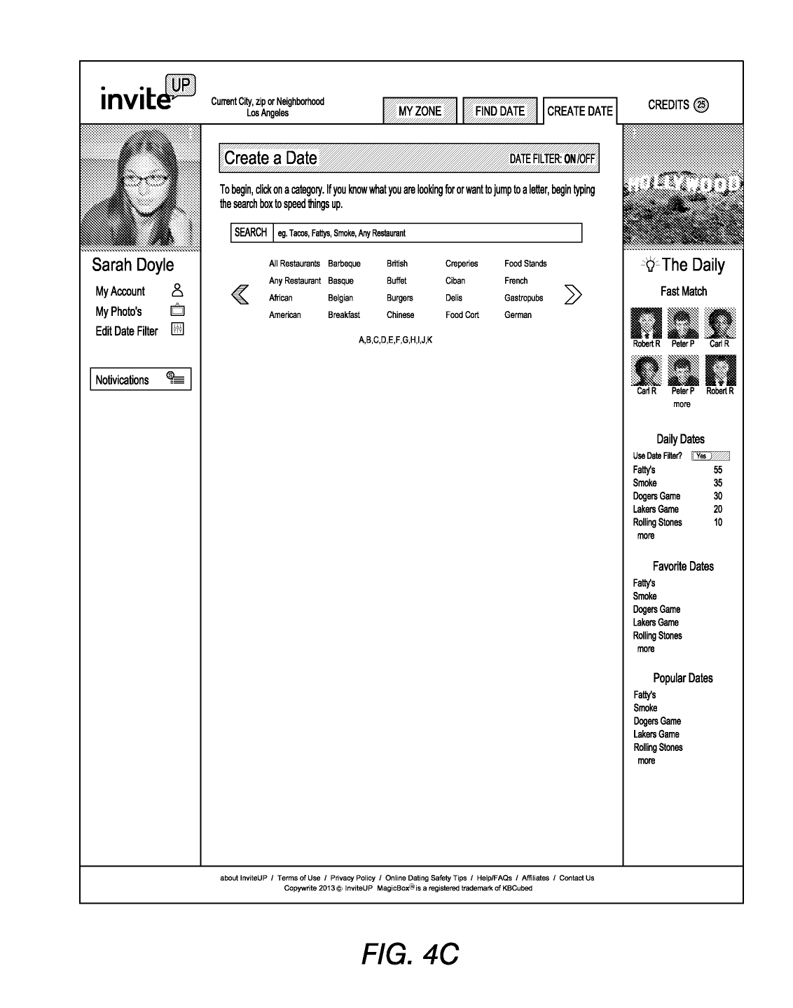

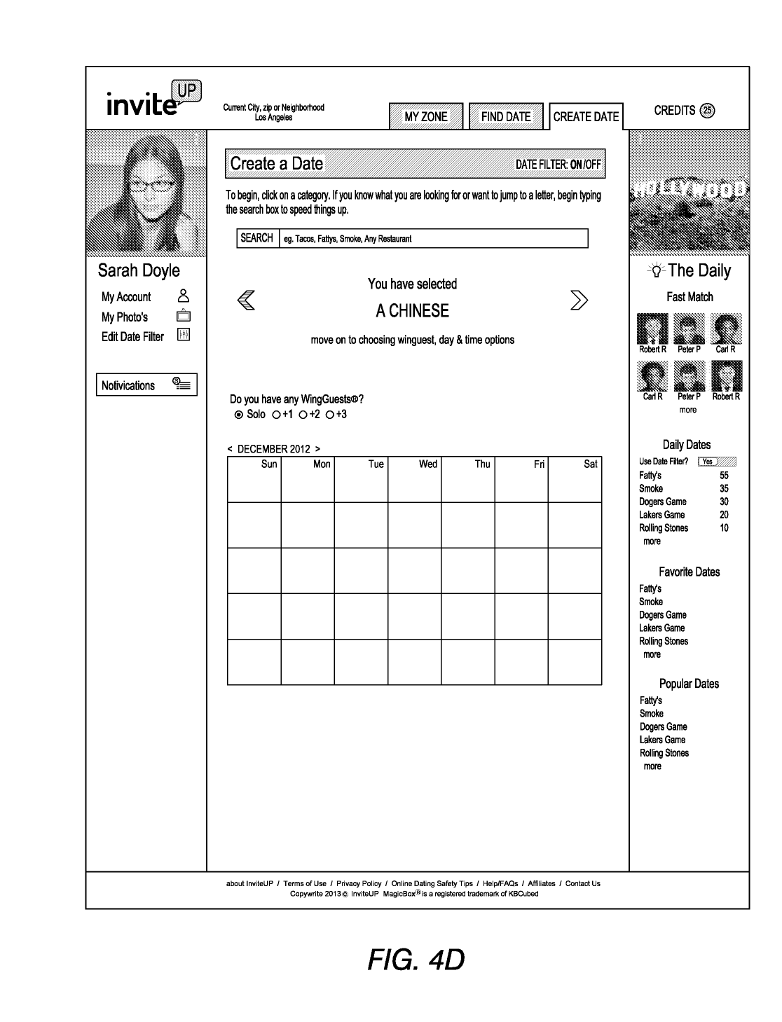

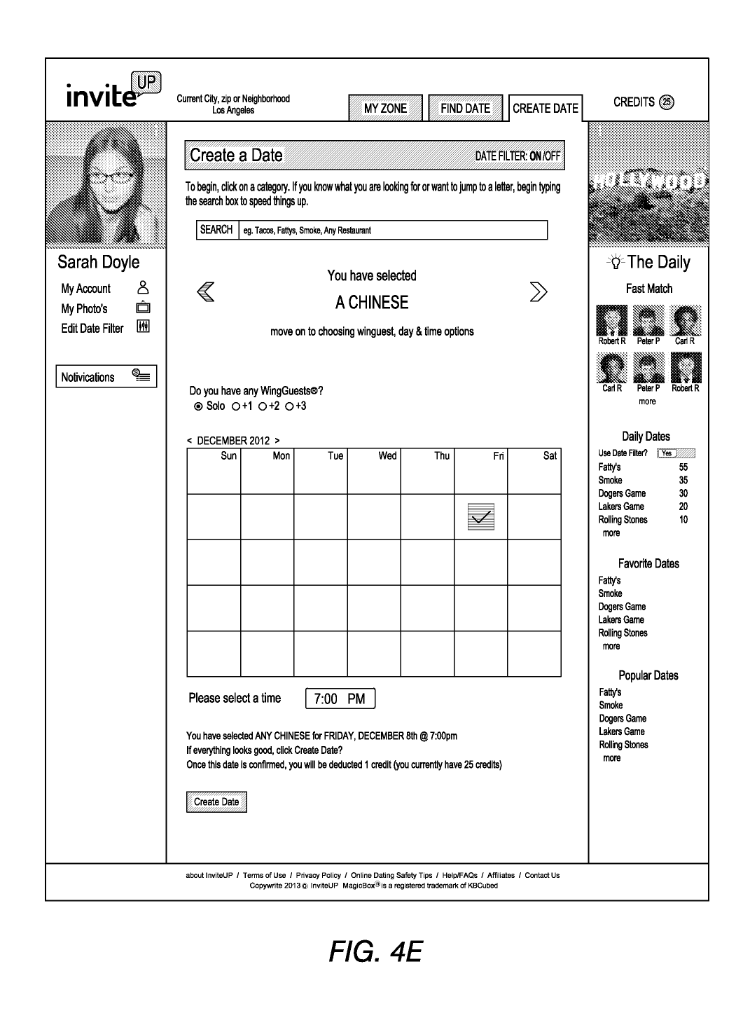

FIG. 4A illustrates an example user interface that a user may utilize to specify a date for a date posting. A system (e.g., a dating system) may determine the user's current and/or registered location (e.g., the city or zip code that is the user's home/work address as indicated by the user in the user's account record and/or the user's current location). The user interface may display such user location information to the user. For example, optionally the system will automatically determine the user's current location (e.g., the city the user is accessing the dating website from) using the user's login IP address. The system may, for example, display the name of the city where the computer, utilized the user to access the dating system, is located. Optionally, the user can change the user location by selecting another city via a menu of cities or by typing in the name (or a portion thereof) of the user's city into a city search field.

Still referring to FIG. 4A, a menu of date categories is provided from which the user can select. For example, the menu of date categories may optionally include food and dining, nightlife, movies, concerts, active life, performing arts, sporting events, etc. The user may scroll through the menu to view additional date categories. In addition, the user may search for a date category by entering a textual search query into a date category search field, and the system will locate and identify to the user matching date categories (if any). Optionally, if the user does not see a predefined satisfactory date category, the user can activate a “create a custom date” control provided via the user interface, which when activated presents a user interface via which the user can specify a custom date that does not fit into one of the predefined categories. For example, a user may be look for someone to go with her to a wedding she is attending, and may specify that the date event is a wedding, taking place at a specified hall, at a specified time, and the dress code for the wedding (e.g., formal, cocktail-style, casual, etc.).

In addition, the illustrated user interface includes account setting information and profile information of the user. The setting and profile information may be accessed by the system from a user account record and provided for display to the user. For example, a photograph of the user and the user's name may be presented. An account control is provided which when activated enables the user to view and edit the user's account information (e.g., contact information, user characteristics, payment information (e.g., credit card number), etc.). A control may be provided which when activated causes the user's photographs and/or photograph albums to be presented. The system may enable the user to upload photographs, delete photographs, edit photographs, and/or organize photographs into one or more albums. A filter control may be provided which enables the user to edit or modify the user's date filter (which may be used to specify desired characteristics in a potential date and/or in date specifications). A control may be provided via which the user can instruct the system to turn on or turn off the date filter. A notification control may be provided which, when activated by the user, causes system and/or other user notifications to be presented.

In addition, fast matches, daily dates, favorite dates, and/or popular dates user interfaces may be provided, as described in greater detail herein. Various of the foregoing features may be provided via some or all of the user interfaces described elsewhere herein.

In this example, once the user selects a date category, a further filter may be provided. For example, if the user selects the food and dining category, a filter interface may be provided, such as that illustrated in FIG. 4B. Optionally, the filter may include a cost filter (e.g., controlled via a cost slider control), via which the user can specify a relative restaurant cost that the user desires. For example, the user may indicate on a scale of 1-10, 1-100, or other scale on how pricey the restaurant should be (e.g., where 1 is very inexpensive and 100 is very expensive). By way of further example, an interface may be provided where the user can enter a typical cost of a meal/per person.

A menu of restaurant categories that satisfy the filter condition(s) may be presented, an example of which is illustrated in FIG. 4C. For example, the restaurant categories may include all restaurants, African, American, Breakfast, Burgers, Chinese, etc. The user may then select a given restaurant category, such as Chinese. A calendar interface may then be presented, such as the example illustrated in FIG. 4D, via which the user can specify one or more calendar days for the date. The displayed calendar may be for the current week, month, or other time period. A forward control and reverse control may be provided enabling the user to navigate to the calendar for the next month or other time period. In addition, the user can specify that one or more of the user's friends will (or will not) be accompanying the user on the date (e.g., as “wingmen”). For example, the user may indicate that 0, 1, 2, 3, or other number of friends will be accompanying the user on the date. A user interface, such as that illustrated in FIG. 4E, may be presented via which the user may specify one or more times for the date. In addition, the date specification as selected by the user may be presented (e.g., Any Chinese for Friday, December 8^{th}, and 7:00 PM). The user may be asked to verify that the presented date specification is correct by activating a corresponding control (e.g., a “create a date” control). The date may then be posted for matching, searching, and/or browsing purposes. Optionally, the user is not charged for the date creation until the user accepts an invitation for the date or the date is otherwise confirmed.

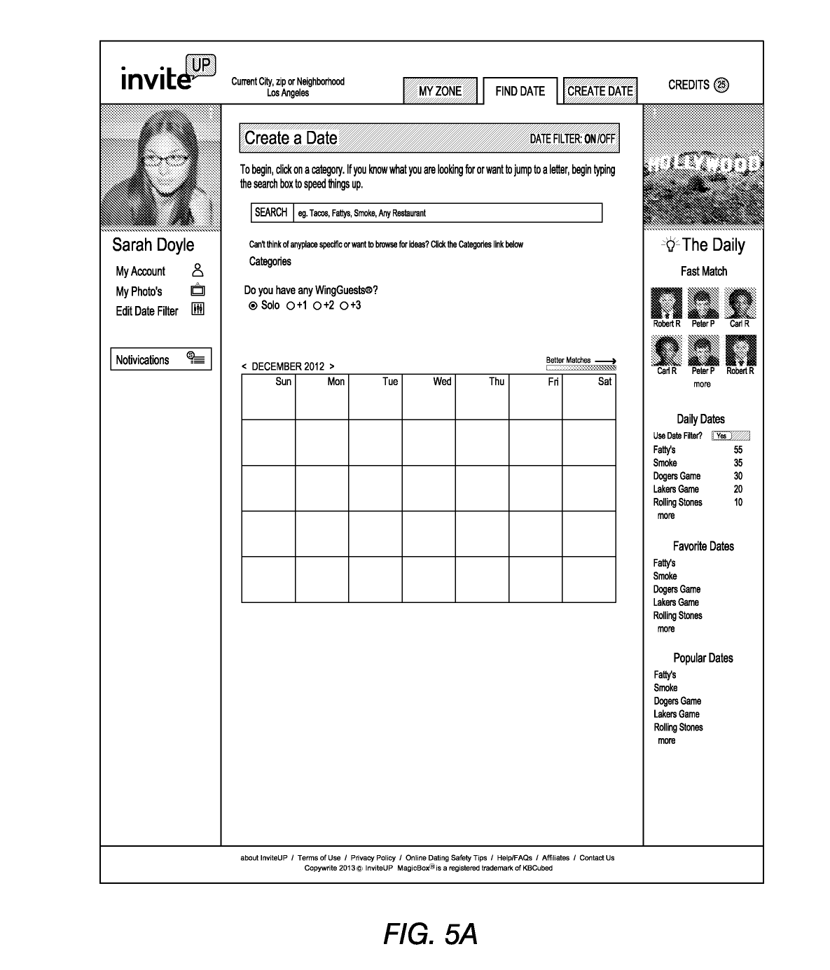

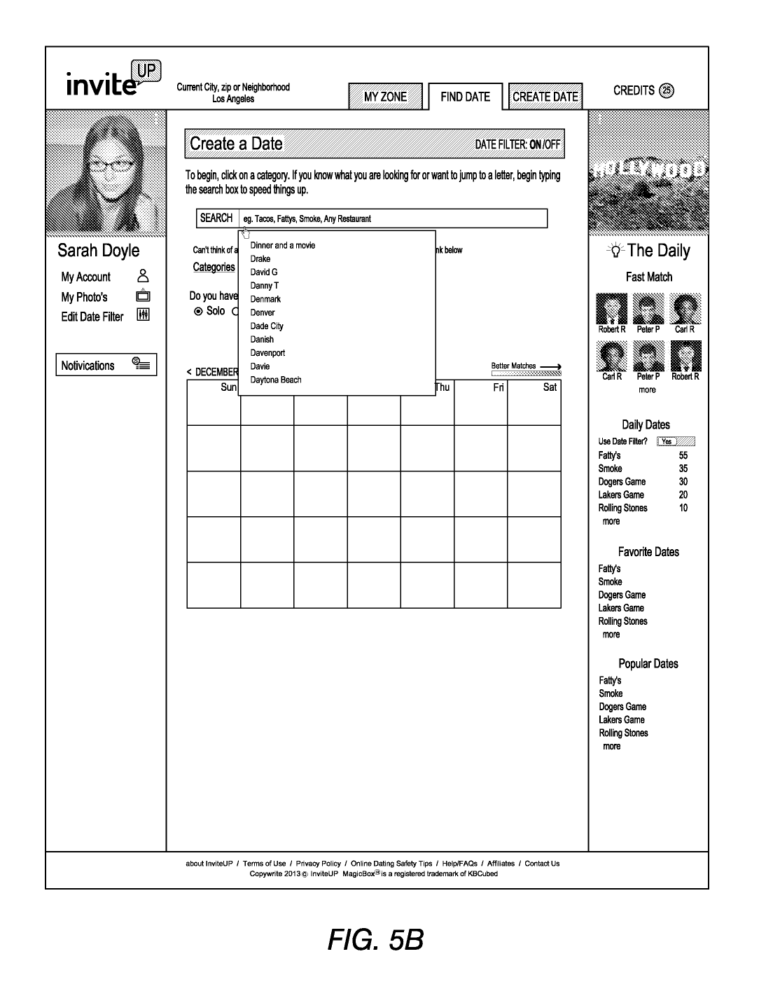

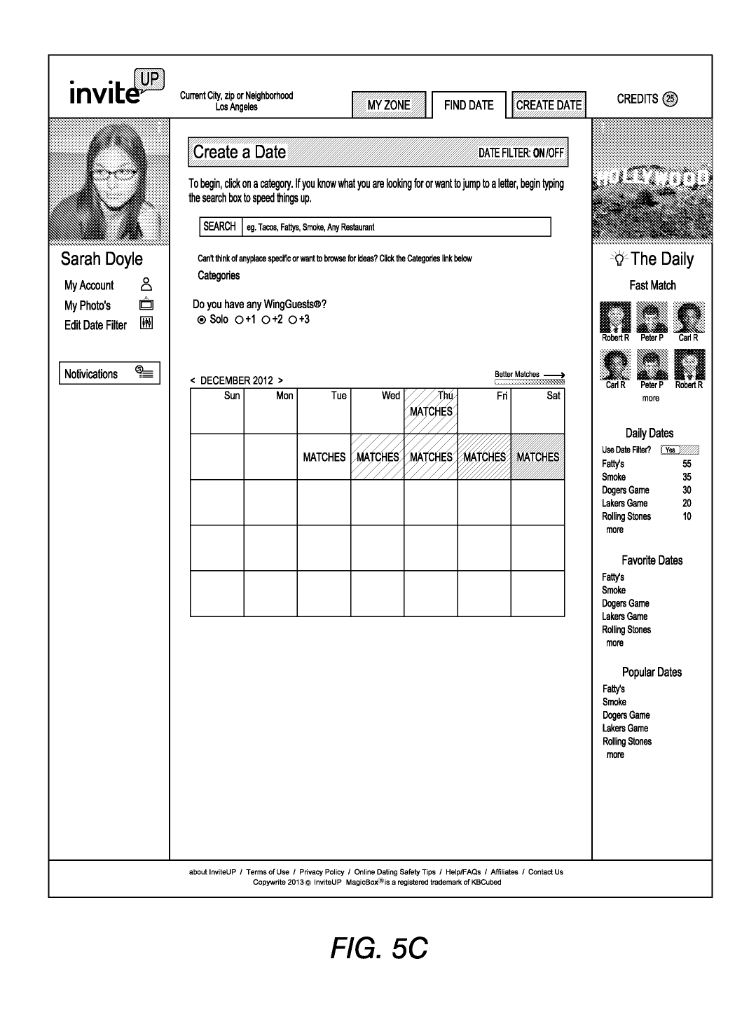

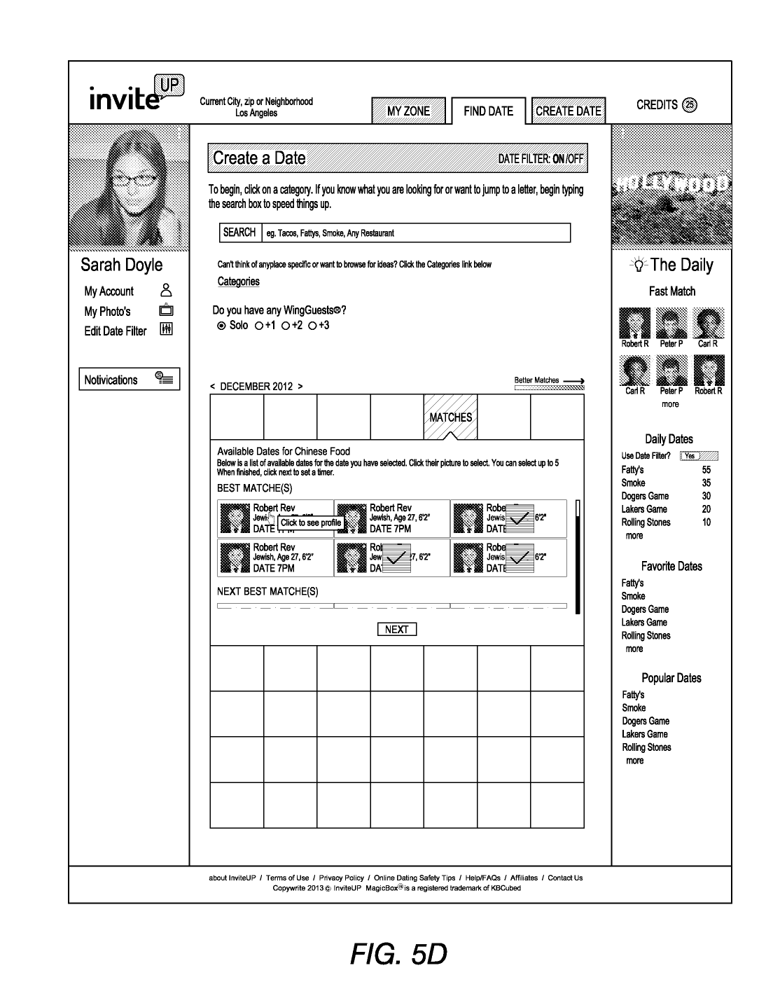

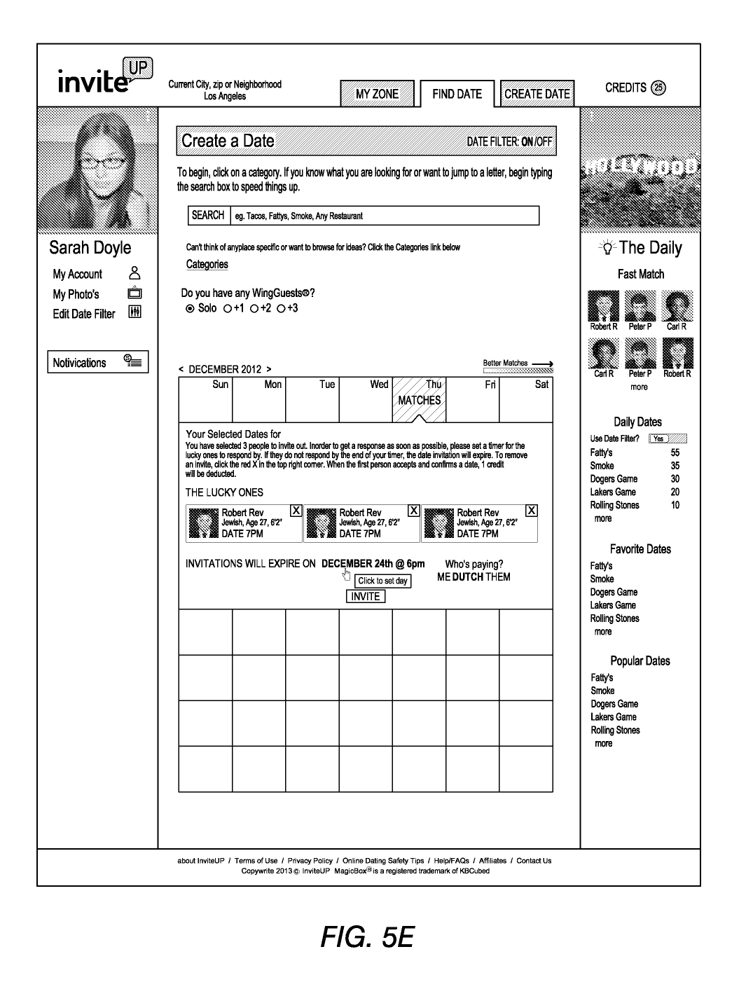

In addition, as discussed elsewhere herein, a user may search for a suitable posted date. For example, with reference to FIG. 5A, a search field may be provided via which the user may enter search query terms (e.g., the name of a date venue, such as a restaurant; a date category, such as dinning or movie; a geographical area, city, etc.). If the user begins to enter text into the search field, optionally the user is presented with suggested search terms that correspond to the search query as it is being entered, as illustrated in FIG. 5B. A menu of date categories may be presented that the user may browse. For example, the user may select movies and browse through posted dates for movies. A calendar may display available dates (or an indication of the existence thereof) on respective calendar days that correspond to the search query. The displayed dates may be displayed with an indication as to relative match closeness of the date to the query. For example, color coding and/or text (e.g., match) may be used to indicate the existence and/or relative match closeness of the date to the query, as illustrated in FIG. 5C.

If the user selects a day on the calendar that has one or more matching dates (e.g., by mousing over, pointing at, or clicking on the day), the matching dates (e.g., including a photo, a name/userID, age, physical characteristics, etc. of the posting user, the date time, etc.) on the selected day may be presented. The presented dates may be organized according to the degree of match (e.g., best matches, next best matches, etc.). The user can select one or more of the presented dates, as illustrated in FIG. 5D. A user interface, such as the example illustrated in FIG. 5E may then be presented. The user interface may present postings for the selected dates optionally without presenting the non-selected dates. The presented postings may present information regarding the posting users, such as name/userID, religion, ethnicity, age, height, etc., particulars regarding the date details for the selected dates (e.g., begin time and/or end time, who is paying, etc.). A control (e.g., an invite control), may be provided via which the user can indicate that the user is interested on going on one of the matching dates for the selected day. The interest will then be communicated to the respective posting user, and if the posting user indicates a reciprocal interest (e.g., by activating an “accept” invitation control), the parties may communicate to coordinate the date as similarly described elsewhere herein. For example, an invitation may be sent to the posting user via a webpage, an email, an SMS message, an MMS message, a push notification, and/or otherwise.

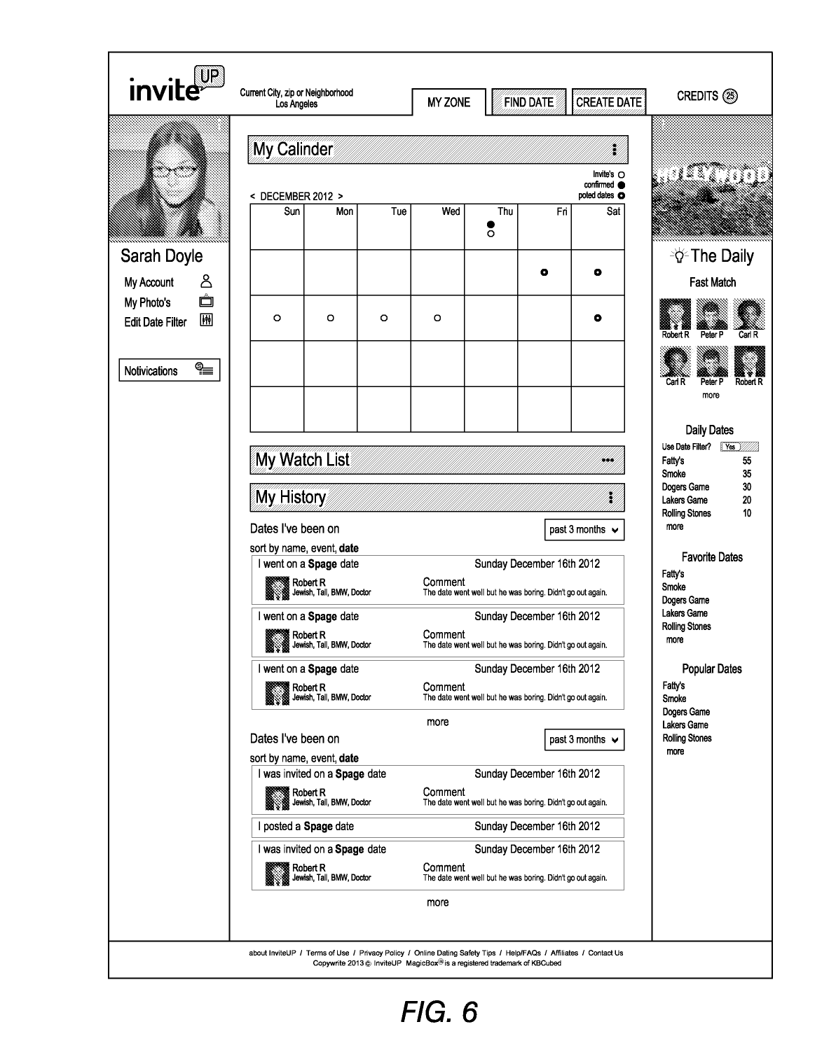

FIG. 6 illustrates a user interface that provides a user with the user's calendar, watch list, dating history, past posts and date invitations using information accessed from a data store. The calendar may list on a day basis which days have a posted date, a confirmed date, or an invite for a date. The dating history may list the dates the user has previously arranged via the dating system. A filter interface may be provided enabling the user to specify a filter to be applied to the dates. For example, the dating history may optionally list all dates, dates over a user or system specified time period (e.g., the last month, the last 3 months, etc.), dates within a certain city or state, etc. A given listing may indicate the date activity, location/venue, date, time, the name or userID, photograph, and/or personal details (e.g., religion, ethnicity, profession, physical characteristics, etc.) of the person the user went on the date with, and a comment entered by the user regarding the date. The date history may be organized by name, event, or date. The past posts and invitations interface may list dates posted by the user and dates on which the user was invited by another user. A given past post and invitation listing may indicate the date activity, location/venue, date, time, the name or userID, photograph, and/or personal details (e.g., religion, ethnicity, profession, physical characteristics, etc.) of the person the user went on the date with, and a comment entered by the user regarding the date, if one occurred, or regarding the other date participant.

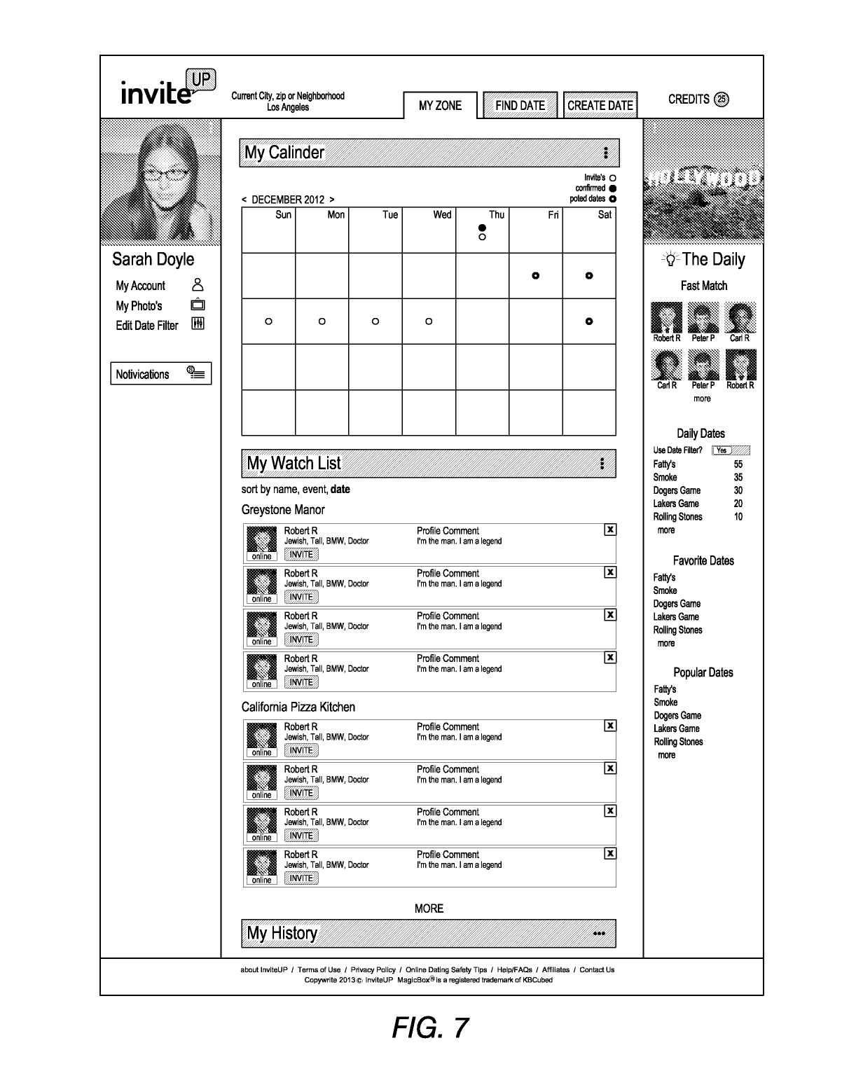

FIG. 7 illustrates an example user interface that provides a user with the user's calendar and a watch list. A watch list may be defined by a user, where the user specifies people, venues and/or activities the user is interested in, but may not have decided to issue an invitation to or for. The system identifies dates posted by the users on the watch list and those of other users that have posted dates for the corresponding specified venues and/or activities on the watch list, and lists those posted dates, organized by the venues/activities of the user's watch list. A given listed posted date may provide profile information regarding the posting user (e.g., a photograph, name/userID, personal characteristics, a profile comment, etc.). The user can indicate an interest in a posted date by activating a control (e.g., an invite control) which may then be processed by the system as similarly discussed elsewhere herein. The user may activate a delete control to cause the system to delete a posted date from the watch list that is not of interest to the user. For example, there may be hundreds of individuals that have expressed an interest to go to an Adele concert (e.g., by posting a date for an Adele concert). As the user looks through the list, the user may identify 10 individuals the user may potentially want to invite to the Adele concert, and the user instructs the system to place the 10 individuals, optionally one-by-one, on the user's watch for further consideration. After the user has completed the review of date postings for the concert, the user can then access and view the user's watch list to more closely examine or review the personal characteristics of each of 10 individuals on the watch list. The user can then invite one or more of the individuals to go on the date to the concert.

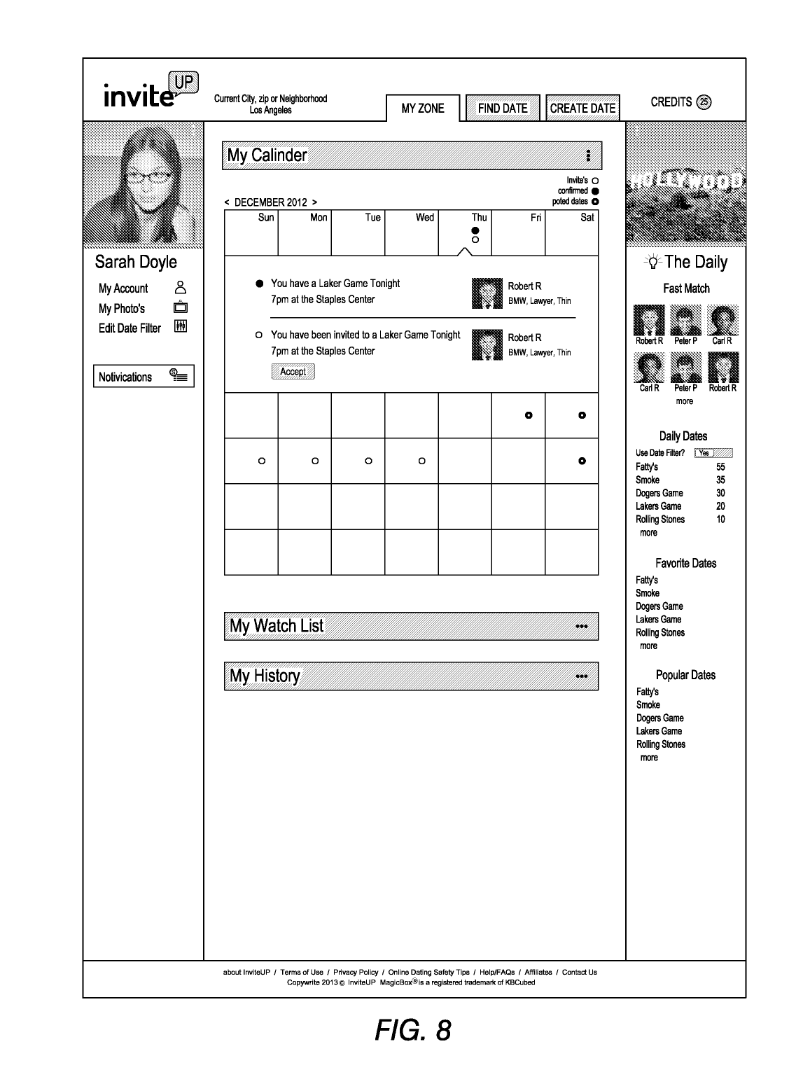

FIG. 8 illustrates another example user interface displaying a user calendar. The calendar displays for a given day (for a daytime period and a nighttime period), via icons and color coding, whether a user has: received an outstanding invite for a posted date for the given day, a confirmed date for the given day, and/or a posted date for the given day. If the user hovers over a given day with a pointer, or otherwise selects a given day, a pop-up window or other interface displays the invitation (e.g., including the event name, venue, time, information on the inviter, etc.), the confirmed date (e.g., including the event name, venue, time, information on the inviter, etc.), and/or the posted date for that day. Optionally, the displayed invitation may include an accept control via which the user may accept the date invitation.

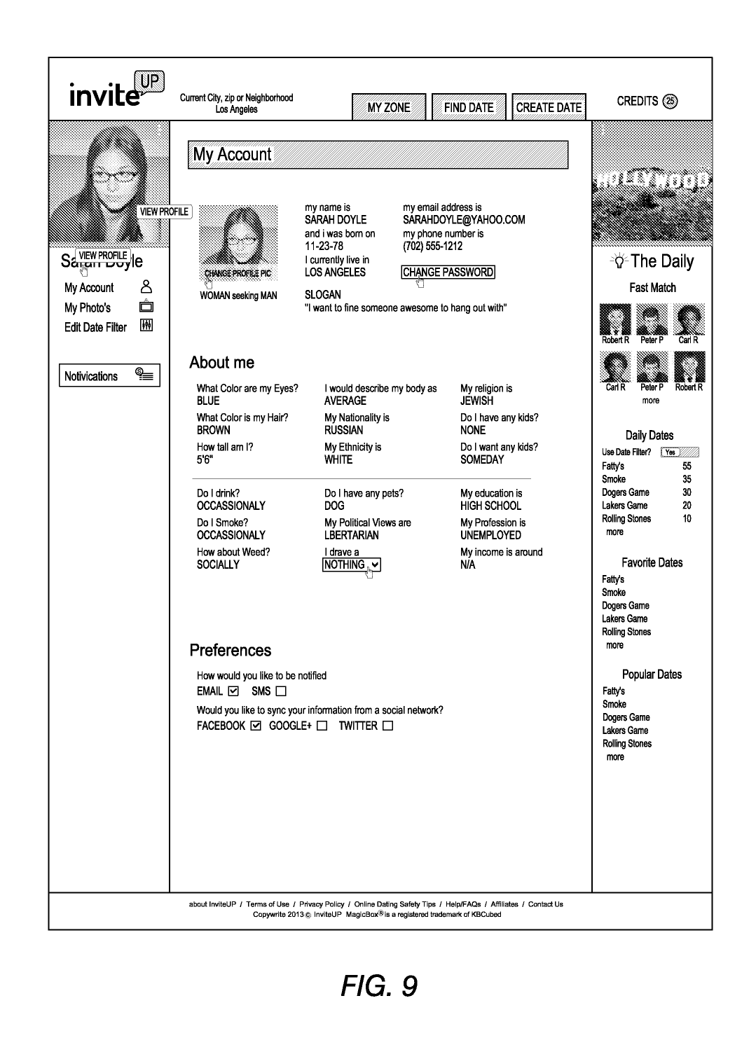

FIG. 9 illustrates an example user account interface via which a user can view and enter/edit account information. For example, the account information may include the user's user name, date of birth, contact information (e.g., email address, phone number, instant messaging identifier, etc.), and a textual description describing the user or the user's goals. The user can also provide descriptive information regarding the user, such as, eye color, hair color, height, weight, body type, nationality, ethnicity, religion, marital status, how many children the user has, whether the user wants children, whether the user drinks, smokes, or uses drugs, whether the user has pets, the user's political views, what type of vehicle the user drives, the user's level of education, the user's profession, the user's income, the user's communication preferences, etc. The profile may include a preference section regarding notification preferences and social network preferences. For example, the user may specify that notifications (e.g., regarding date invitations, date acceptances, etc.) are to be provided via email, SMS, instant messaging, and/or otherwise. The user may also specify which social network accounts of the user should be synchronized with the user's dating system account.

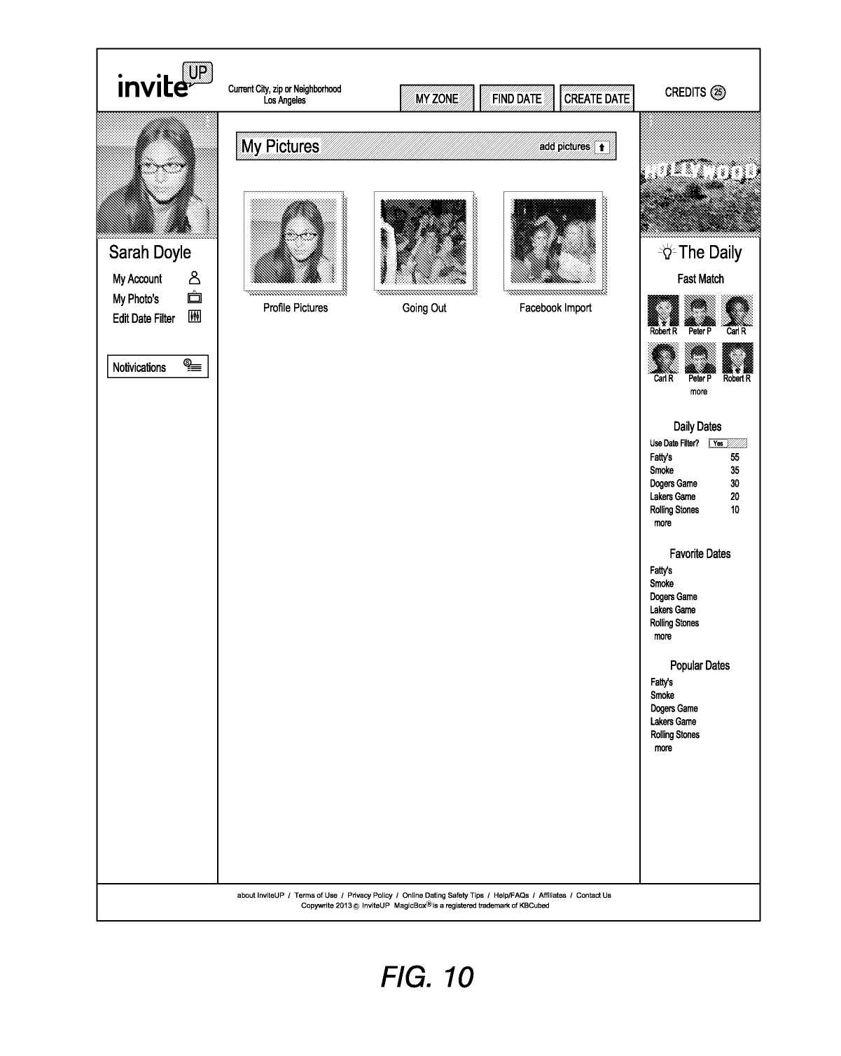

FIG. 10 illustrates an example user interface via which the user can organize their photographs. For example, the user may organize photographs into one or more files/groupings (e.g., profile pictures, date pictures, social network imports, etc.).

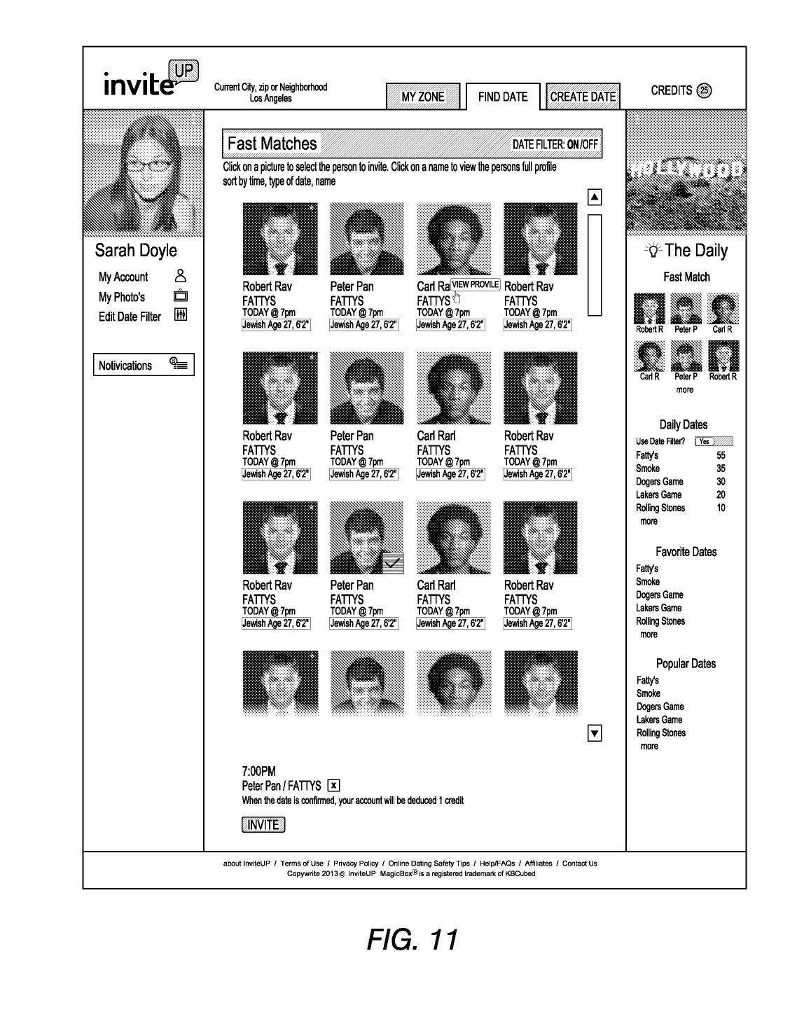

FIG. 11 illustrates an example fast matches user interface. The fast matches interface provides system identified matches for one or more dates that the user has posted. For example if the user has posted a date for the Acme Leaf tea shop on Santa Monica and Doheny for Wednesday night, the system identifies and presents individuals that have posted identical dates (at the same location and time) and/or similar dates (e.g., with a slightly different time, such as no greater than a 30 minutes difference in start time or other threshold, where the threshold may be user and/or system specified). The presentation of individuals may include photographs and/or other profile information regarding the respective individuals, and may optionally provide details on their respective date postings. Optionally, the fast matches interface may display posted dates as having a category that matches that of the date posted by the user. For example, the category may be Coffee in Santa Monica on Wednesday night. The system identifies and displays individuals that have posted dates with the Coffee category at locations in Santa Monica on Wednesday night, regardless of the particular chain/store (e.g., the system may identify and display individuals that have posted dates at the Acme coffee shop, the Beta coffee shop, and the Zeta coffee shop, in Santa Monica on Wednesday night).

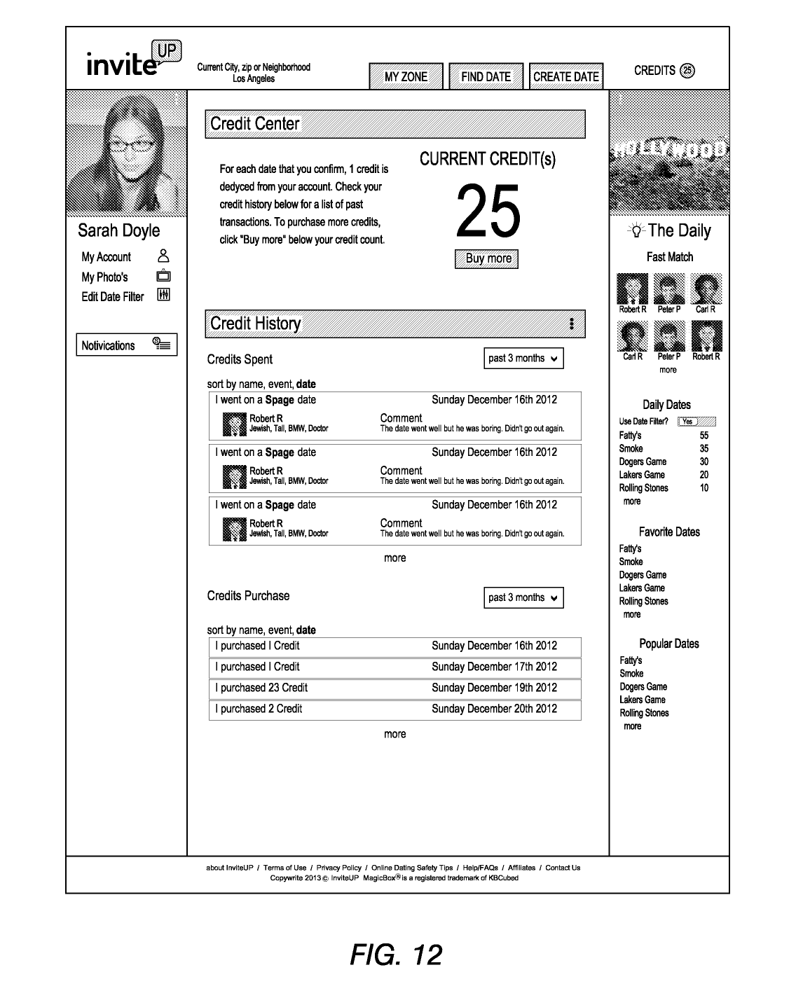

FIG. 12 illustrates an example credit center user interface. Optionally a user may purchase one or more credits which may be associated with the user's account. The credits may be used to pay for dates as described elsewhere herein. The user interface may display how many credits the user has. In addition, the account user interface may provide a credit history, listing the dates the user has gone on and spent credits for, as well as the user's comments/rating of the date. The history may also indicate when the user purchased credits, and how many credits were purchased at a given time. The history may be limited to a specified time selected by the user or system (e.g., the last 3 months, the last 6 months, or other time period).

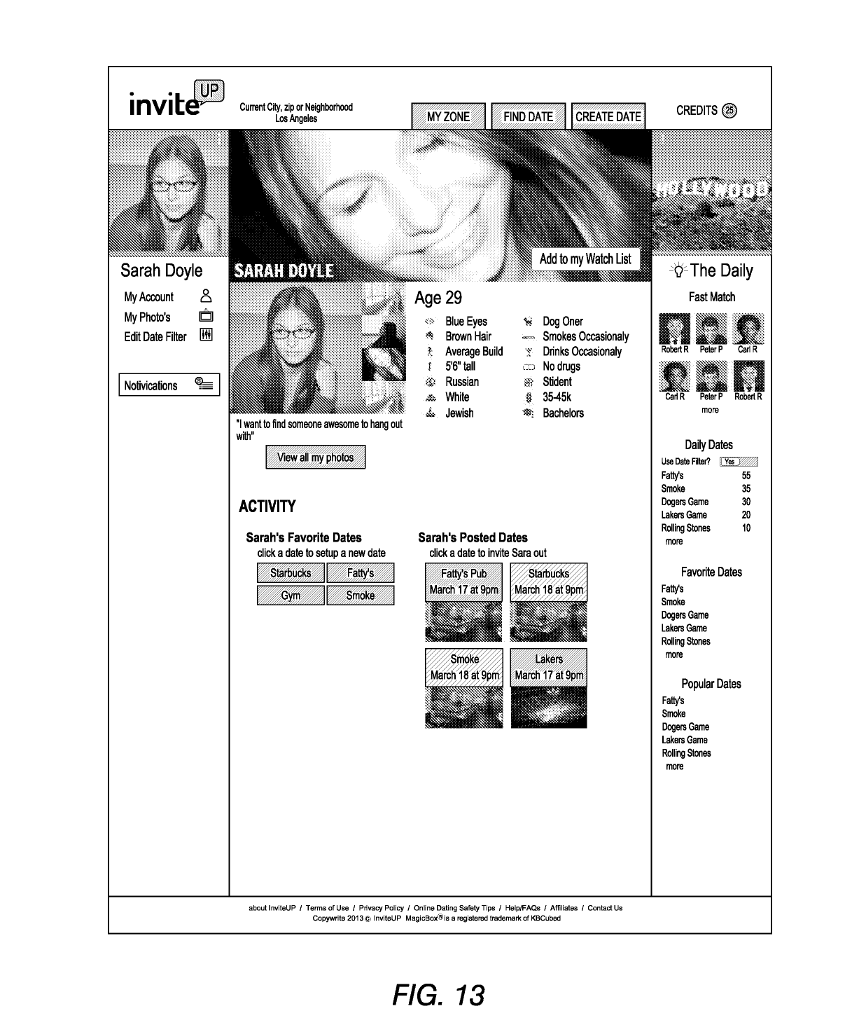

FIG. 13 illustrates an example user's profile page, which may be viewed by the user's whose profile it is, and/or other users. The profile page may include one or more photographs of the user and characteristics of the user (e.g., age, color of eyes, hair color, build, height, nationality, race, religion, hobbies, likes animals, smoking habits, drinking habits, drug use, profession, income, education, marital status, sexual preferences, etc.). The profile page may also list the user's favorite dates (e.g., favorite date venues and/or activities) and the user's posted dates (e.g., venue, activity, date, time). The posted dates may have an associated invite control which when activated causes an invitation be sent to the user for the posted date, identifying who is sending the invitation as similarly discussed elsewhere herein.

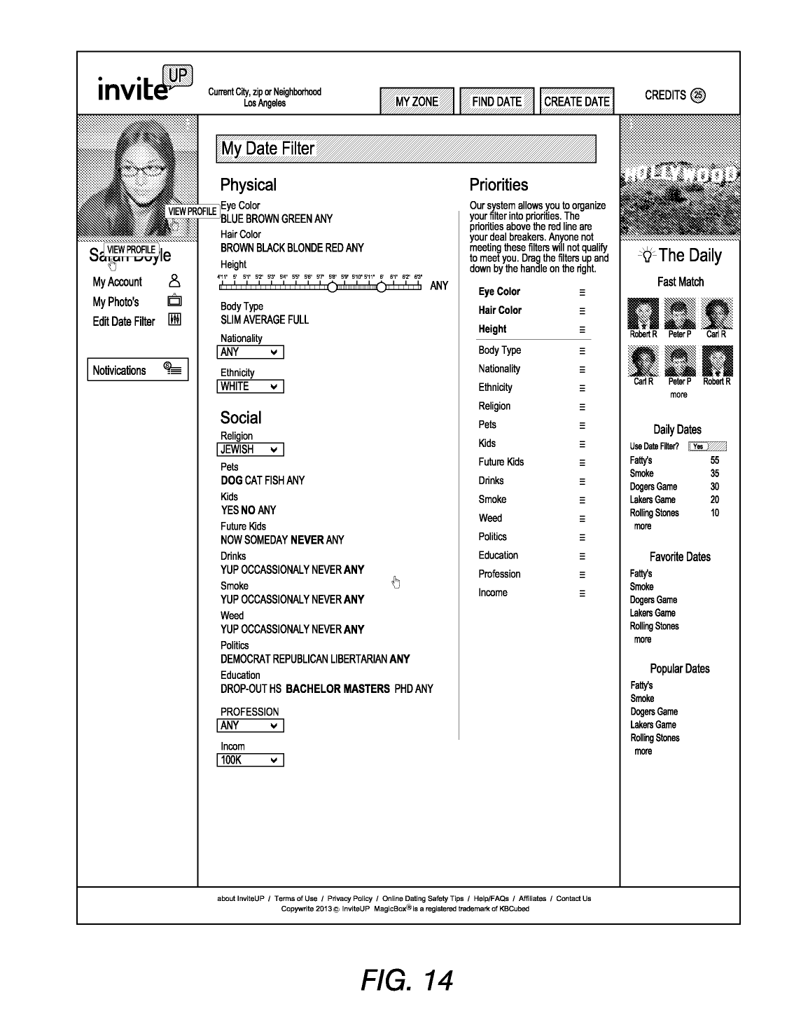

FIG. 14 illustrates an example date filter user interface via which the user can specify various desired features in a potential date, such as height, body type, eye color, hair color, nationality, ethnicity, religion, pets, current children status, intent regarding potential future children, alcohol drinking habits, smoking habits, drug use habits, political affiliations/leanings, education level, profession, income, etc. In addition, an interface may be provided via which the user can specify priorities with respect to the various filter criteria. Optionally, the interface enables the user to specify that certain criteria are “must haves”, where anyone not satisfying the “must have” criteria will not be presented to the user when the user enables the filter and the filter is applied.

As similarly discussed elsewhere herein, the system and/or a local application may provide user interfaces and data to assist users in keeping track of invitations received and sent, the dates for prospective matches, and may provide a system of alerts and reminders. Optionally, a datebook may be provided that displays a list view and/or a calendar view of date related information, and that optionally enables a user to perform some of all of the following: post dates, send invitations, accept invitations, delete date postings, cancel dates, etc. The datebook may be dedicated to dating activities or may be a general calendaring application.

Optionally, the system may automatically post to the datebook (for viewing by the user) some or all of the following information: the time of a posted date, the location of a posted date, who will pay for the posted date (e.g., the posting user, the inviting user, or payment will be split between the two), how many wing guests will also go on the date, and other details. The system may also indicate via the datebook whether there are any matches for a posted date, whether there are any pending invitations, any accepted invitations (confirmed dates), etc. Thus, while reviewing a posted date in the user's datebook, the user can easily check to see if there are any matches to the user's posted date(s) and when a date has been accepted (sometimes referred to herein as a confirmed date). The user can review date details (e.g., time, date, location, who pays, number of wing guests, etc.), and at the same time can view the user's date's photos and/or public profile information.

The datebook may also be associated with a search engine/filter enabling the user to search for specific datebook items and sets of datebook items. For example, the user can search for any data included in datebook postings or profiles of dates in date postings, and the search engine will locate and display matches to the user. By way of illustration, the user can initiate a search for all future dates where the user is going to pay, or for all invitations to dinner, or for all invitations for a specific bar, or for all date partners having a specific profile characteristic (e.g., all dates over the age of 25, taller than 5.5 feet), or for all future dates which will have wing guests, etc., and then review the results provided by the search engine, where the results may optionally be provided in list form, and may be sorted in ascending or descending order.

The system may automatically notify (e.g., via the datebook, a popup notification, an audible alert, and/or an icon provided via the user device) a user if an invitation has been accepted and an if invitation has expired, as well as information regarding invitations that have been sent and to whom they have been sent. Optionally, a reminder alert is generated and provided to the user regarding a confirmed date at a default interval (e.g., 24 hours before a date) or a variable interval set by the user. Push notifications may optionally be provided, wherein even if the app is not opened, a message will be displayed via the face of the user's phone (or other mobile device).

Optionally, the datebook is configured to enable a user to cancel date postings. For example, the datebook is configured to enable a user to cancel dates that had been posted but that have not yet been accepted by another user. Optionally, the datebook is configured to enable a user to cancel a confirmed date (where someone sent the user an invitation for the posting, and the user accepted the invitation). Optionally, the system is configured to limit the number of dates a user can post at a given time and/or with a given time period to a predetermined threshold (e.g., 40 dates at a time, 20 dates at a time, 30 dates/month, 20 dates/month, 4 dates/day, etc.). Optionally, if the system detects if the user is attempting to post a date in excess of the threshold, the system may so notify the user, prevent the user from posting additional dates, and/or may offer the user the option to delete one or more of the user existing date postings in order to make room for new dates within the threshold.

Optionally, a messaging system (e.g., a text messaging system) is provided via which users going on a date can coordinate the logistics of the date. Optionally, an alert is generated by the system and provided to the user a predetermined amount of time before the date is scheduled to occur (e.g., 24 or 48 hours before the date is scheduled to occur) as a reminder to use the messaging system to coordinate the date logistics. Optionally, date participants may be able to communicate with each other via the messaging system and predetermined amount of time before the date is scheduled to occur, after the date has been confirmed, or otherwise.

Optionally, the datebook calendar can be integrated and synchronized with one or more other online and/or local calendars (e.g., GOOGLE®, BING®, and/or OUTLOOK® calendars). The system may generate alerts to the user regarding invitations received, invitations that are set to expire, etc.

As similarly discussed above, the system optionally enables a user to simultaneously search for posted dates within a certain radius of a location (e.g., the user's current location, or a selected address, neighborhood, or city) that are posted by users with user-defined characteristics, and the system will find matches that satisfy the date, location, a user/potential date characteristics specified by the querying user.

For example, a user can search for all dates to coffee shops, parks, bars, or sushi restaurants within a defined radius (e.g., a predefined radius set by the system or a radius of variable size which may be set by the user) at a specified calendar date(s) (or calendar date range), and at the same time use that radius (or a different radius) to search for specific match characteristics such as age, hair color, education, height, other physical or personal characteristics, etc. As an example, a user located in downtown Los Angeles may wish to search for all posted dates to coffee shops within a 25 mile radius scheduled for the week of August 1. At the same time the user can search for individuals between the ages of 35-45, who are 6 feet or taller with a college education that have expressed an interest in going to those same coffee shops. This radius can be the same or different than the location radius. The search results provided by the system search engine may include photographs of matching users, and the viewing user can select a given user photograph (e.g., by tapping on the photograph if the user device has a touch screen) to access profile information of the selected user and/or to access an invitation user interface so as to invite the given user on a date.

Thus, dates may be divided dates into categories, such as places and faces. As similarly discussed above, the places category may be organized around the venue of the date (e.g., Acme Coffee, a park, concert, etc.). Searches for date venue s may be conducted by way of example, by search query including keyword, zip code, other geographic area, location name, cross streets, etc. The system may then locate and display to the user venue matches corresponding to the search query. For example, a user can search for, and view, all the dates in zip code 90210, all the dates in Beverly Hills, or dates within a radius around the user, where the user sets the radius size.

Once the user selects a specific location, the system searches for other users that also want to go on a date to the same location, and the system will access and display to the user “faces” (e.g., portrait photographs) of such other users that want to go on a date to the same location. Optionally, the system will provide for display (optionally simultaneous display) to the user device some or all of the following date information: the calendar date and time for the proposed date, who is to pay for the date, and the number of wing guests that will also go on the date. Optionally, the system will locate and provide for display (optionally simultaneously display) to the user, via the user device, the public profile of the person that posted the date. A user public profile may optionally include physical and/or personal characteristics about the user (such as those described elsewhere herein), and may optionally include personal information that the user has chosen to post as part of the user's public profile. Optionally, if multiple users are going to the same location, the system will provide for display images (e.g., accessed from their user profiles) of all of the multiple users (e.g., where photographs are displayed by user device one-by-one, where the user can scroll or swipe through the photographs on the user device, or the photographs may be displayed in groups if multiple photos are provided for display at the same time). Photographs of matching users are optionally organized by calendar date and time or by closeness of match with respect to their personal characteristics to those specified by the viewing user, or based on other date-related information discussed herein.

Certain example user interfaces will now be described. Generally, certain of the user interfaces described herein may include a zoom control enabling the user to instruct the system or application to zoom in or out with respect to a user interface or with respect to certain information displayed by the user interface. For example, if photographs of faces or places are being displayed, the zoom control may be used to cause the application or system to cause the user device to display fewer and larger photographs or additional and smaller photographs. Scroll controls may be provided (e.g., left and right arrows or up and down arrows) enabling the user to cause the application or system to scroll through information (e.g., a datebook list, photographs of places or faces, etc.). “More information” controls (e.g., “more info”) may be provided enabling the user to instruct the application or system to display via the user device additional information regarding what is currently being presented (e.g., if a photograph of another user is being presented, activating the more information control may cause the user device to display additional profile information regarding that user, if a photograph of a venue is being displayed activating the more information control may cause the user device to display additional information regarding the venue, such as hours of operation, mapping information, cost, etc.). The user interfaces may be generated by an application installed on the user device (e.g., an app installed on a mobile phone) and/or may be generated by a remote system and provided to the user device (e.g., where the remote system generates a document (e.g., an HTML document) and the user device renders the document (e.g., a webpage) using a browser, or the remote system generates and provides the user device with a pre-rendered document).

The user interfaces may optionally include a navigational area including controls which enable a user to directly navigate to one or more other user interfaces corresponding to different functionality. For example, the navigational area may optionally include controls to enable the user to directly navigate to the user's profile information (e.g., a “Me” control), to a places/venues user interface enabling a user to view date venues (e.g., a “Places” control), to a user interface that enables a user to post dates (e.g., a “Post Up” control), to a faces user interface enabling the user to view photographs of people who have posted dates (e.g., “Faces”), to a datebook user interface (e.g., “DateBook”), and/or other user interfaces.

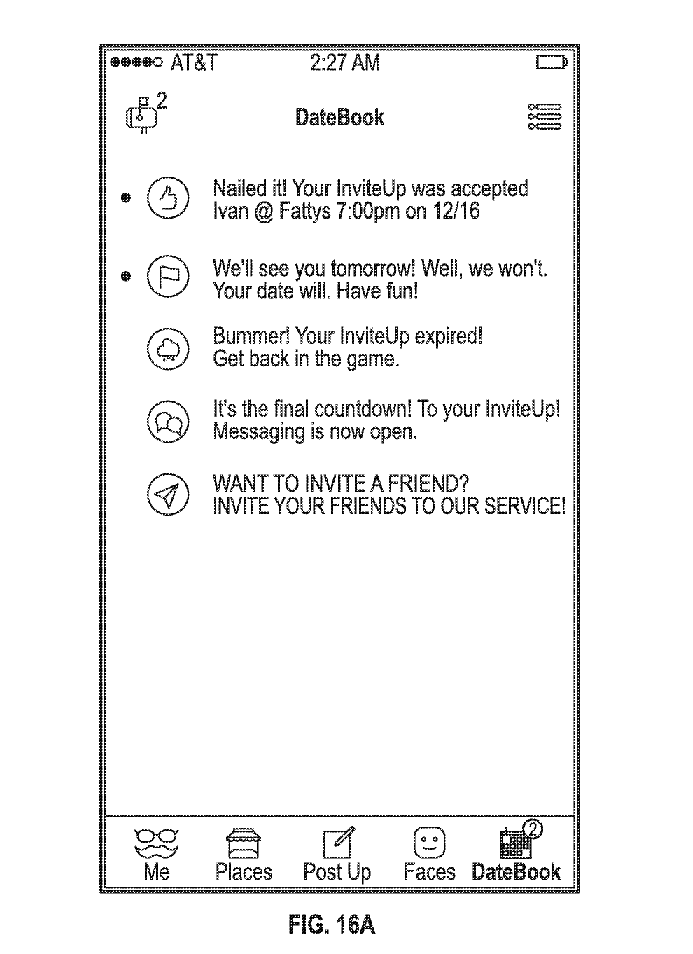

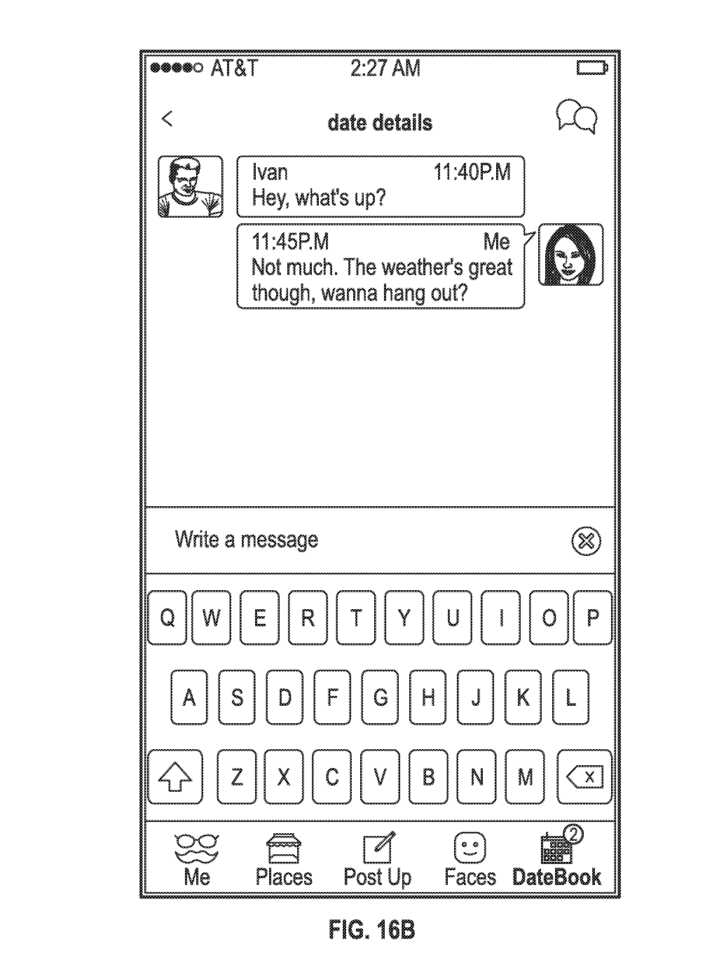

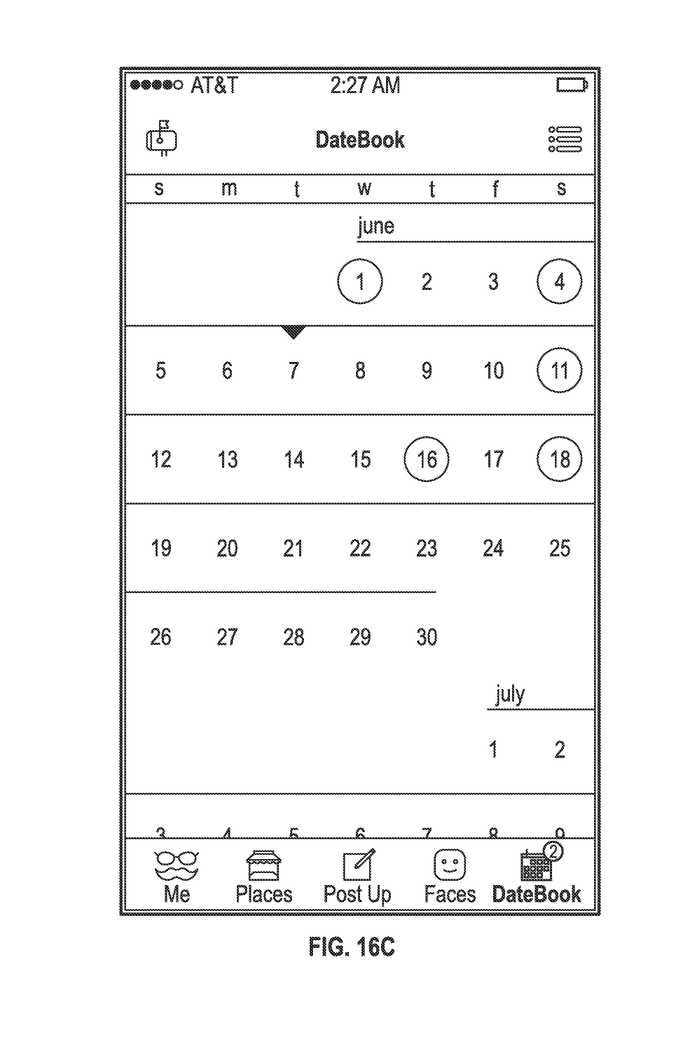

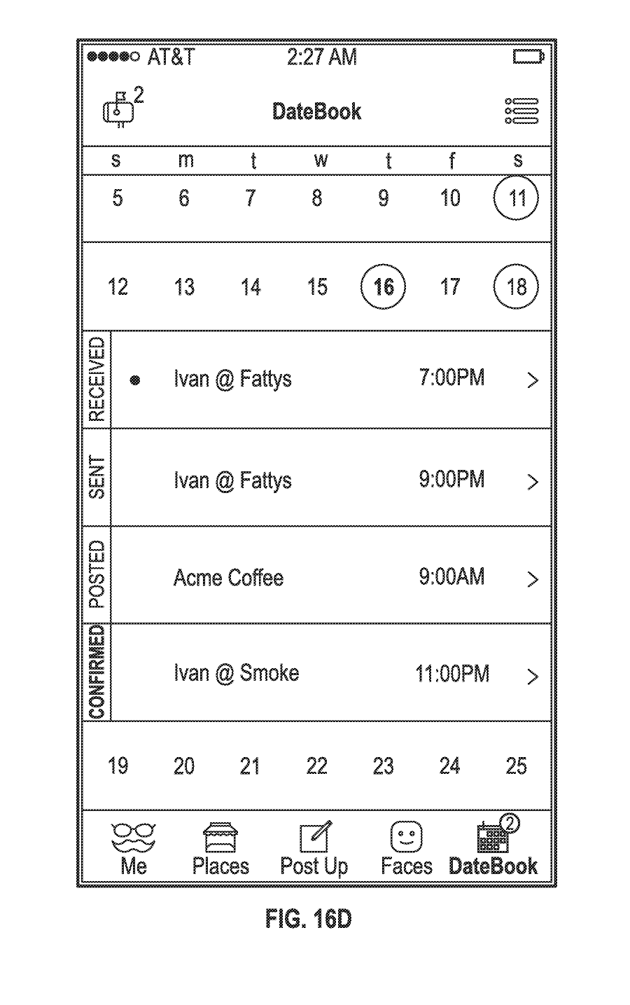

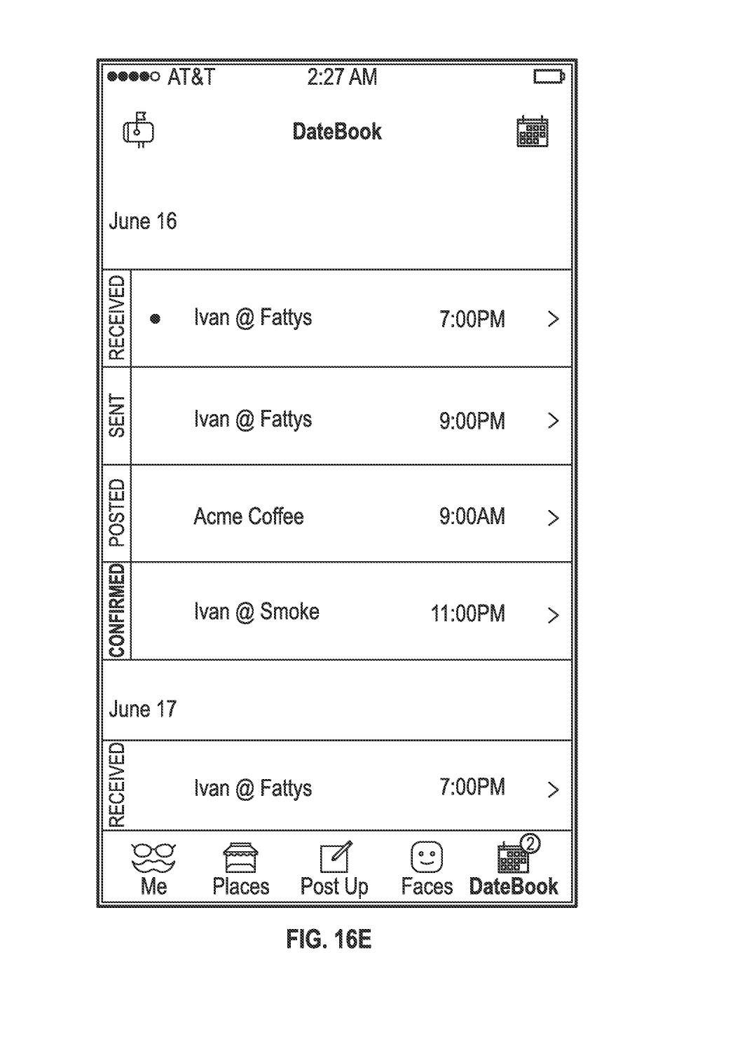

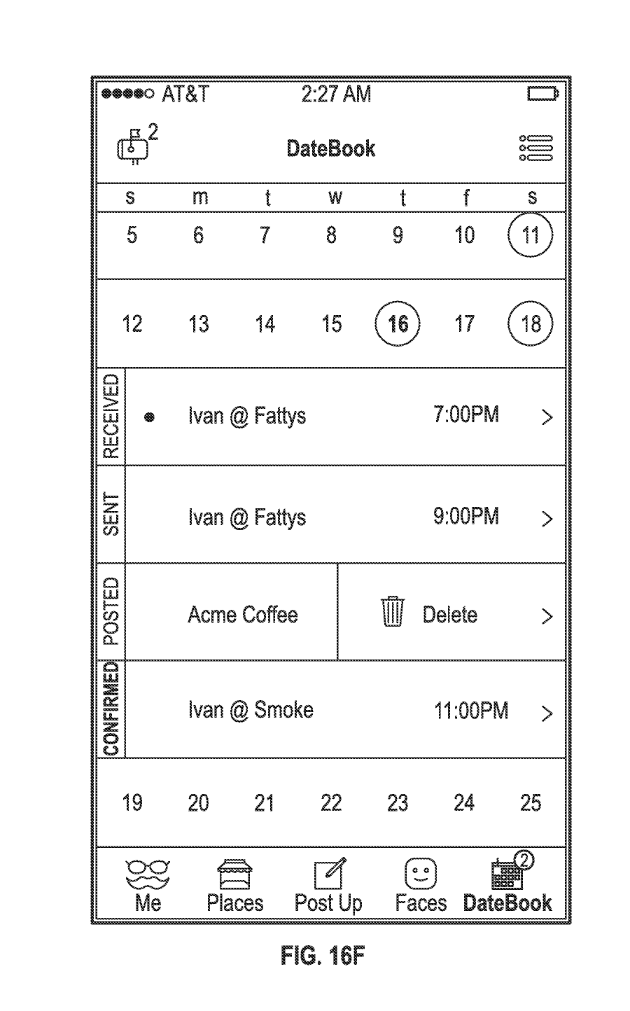

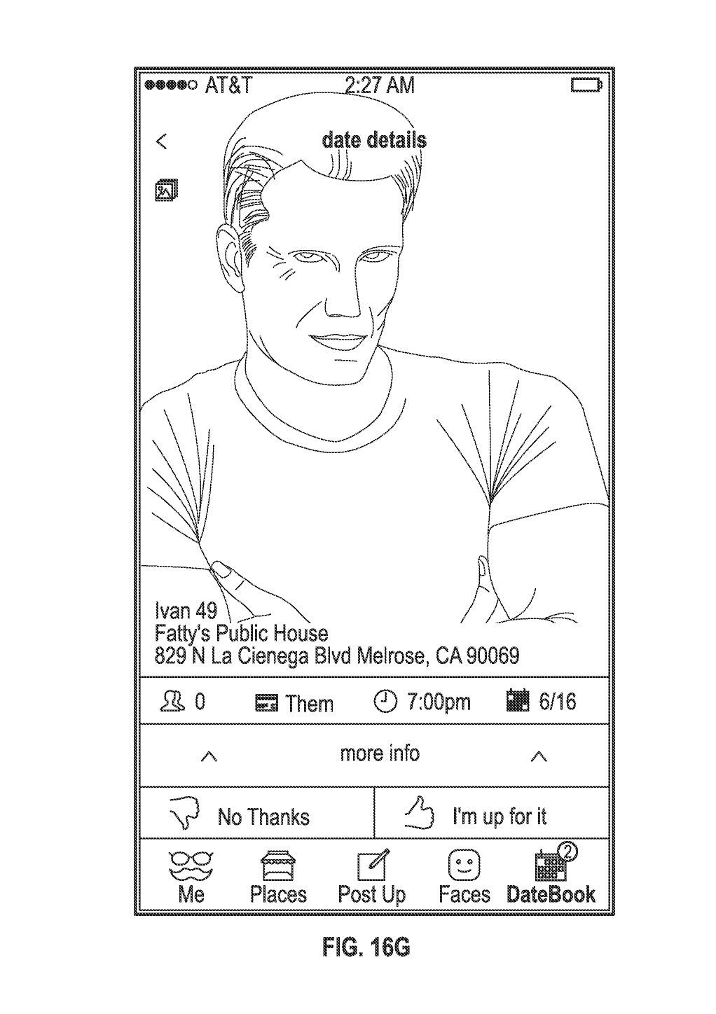

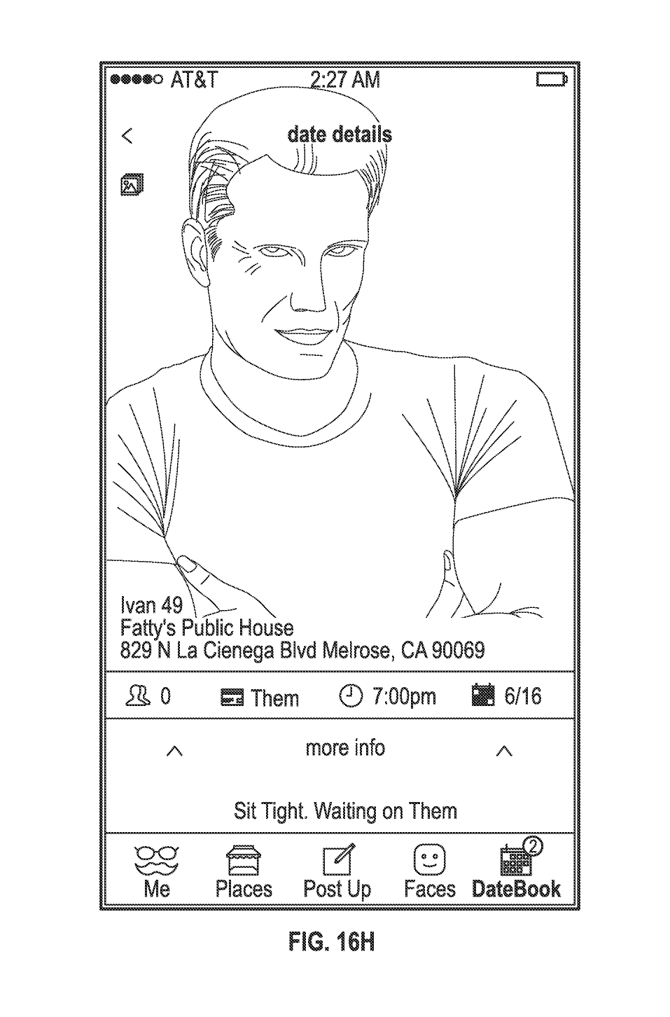

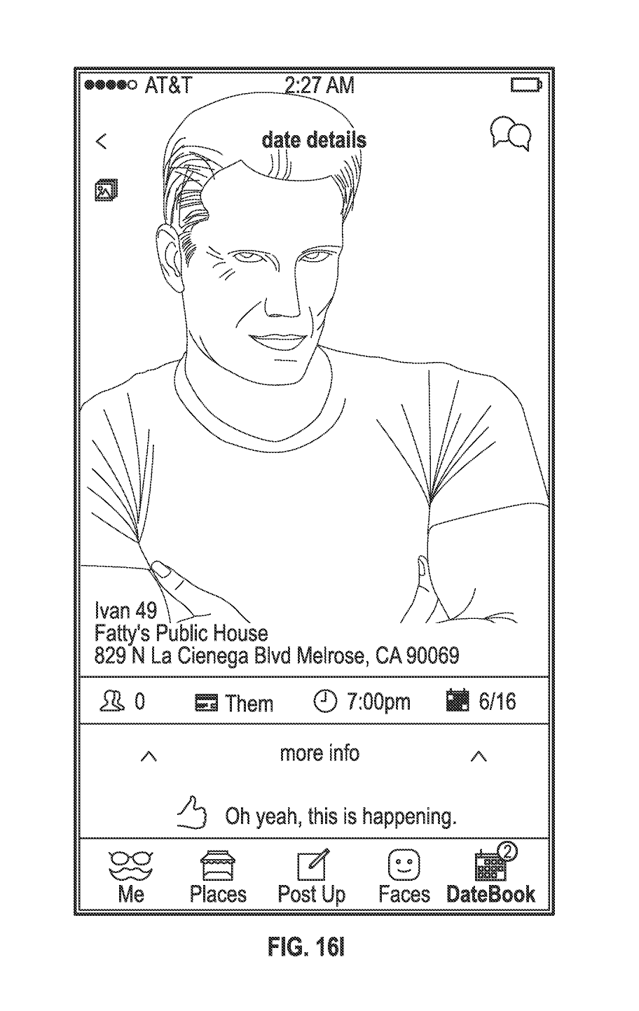

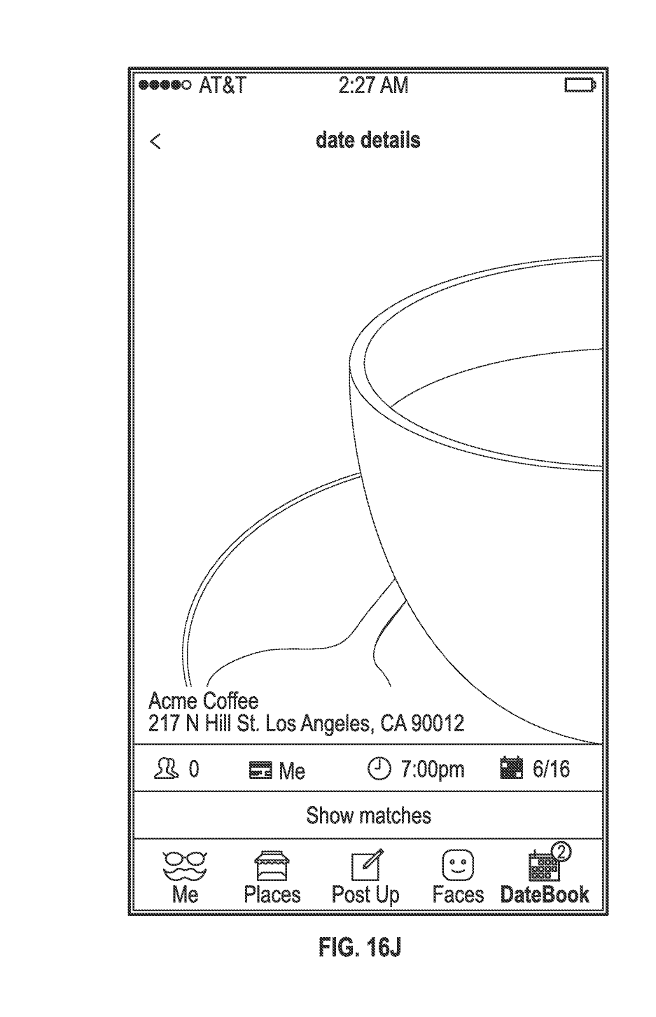

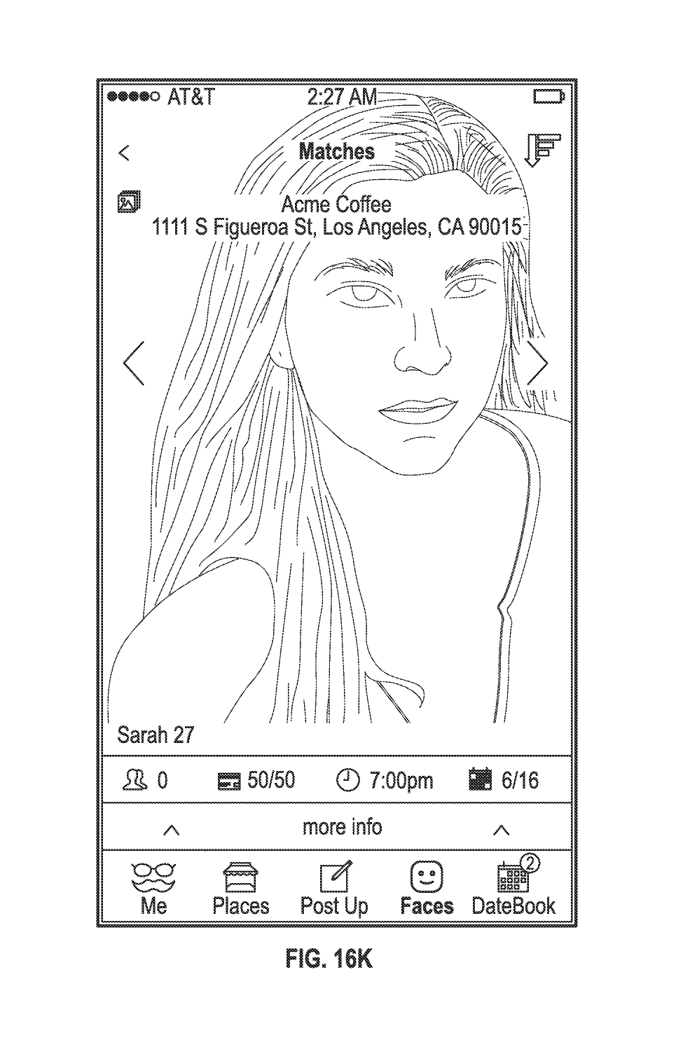

FIG. 16A illustrates an example alert user interface presented via the datebook. The various controls described herein may be selected using a selection mechanism, such as by way of example a mouse, trackball, a track pad, a finger or stylus (e.g., if a touch screen is being used), or otherwise. The alert user interface may be automatically displayed in response to one or more events. For example, optionally the alert user interface may be displayed in response to one or more of the following: detecting that the user has opened a dating application that comprises the datebook; detecting that the user has opened the datebook, detecting a change in status with respect to a dating event (e.g., one or more of the following: receipt of an invitation, acceptance of an invitation, expiration of an invitation, cancellation of a date, an upcoming scheduled date, opening of a messaging channel, receipt of a message from a date participant, etc.), receipt of a status message from the system operator, the user manually selecting an alert control, etc. A given alert entry may include an icon and text corresponding to the alert type. Where applicable, location, calendar and/or timing information may be included in an alert entry (e.g., an alert entry indicating acceptance of an invitation may include the location, calendar date, and/or time of the date). Optionally, the user may specify or modify which events (such as one or more of the events listed above) will cause the alert user interface to be presented, and the user specification will be stored for later access in determining when and which alerts are to be provided to the user. Optionally, the user interface may be configured to enable the user to delete a given alert entry or to indicate that the user has already reviewed the given alert entry, and the user deletion or indication may be stored. The alert user interface is optionally configured to enable the user to provide a gesture to swipe away or otherwise cause the alter user interface to be closed.

FIG. 16B illustrates an example chat user interface presented to the user or accessible to the user (e.g., when a chat channel opens, such as a predetermined amount of time before the scheduled date or after the date is confirmed). The user interface is configured to enable chat between the viewing user and the other date participant without the viewing user having to provide contact information for the other date participant (or vice versa). Optionally, the system routes communications between the viewing participant and the other date participant without revealing an email address, cell phone number, instant messaging address, of one date participant to the other date participant, ensuring privacy and avoiding unwelcome communications (e.g., if the date goes badly).

FIG. 16C illustrates the datebook calendar, enabling the user to select one or more calendar dates to view corresponding datebook entries/events in greater detail.

FIG. 16D illustrates an example list view of date events for calendars date(s) selected by the user via the user interface illustrated in FIG. 16C. The user interface may display the calendar dates and/or day names, list received invitations, sent invitations, dates posted by the user, confirmed/accepted dates, cancelled dates, etc. For example, a given datebook list entry may include some or all of the following: a notation indicating the date event type (e.g., received invitation, sent invitation, posted date, confirmed date, cancelled date, etc.), the name and/or other public profile information of the other party to the date, the name and/or other information regarding the date venue, the date time, and/or other information. An indication may be provided (e.g., a dot or other indicator) indicating unread communications. The list may be displayed together with at least a portion of the calendar user interface (e.g., the portion containing some or all of the selected calendar dates).

FIG. 16E illustrates an example list view of date events similar to that illustrated in FIG. 16D, without having the calendar user interface of FIG. 16C displayed. Optionally, lists for more than one day can be displayed at a time via this interface.

As illustrated in FIG. 16F, the datebook list user interface may be configured to enable the user to delete a date. For example, the user may swipe a date entry to cause a delete user interface to be displayed in associated with the swiped entry, and the user may then confirm deletion of the entry by selecting a delete control. The deletion will then be recorded by the system. By way of example, the list user interface may enable the user to delete a posted date or a confirmed date. If the user deletes a confirmed date, the system will detect such deletion and identify and inform the other date participant of the cancellation. The system will optionally delete the entry in the other date participant's datebook or provide an indication in the entry indicating that the date has been cancelled. If the system detects that the user cancelled a posted date, the system will store an indication that the date is no longer active and optionally will not display the date to other users (e.g., in response to a search for dates). If other users have sent invitations for the deleted posted date, the system optionally informs the users of the deletion, and optionally updates the status of their invitations in their datebooks accordingly (e.g., to indicate the invitation was declined and/or that the posted date has been cancelled).

FIG. 16G illustrates an example received date invitation user interface. The user interface may be displayed in response to the invitation being received, in response to the user selecting a corresponding datebook entry, or otherwise. The user interface may display some or all of the following date information: the calendar date and time for the proposed date, the date venue, who is to pay for the date, and the number of wing guests that will also go on the date. Optionally, the system will locate and provide for display (optionally simultaneously display) to the user, via the user device, some or all of the public profile of the person that issued the invitation. A user public profile may optionally include the user's name (e.g., first name, full name, alias name, etc.), and certain physical and/or personal characteristics about the user (e.g., age, height, weight, and/or other personal characteristics described elsewhere herein). Optionally, a control is provided (e.g., “more info”), which when activated will cause additional profile information to be provided. Controls may be provided via which the user can indicate acceptance of the invitation (“I'm up for it”) or may decline the invitation (“No thanks”).

FIG. 16H illustrates an example date invitation user interface for an invitation sent by the viewing user. The user interface may be displayed in response to the invitation being sent, in response to the user selecting a corresponding datebook entry, or otherwise. The user interface may display some or all of the following date information: the calendar date and time for the proposed date, the date venue, who is to pay for the date, and the number of wing guests that will also go on the date. Optionally, the system will locate and provide for display (optionally simultaneously display) to the user, via the user device, some or all of the public profile of the person that the invitation is being sent to. A user public profile may optionally include the user's name (e.g., first name, full name, alias name, etc.), and physical and/or personal characteristics about the user (e.g., age, height, weight, and/or other personal characteristics described elsewhere herein). Optionally, a control is provided (e.g., “more info”), which when activated will cause additional profile information to be provided. A notification may be provided indicating the invitation has not yet been accepted or declined (e.g., “Sit tight. Waiting on them”). If the recipient of the invitation accepts the invitation, the invitation status may change to indicate acceptance (e.g., “Oh yeah, this is happening”), as illustrated in FIG. 16I. If the recipient of the invitation declines the invitation, the invitation status may change to indicate the invitation has been declined (e.g., “Your invitation was declined. Try someone else, there are a lot of great people out there.”).

FIG. 16J illustrates an example date details user interface, which may be displayed at least partly in response to detecting that the user has selected a posted date entry from the datebook. The user interface may provide date details, such as, by way of example, the name of the date venue, the address of the date venue, how many wing guests/friends will be accompanying the matching user on the date, who will pay for the date, what time the date will take place, and on what calendar date the date will take place. A control (e.g., “Show matches”) is provided via which the user can instruct the system to locate matching posted dates.

FIG. 16K illustrates an example date match user interface displaying a photograph of a user who matches the viewing user's posted date criteria and other criteria specified by the user (e.g., personal characteristics criteria, such as age, height, etc.). The user interface illustrated in FIG. 16K may be displayed in response to detecting that the user activated the “Show matches” control illustrated in FIG. 16J. The example user interface may also display the date venue an address for the date posted by the matching user, selected profile information of the matching user (e.g., the matching user's age), and other date details, such as how many wing guests/friends will be accompanying the matching user on the date, who will pay for the date, what time the date will take place, and on what calendar date the date will take place. The user may scroll to other matches using the optional left/right scroll controls.

Optionally, “Places” may be organized into multiple categories (where a given place may be in more than one category). For example, “Places” may be characterized as dates that are scheduled to occur on the current day (“Up for Today”) in the user's vicinity (or in a larger geographical area), dates in the user's vicinity (or in a larger geographical area) that are trending up in popularity at a certain level (for dates that are scheduled to occur on the current day and future days), and dates that the individual user has posted for dates that are scheduled to occur on the current day or future days (e.g., “My Dates” or “Favorites”).

Optionally, dates (e.g., in the form of date listings) presented to the user may be presented in chronological order. For example, if dates scheduled to occur on a selected day are presented to the user, the dates may be presented in the time order the dates are scheduled to begin (e.g., first date at 6:00 AM, second date at 6:30 AM, third date at 6:45 AM, etc.). If dates for multiple days are presented to the user, then dates occurring on the soonest day are presented first in time order, dates for the second day are presented next in time order, and so on. A filter may be provided via which the user can specify filter criteria (e.g., specific calendar dates or ranges of calendar dates, locations, personal characteristics (e.g., height, hair color, weight, etc.), who will pay for which portion of the date, how many wing persons/friends will be on the date, etc. The system may receive and apply the filter criteria, and provide and present in chronological order the dates that satisfy the filter criteria, where a given date listing may include a user photograph and/or other information (e.g., name, height, weight, hair color, eye color, etc.).

Optionally, a user may send an electronic date “card” to one or more selected users that satisfy filter criteria (e.g., where the user can select other users by touching a respective user image displayed in the chronological listing of dates, or otherwise). The date card may include and/or may provide a link to summary information regarding the user that is sending the date card (e.g., name, photograph, and/or other information discussed herein) and/or regarding the proposed date (e.g., the calendar date, time, location, who is to pay for which portion of the date, etc.). Optionally, the chat user interface discussed above may be inhibited from enabling the user to chat with other users that are recipients of the date card, to avoid uncomfortable chat sessions until a date is accepted or until a specified period of time before an accepted date is scheduled to occur. Optionally, the first recipient of the date card that accepts the date will be entitled to the date, and the other date cards with expire.

Certain example “place” user interfaces will now be described.

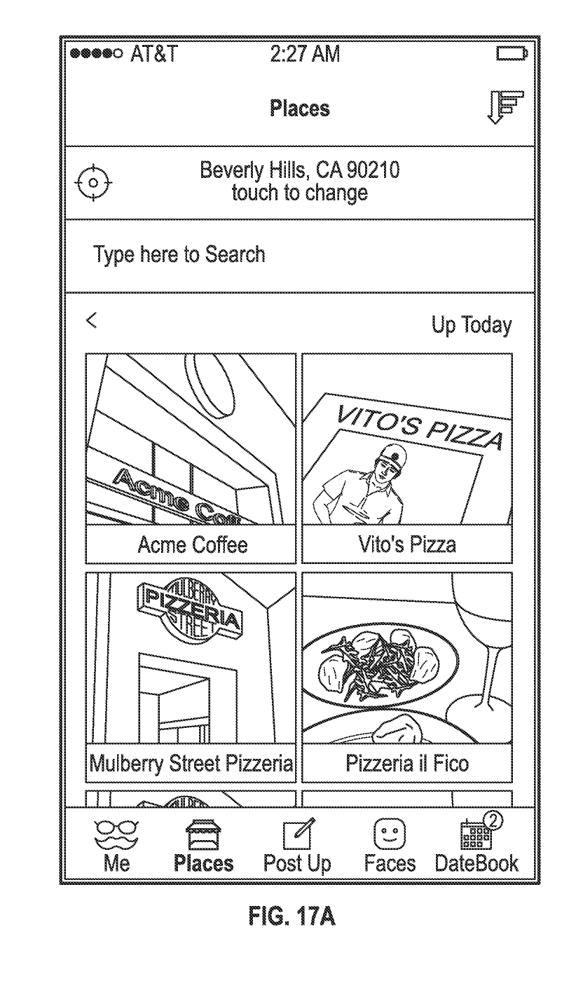

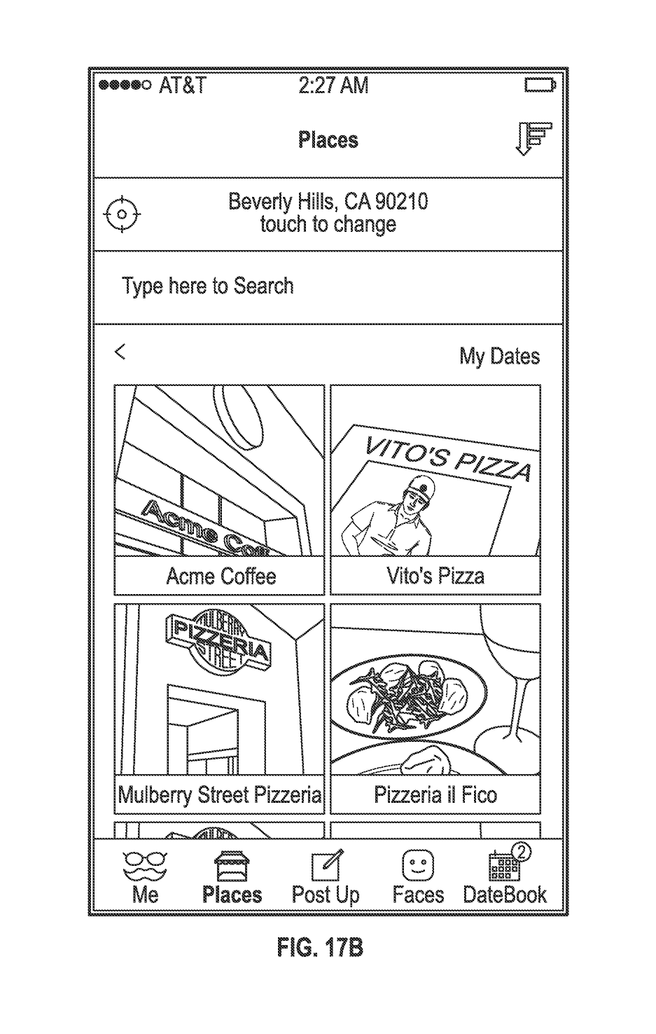

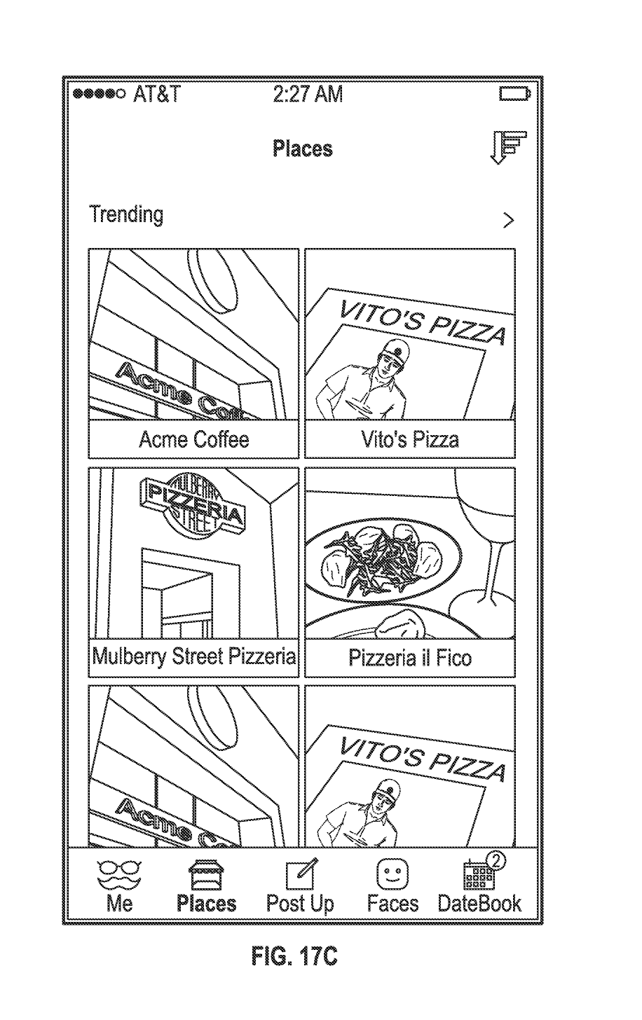

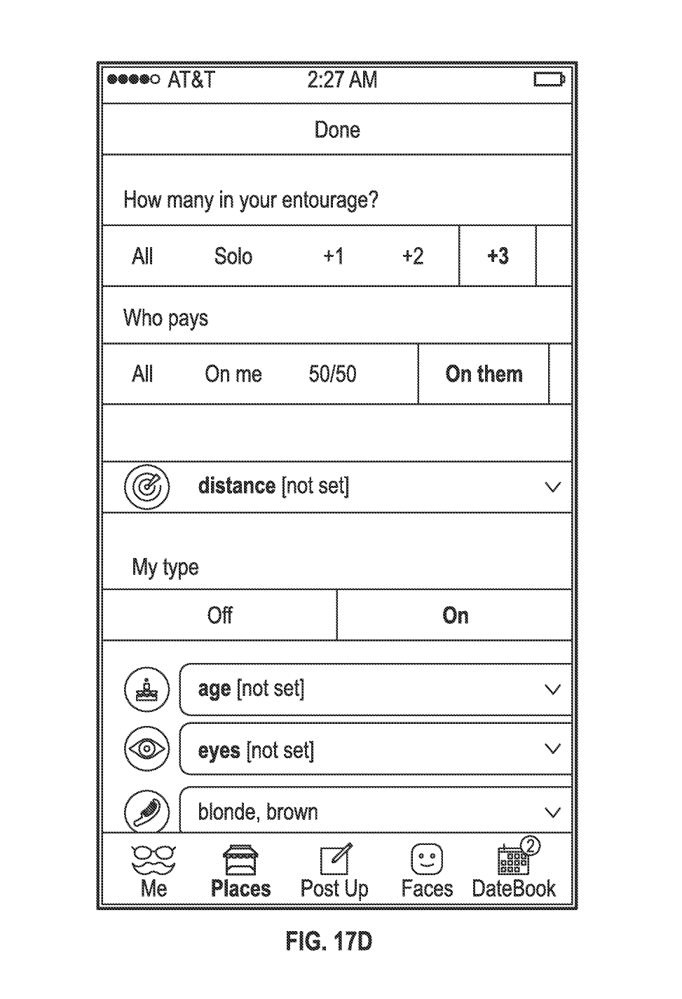

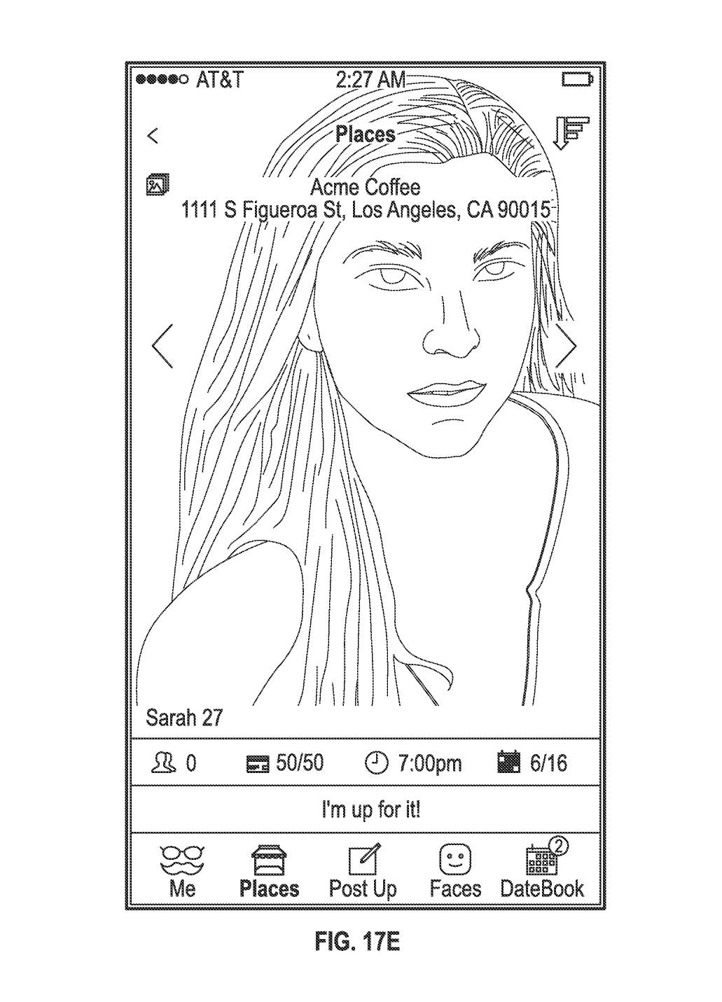

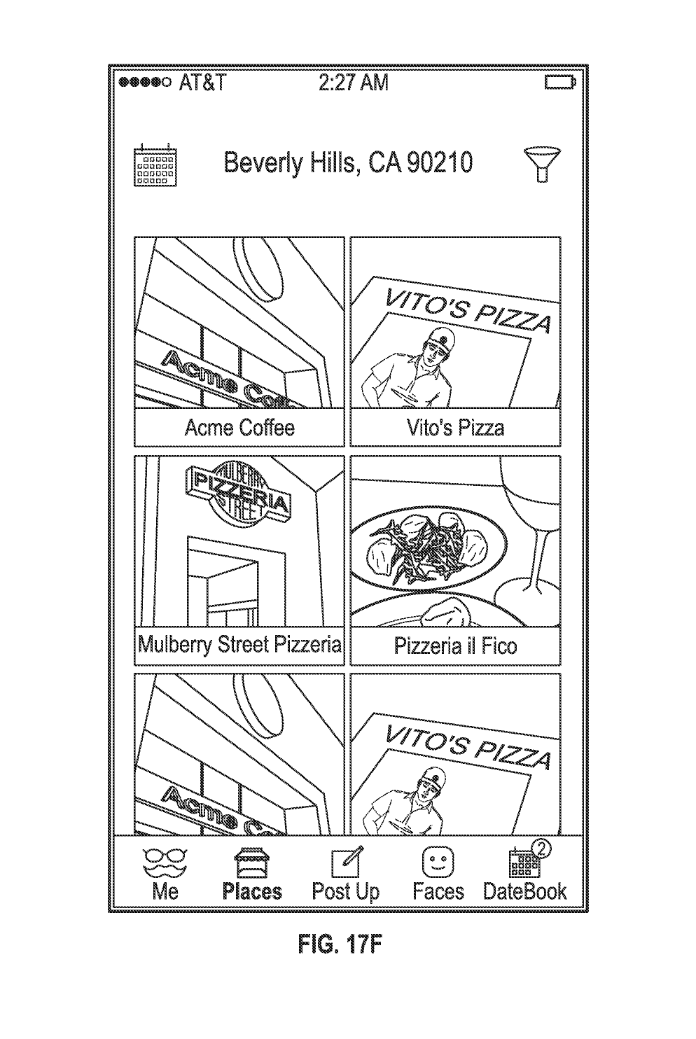

FIG. 17A illustrates an example user interface (“Up for Today”) displaying photographs and venue names associated with venues for which dates are scheduled for the current day, where the venues are in the area of the city (or other locale) whose name is displayed in an area field. The user can change the area by selecting the area field, and searching for or manually entering a new area. For example, the venue photographs may be of the venue, of a venue sign, of a menu from the venue, of a dish from the venue, of a logo of the venue, etc. FIG. 17B illustrates an example user interface displaying photographs and venue names associated with venues for which the viewing user has posted dates scheduled to occur in the future (“My Dates”). FIG. 17C illustrates an example user interface (“Trending”) displaying photographs and venue names associated with venues that are trending (becoming increasingly popular over a recent period of time, such as over the previous 24 hours, week, or month).

FIG. 17D illustrates a “places” filter via which the user can instruct the application to system to filter the places/venues presented to the user by specifying matching criteria for posted dates and/or for the users that posted the dates. The example user interface includes controls via which the user can specify how many wing guests/friends will be in the user's entourage. In this example, the user can select solo (meaning the user will not be bringing any friends), one wing guest, two wing guests, or three wing guests (of course, the user interface may enable the user to indicate more than three friends will be accompanying the user). If the user specifies “all” then the entourage criteria will not be used as a match filter. The example user interface includes controls via which the user can specify who pays for the date. In this example, the user is presented with three options, the posting user will pay (“me”), the parties to the date will each pay half (“50/50”), or the other party to the date will be paying for the entire date (“them”). Optionally, fewer or additional options may be offered (e.g., the options may include each party will pay for what that party orders). If the user specifies “all” for “who pays” then the “who pays” criteria will not be used as a match filter. The example user interface includes controls via which the user can specify the maximum distance of a place/venue from the user's current location or from the user's address specified in the user's profile or otherwise. If the user does not specify a distance, then distance will not be used as filter criteria. A control is provided via which the user can also turn on or off personal characteristics to be used as filter criteria. In addition, controls are provided via which the user can specify the personal characteristics to be used as filter (e.g., age, eye color, hair color, height, weight, etc.). If a user does not set a given personal characteristic, such personal characteristic will not be used as a filter.

FIG. 17E illustrates an example place/user match located by the system or application after the filter has been applied. The match lists the name and address of the matching place and a photograph of a matching user that has a date posted for the matching place. Optionally user profile information may also be provided for display. The user may issue an invitation by selecting an invitation control (e.g., “I'm up for it!”).

FIG. 17F illustrates an example user interface displaying venue-related images and venue names, where the venues are in the area of the city (or other locale) whose identifier (e.g., city or county name and/or zip code) is displayed in an area field. The user can change the area by selecting the area field, and searching for or manually entering a new area. For example, the venue photographs may be of the venue, of a venue sign, of a menu from the venue, of a dish from the venue, of a logo of the venue, etc. The illustrated example user interface includes a calendar icon in the upper left hand portion of the user interface. In response to the user selecting the calendar icon, the application displays a calendar user interface (which may optionally be independent of the datebook). The calendar user interface may display the days of the current week, the next 7 days, the current month, the next 30 days, a two week period, a two month period, or other period. Optionally, if a calendar date is displayed that has already passed, such date is visually deemphasized (e.g., by displaying the date number with less intensity and/or with a muted color, such as gray) relative to displayed current or future calendar dates, and/or is non-selectable. The user can select a desired calendar date (or multiple calendar dates) from the calendar user interface, and in response to detecting the user selection, the application may display venues (e.g., venue-related images and/or venue names) for which dates have been posted for the selected calendar date. If the user selects one or more of the displayed venues, the application will access images (and optionally names) of the users who posted dates for the selected venue(s) for the selected calendar date(s), and will display at least a portion of the corresponding user images (and optionally associated names) to the user via the user terminal.

Referring again to FIG. 17F, a filter icon, in the shape of a funnel, is provided in the upper right hand corner of the user interface. Selecting the filter icon causes the application to present a filter user interface, such as the example user interface illustrated in FIG. 17D, enabling the user to provide various filter criteria, such as which date participant pays for the date or a portion of thereof, how many wing guests/friends will be attending, desired personal characteristics (e.g., height, age, hair color, drinking habits, etc.), etc. In response to the user selecting a done control, the application (or other system) will filter the posted venues based on the filter criteria specified by the user, and will refresh the user terminal display to display those venues that satisfy the filter criteria.

As noted above, dates may be categorized by faces, where instead of initially starting with a location, dates are organized according to other users (where faces are first displayed to a viewing user rather than date locations). For example, optionally initially, multiple faces (photographs of faces) are displayed at the same time on the user device and the user can choose to view the faces in a larger format (e.g., where relatively fewer photographs of faces are displayed at one time, such as one at a time). Optionally, the system will filter those faces displayed to the user so only those users that have active posted dates within the user's geographic region will be displayed to the user. Thus, for example, if all of a given user's posted dates have expired, optionally the system will filter out photographs of such user so that the such user's face will not appear in the faces or places presented to the viewing user (and so may thereby inhibit the viewing user, who is looking for a date, from contacting users that do not have any active posted dates). Further, by optionally only posting images/information of users with current or prospective posted dates, the system avoids wasting a viewing user's time and effort that would otherwise be consumed by attempting to communicate with individuals that are no longer active on the dating site hosted by the system and may be no longer interested in going on dates arranged via the dating system.

The faces presented to the user may be organized by the system into multiple categories (where a given face/user may be in more than one category). For example, a user interface may be presented to the user of users' faces having dates posted for the current day (e.g., “Up Today”), and another user interface may be presented to the user including those users that have posted future dates beyond the current day (e.g., “What's Up”). Other example categories and corresponding user interfaces may include a category where the user posting the date is willing to pay for both parties to the date, where the posting user is willing to pay for their share of the date, where the posting user is not taking any wing guests along on the date, where the posting user is taking wing guests along on the date, where the posted date is scheduled for the upcoming week, during the current month, and/or other time period.

Optionally, if the system detects that the user has selected a given displayed user face (e.g., by tapping on the face or clicking on the face or an identifier associated with the face), the system will locate and display other dates (e.g., scheduled to occur in the future) that have that have been posted by that person. The posted dates of a selected user may presented to the viewing user organized by calendar date (e.g., soonest to most distant in time, or most distant in time to soonest), by place (e.g., closest to furthest, furthest to closest, most preferred to least preferred, least preferred to most preferred, etc.), alphabetically, reverse alphabetically, by age or reverse age, by height or reverse height, etc.

By way of illustration, the system enables the user to search, via the search engine, through users/faces that meet certain date location characteristics. For example, through the use of a user-specified keyword (e.g., coffee, bar, park, movie, Acme Tea) the user can restrict the search to only those users that are going to a venue corresponding to the keyword. Similarly a user can search for users that have posted dates for a specific area/neighborhood (e.g., Westwood), city (e.g., Culver City), or zip code (e.g., 90004), are willing to pay for both parties to the date, are taking at least one wing guest, etc. By way of example, the user may search for or sort dates based upon the date's geographic proximity to the user. Optionally, the dates may be organized and displayed to the user (in ascending or descending order) by default or in response to a user command, based as time, calendar day, who pays (e.g., where one person may pay for both parties to the date, or which each person may pay for their portion or half of the date), or how many people are in the user's entourage. In addition, the system may enable the user to search, filter, or sort search results based on other physical and personal characteristics. As similarly noted above, a given user (e.g., a photograph of the user) in the search results is associated with specific, active posted date, optionally including such related information as time, calendar day, who pays, and how many people are in the user's entourage (e.g., how many wing guests will be accompanying the user on the date).

Advantageously, the system optionally stores information, such as how many dates a user has already gone on, in what geographic area users have gone on dates, at what types of venues users have gone on dates to (e.g., bars, coffee houses, restaurants, etc.), the names of the venues users have gone on dates to, the calendar dates on which users have gone to a particular venue for a date, ratings posted regarding users by other users, etc. This enables a user to conduct even more sophisticated and detailed searches via the system. For example, the user may optionally search for other users that have gone on the most dates (e.g., the 10 most prolific date goers over the last 3 months, most dates in a defined geographic area, most dates to bars, coffee shops or even most dates to a specific location (e.g., ACME Art Museum)), highest rated users, etc. In addition, as similarly discussed above, optionally the user can instruct the system to sort search results based on one or more of the foregoing parameters and/or on other parameters discussed herein.

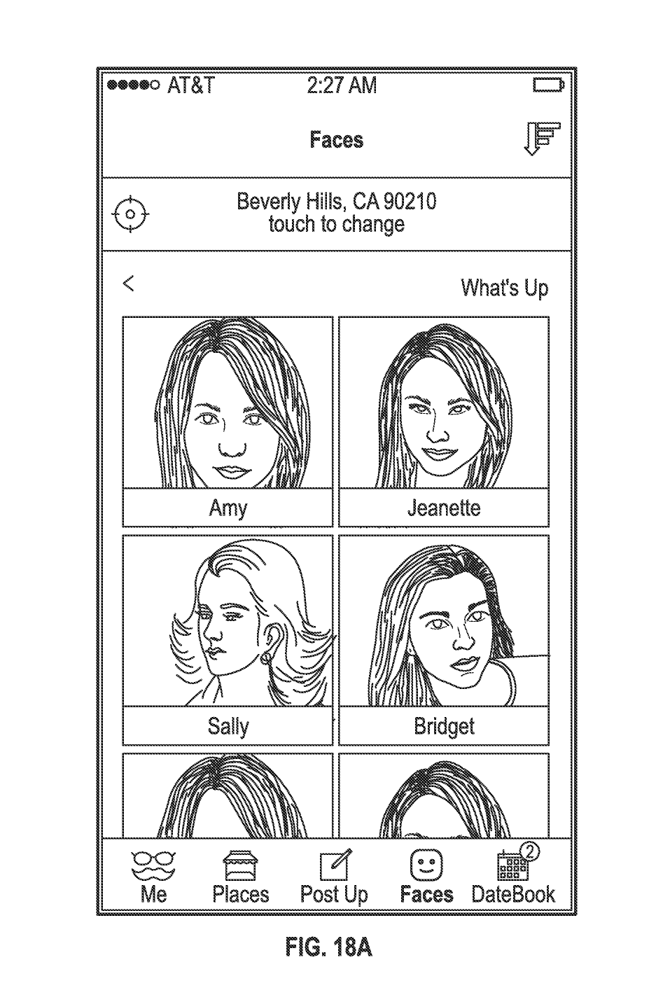

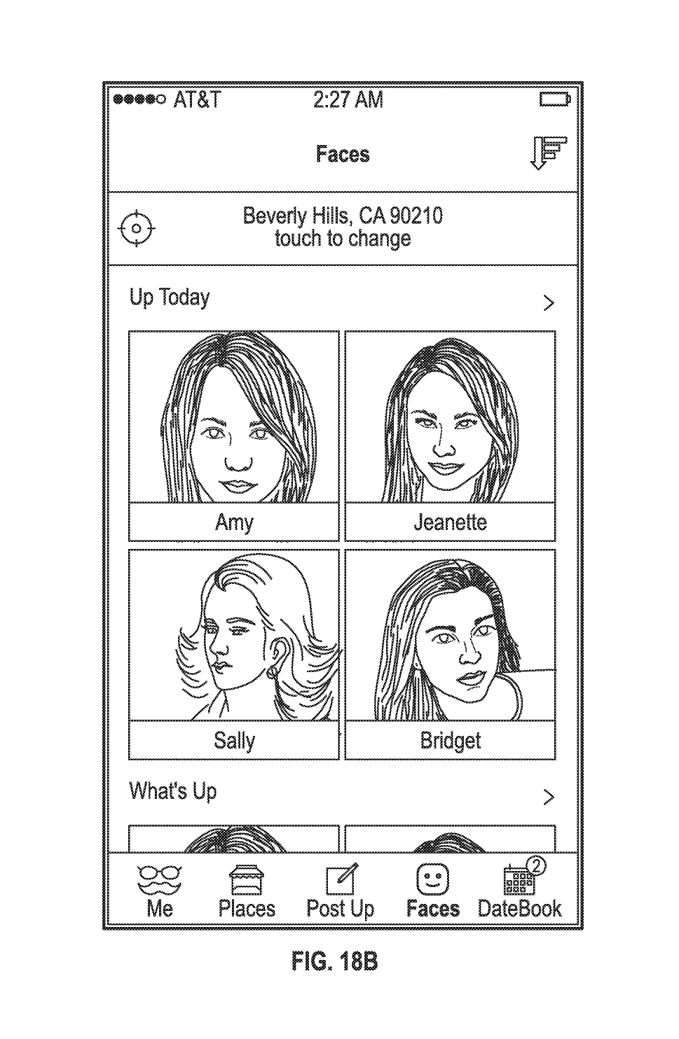

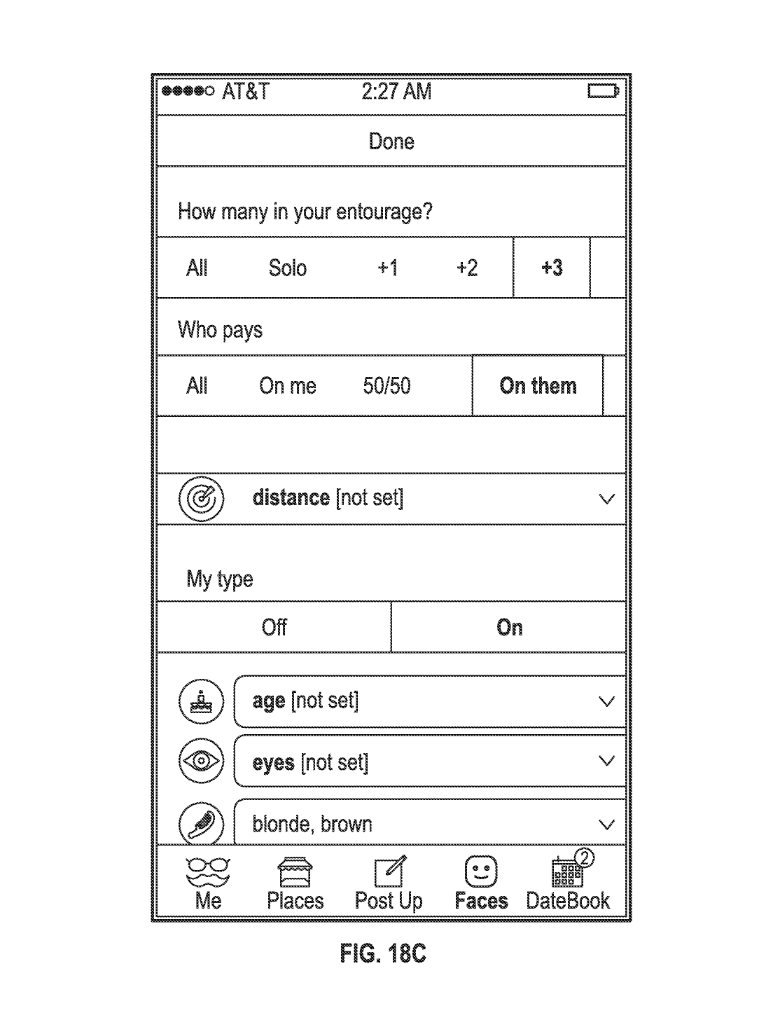

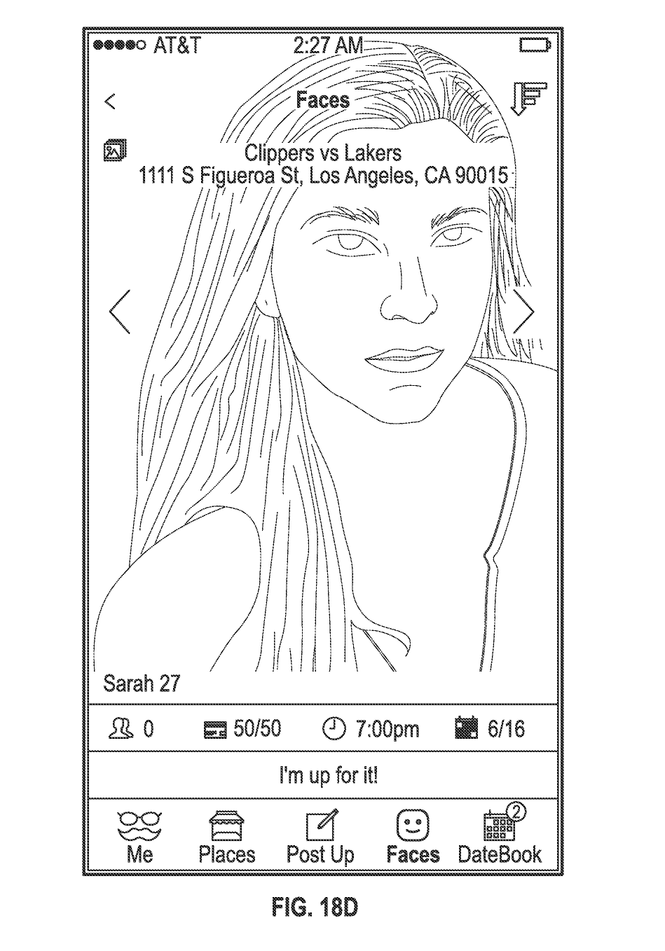

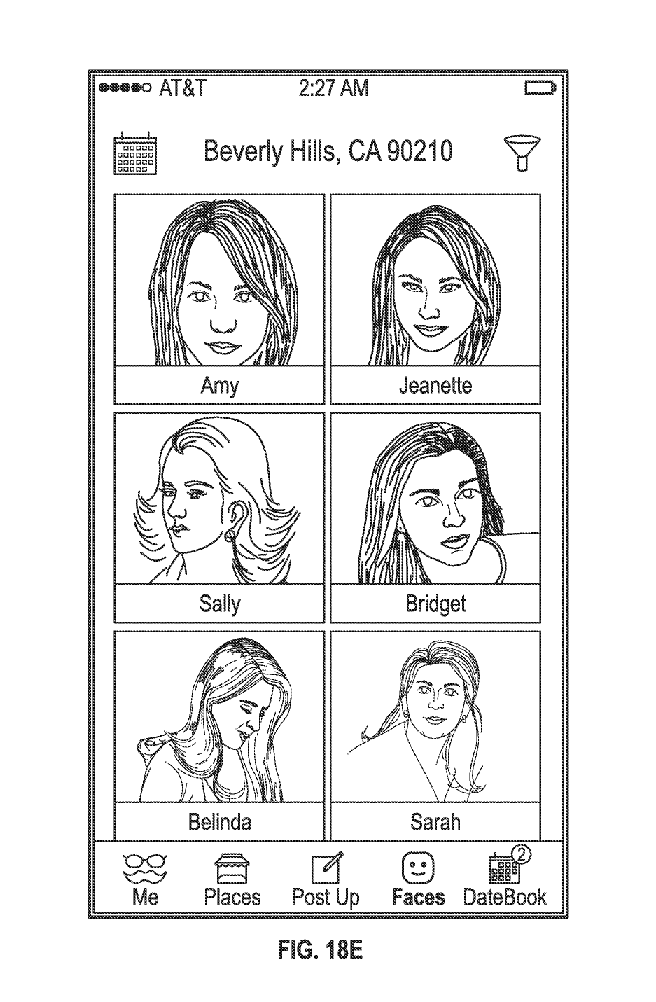

Example “faces” user interfaces will now be described. FIG. 18A illustrates an example user interface presenting photographs of users within or adjacent to the area listed in the area field that have posted future dates beyond the current day (and optionally including users that have dates posted for the current date). Optionally, if it is detected that the user has selected a photograph (e.g., by tapping it), some or all active, future dates posted by the corresponding user may be displayed to the viewing user (e.g., organized in ascending or descending order by calendar date, distance from user, place, location (e.g., area, city, zip code, etc.), alphabetically, number of wing guests, who pays, other date details, etc.), enabling the user to issue an invitation for one or more of the future dates to the selected user. FIG. 18B illustrates an example user interface (“Up Today”) presenting photographs of users within or adjacent to the area listed in the area field that have dates posted that are scheduled for the current day. The user can change the area by selecting the area field, and searching for or manually entering a new area.

FIG. 18C illustrates a filter via which the user can filter the places/venues presented to the user by specifying matching criteria for posted dates and/or for the users that posted the dates. The example user interface includes controls via which the user can specify how many wing guests/friends will be in the user's entourage. In this example, the user can select solo (meaning the user will not be bringing any friends), one wing guest, two wing guests, or three wing guests (of course, the user interface may enable the user to indicate more than three friends will be accompanying the user). If the user specifies “all” then the entourage criteria will not be used as a match filter. The example user interface includes controls via which the user can specify who pays for the date. In this example, the user is presented with three options, the posting user will pay (“me”), the parties to the date will each pay half (“50/50”), or the other party to the date will be paying for the entire date (“them”). Optionally, fewer or additional options may be offered (e.g., the option may include each party will pay for what that party orders). If the user specifies “all” for “who pays” then the “who pays” criteria will not be used as a match filter. The example user interface includes controls via which the user can specify the maximum distance of a place/venue from the user's current location or from the user's address specified in the user's profile or otherwise. If the user does not specify a distance, then distance will not be used as filter criteria. A control is provided via which the user can also turn on or off personal characteristics to be used as filter criteria. In addition, controls are provided via which the user can specify the personal characteristics to be used as filter (e.g., age, eye color, hair color, height, weight, etc.). If a user does not set a given personal characteristic, such personal characteristic will not be used as a filter.

FIG. 18D illustrates an example user/place match located after the filter has been applied. The match lists the name and address of the matching place and a photograph of a matching user that has a date posted for the matching place. The user interface enables the user to scroll through matched by activating the left or right matches. Optionally, the user can select a zoom control to cause more than one match to be displayed at a time, wherein the photographs may be displayed in a smaller format.

FIG. 18E illustrates another example user interface presenting photographs of users within or adjacent to the area listed in the area field that have posted future dates beyond the current day (and optionally including users that have dates posted for the current date).

The illustrated example user interface includes a calendar icon in the upper left hand portion of the user interface. In response to the user selecting the calendar icon, the application displays a calendar user interface (which may optionally be independent of the datebook). The calendar user interface may display the days of the current week, the next 7 days, the current month, the next 30 days, a two week period, a two month period, or other period. Optionally, if a calendar date is displayed that has already passed, such date is visually deemphasized (e.g., by displaying the date number with less intensity and/or with a muted color, such as gray) relative to displayed current or future calendar dates, and/or is non-selectable. The user can select a desired calendar date (or multiple calendar dates) from the calendar user interface, and in response to detecting the user selection, the application may display images of users that have posted dates for the selected calendar date(s). If the user selects one of the displayed user images, the application will access date posting information for the user whose image was selected and present at least a portion of the date posting to the user. For the example the date posting information may include the user name, date venue, location (e.g., area, city, zip code, etc.), number of wing guests, and indication as who will pay for the date, other date details, etc., and may enable the user to issue an invitation for the posted date to the selected user.

Referring again to FIG. 18E, a filter icon, in the shape of a funnel, is provided in the upper right hand corner of the user interface. Selecting the filter icon causes the application to present a filter user interface, such as the example user interface illustrated in FIG. 18C, enabling the user to provide various filter criteria, such as which date participant pays for the date or a portion of thereof, how many wing guests/friends will be attending, desired personal characteristics (e.g., height, age, hair color, drinking habits, etc.), etc. In response to the user selecting a done control, the application (or other system) will filter the posted images based on the filter criteria specified by the user, and will refresh the user terminal display to display those user images for users that satisfy the filter criteria.

As noted elsewhere herein, the system may enable a date participant to rate another participant. For example, after a date has been scheduled to occur, the system may optionally automatically transmit a request to both parties to the date to rate the date experience and/or various aspects of the date. For example, the user may be asked by the system to respond to one or more of the following queries (and/or other queries): Did your date show up? Was your date courteous? Was your date on time? Was your date's public profile accurate, inaccurate, in between? How would you rate your date (e.g., using a numeric or star scale (1-5), a letter grade, or otherwise). Optionally, the ratings may be stored and later displayed to one or more users in association with a corresponding user's profile and/or posted date so that other users may take such rating into consideration in deciding who to go on a date with. Optionally, the ratings are displayed anonymously.

Certain additional example user interfaces will now be described with respect to posting a date. In these optional user interfaces, the user is only asked to perform one posting step per user interface, making the posting process intuitive and easy to perform. Optionally, however, the user may be asked to perform more than one posting step per user interface. In addition, while the following description may refer to certain user interfaces being presented in a certain sequence, optionally, the user interfaces may be presented in a different sequence. By way of example, the user interfaces may accept location information from a user (e.g., zip code, area, city, etc.), a selection or entry of a venue category (e.g., movie, coffee, restaurant, etc.), identify and access from a system or third party venue database matching venues, and enable the user to post the date for a selected matching venue at a user specified date, with user specified date related criteria (e.g., time, who pays, how many wing guests, etc.). Optionally, when the user has completed the posting process, the system or application may return the user to the initial posting user interface, which displays the previously presented list of matching venues in the selected/specified location without re-accessing a third party venue database, thereby eliminating or reducing the need of the system to access the third party venue database, reducing computer and network utilization, and potentially, third party fees. Optionally, the posting process is configured to take an average user less than 15 seconds to post a date, with 6 or less posting steps, although optionally it may take longer and involve more than 6 steps. However, keeping the posting process to 15 or less seconds, involving 6 or less steps, will result in users posting many more dates as compared to longer, more involved posting processes.

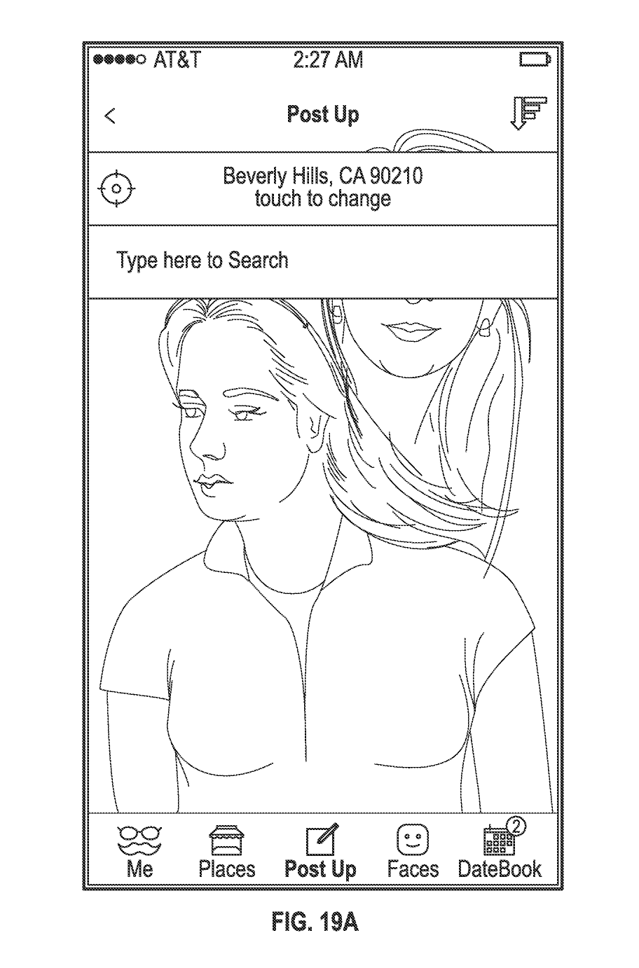

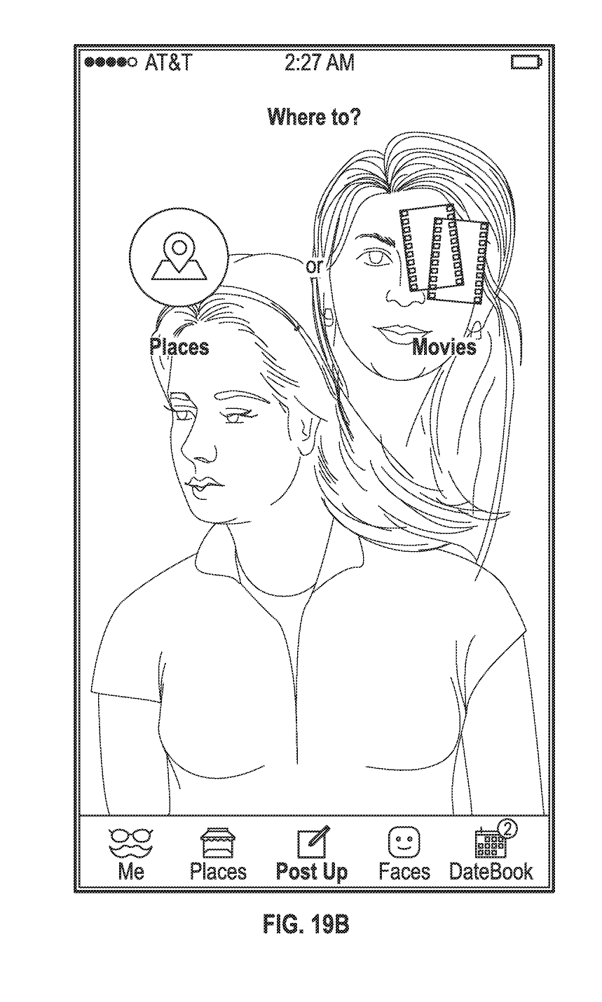

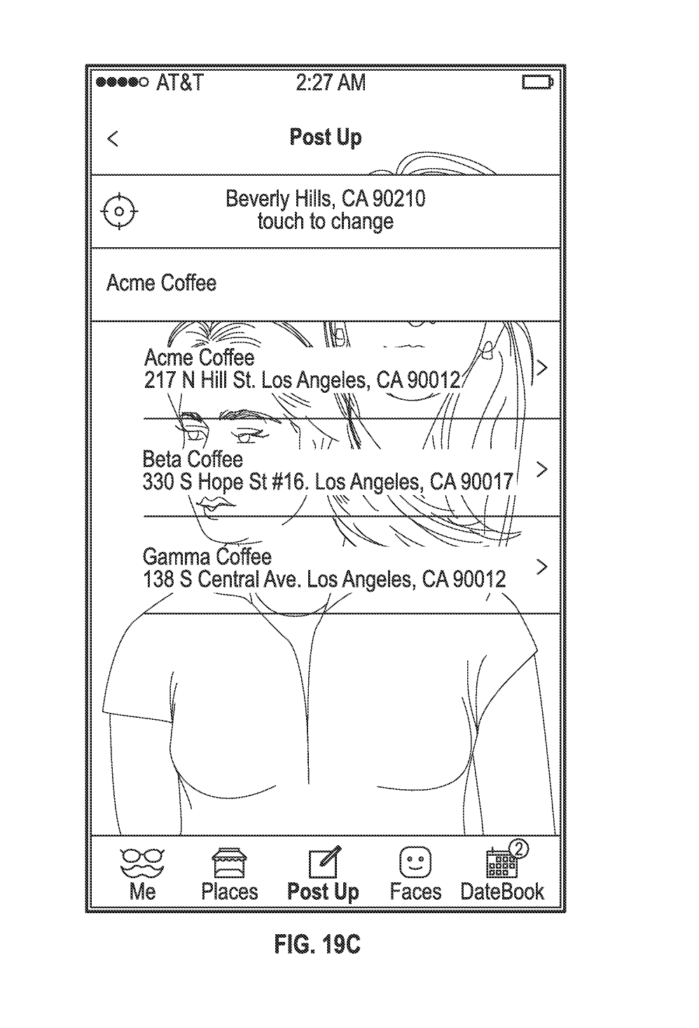

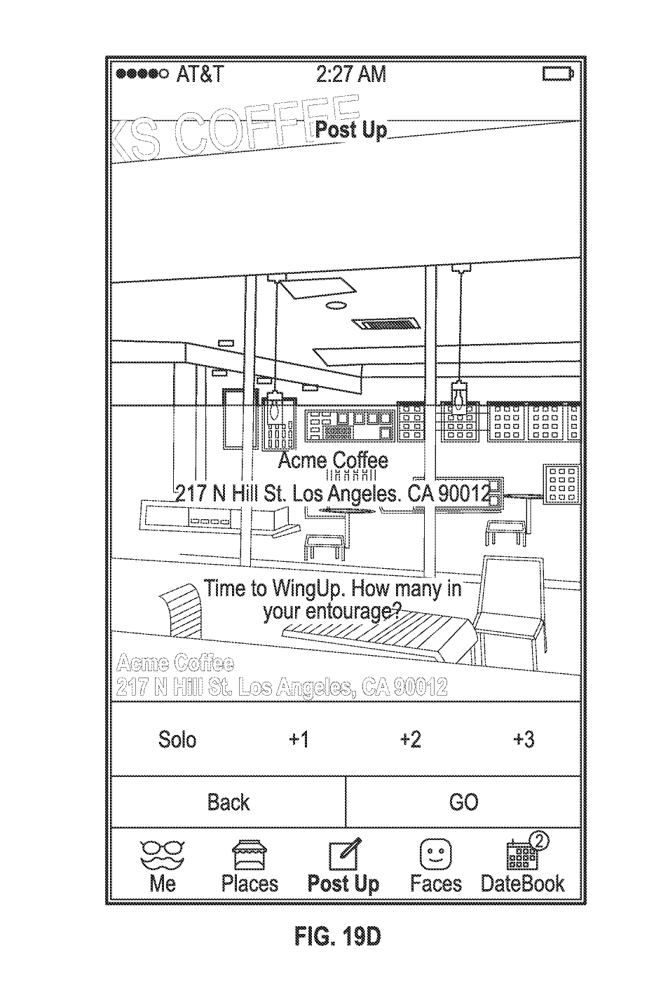

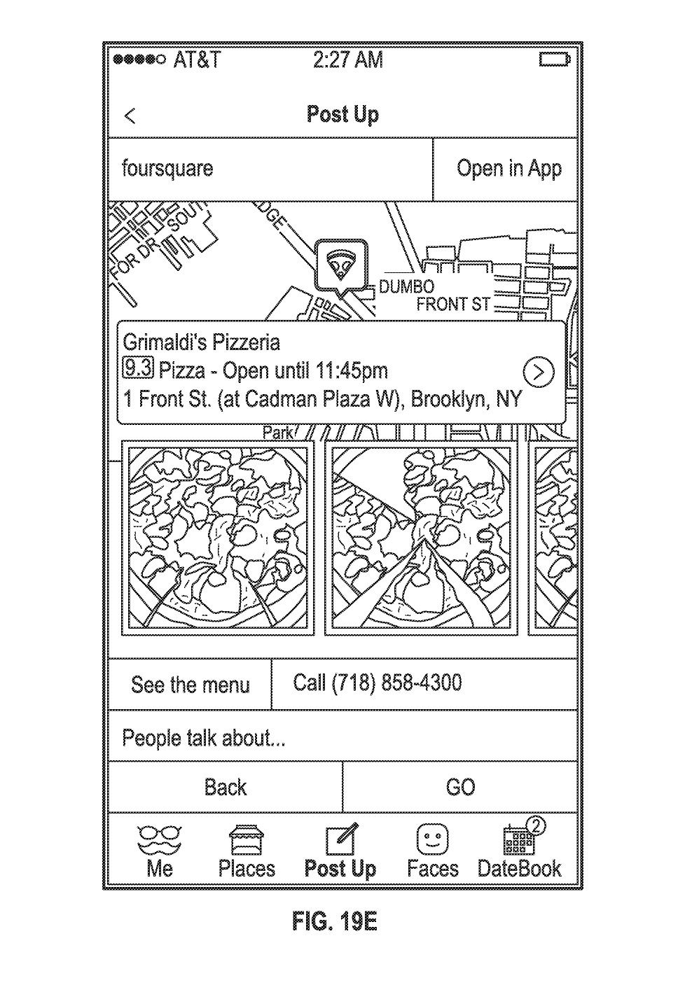

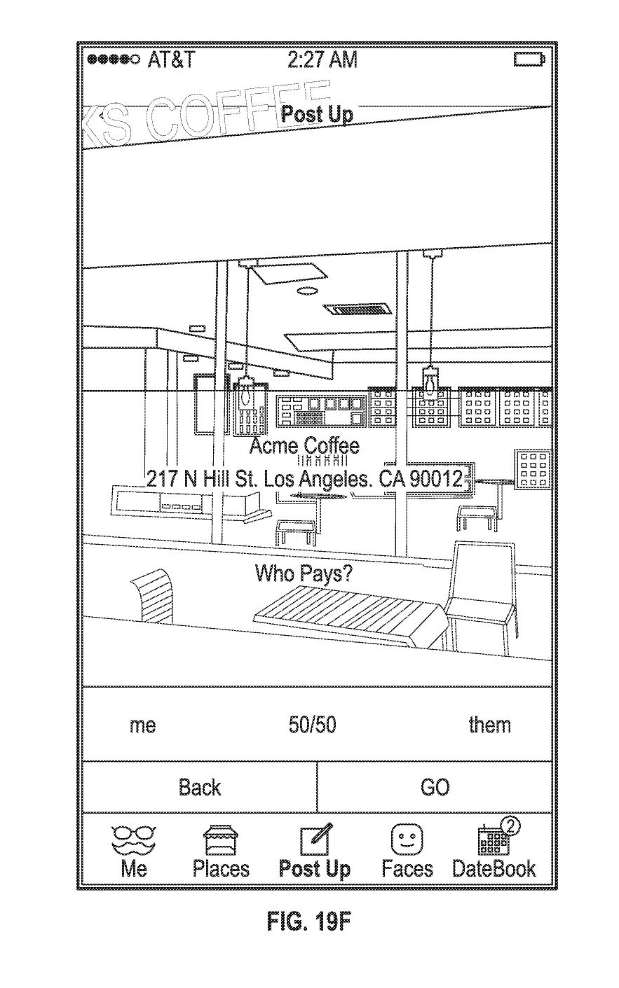

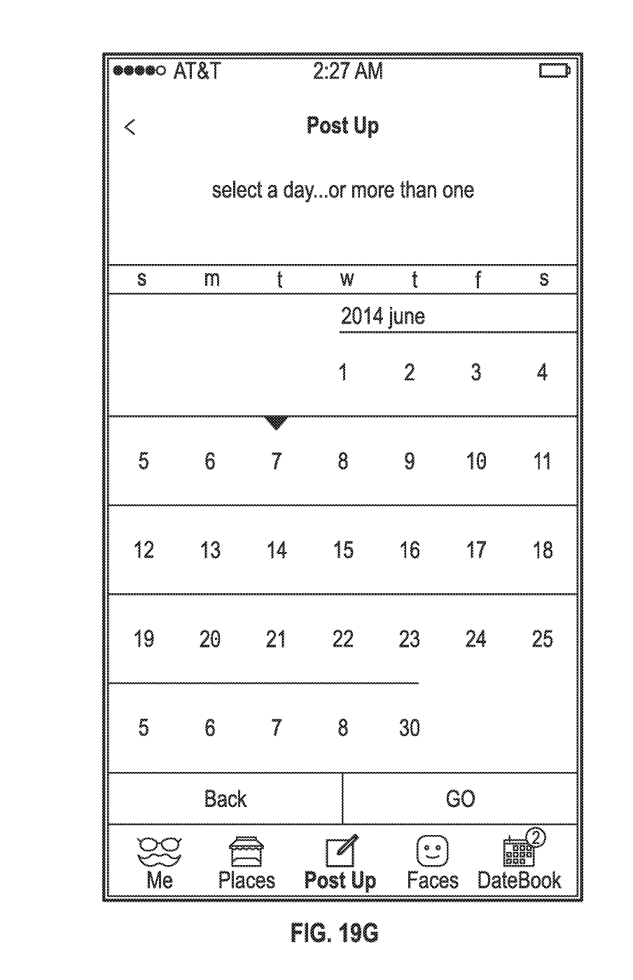

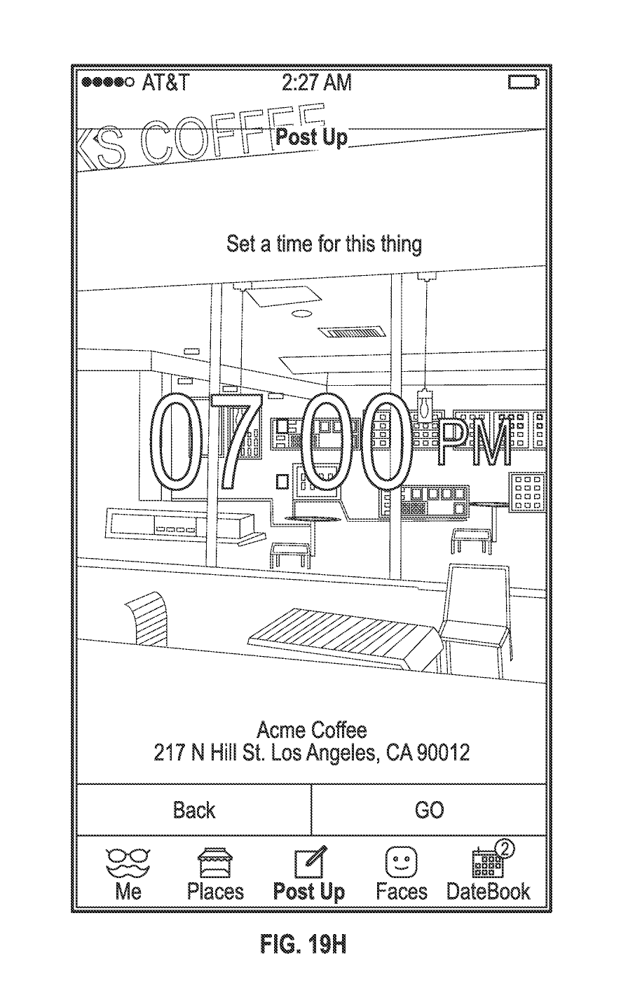

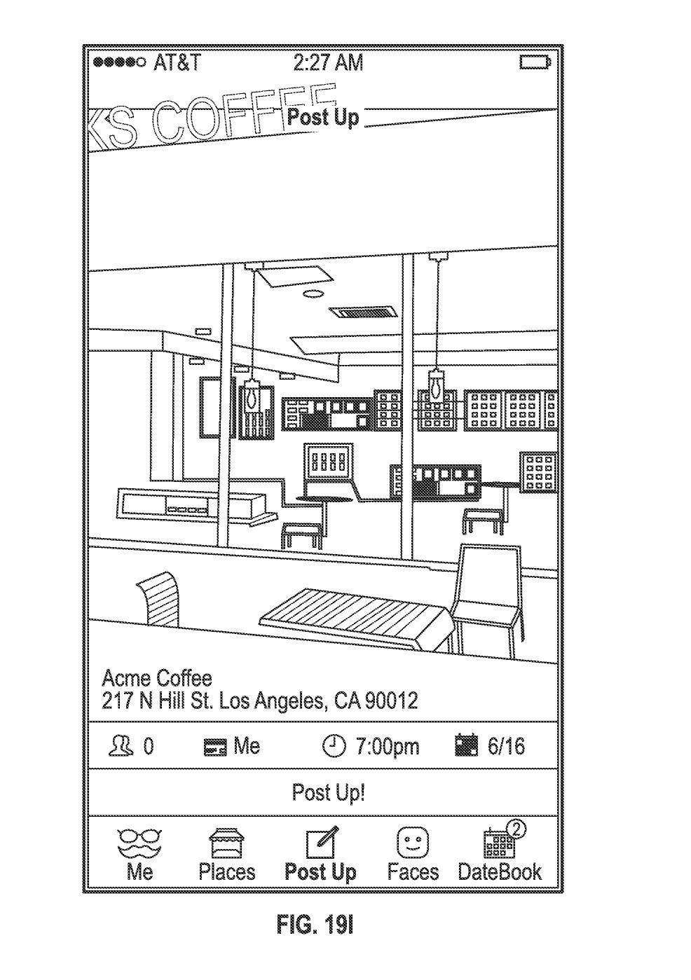

Referring to FIG. 19A, a first posting user interface is provided for display (e.g., on a user mobile device with a touch screen or other user device). This user interface is used to set the geographic location of the date. The location may be prepopulated with the user's location (e.g., current location) as determined via location information provided by the user's mobile device (e.g., via a GPS receiver, Wi-Fi locator, and/or otherwise), as accessed from the user's profile, using the location used for a previously posted date, using a location manually entered or selected by the user, or otherwise. The user can tap or otherwise select the location user interface to change the location to a different location, where the user can search for a location or can manually enter a location.

Once the user accepts or enters a location, the location (“where to”) user interface is optionally presented, an example of which is illustrated in FIG. 19B. In this example, two high level categories are presented, “places” and “movies.” Additional or fewer high level categories may be used (e.g., eating, concerts, museums, parks, etc.). In this example, the user has selected “places” and has further selected “coffee.” The example user interface illustrated in FIG. 19C is presented, listing several corresponding venues (coffee houses in this example) in the user's geographical area. The venues may be identified from one or more databases of venues that include geo-location information for the venues. The user may select one of the listed venues (e.g., coffee houses), and the example user interface illustrated in FIG. 19D is optionally presented.

Referring to the example user interface illustrated in FIG. 19D, the name and address of the selected venue is presented. The user is queried to indicate how many wing guests/accompanying friends will be going on the date. In this example, several options are provided to the user via the example user interface. The user can select solo (meaning the user will not be bringing any friends), one wing guest, two wing guests, or three wing guests (of course, the user interface may enable the user to indicate more than three friends will be accompanying the user). Optionally, a given option (e.g., “solo”) may be preselected by default, and the user can keep the preselected option or may select another option. The user may activate a completion control (e.g., “go”) in order to indicate that the user has entered the requested data, and is to proceed to the next user interface.

Once the user indicates how many wing guests will be accompanying the user, the example user interface illustrated in FIG. 19E may optionally be presented by the user. The example user interface may optionally provide details of the selected venue, such as some or all of the following: hours of operations, contact information, its location on a map, ratings, etc. Some or all of the information may be obtained from a system database or from a remote database using an API (e.g., the venue database or a third party database), or otherwise. The user may activate a completion control (e.g., “go”) in order to indicate that the user has entered the requested data, and is to proceed to the next user interface.

Referring now to FIG. 19F, the example user interface instructs the user to indicate who will be paying for the entire date (or dates, as discussed below). In this example, the user is presented with three options, the posting user will pay (“me”), the parties to the date will each pay half (“50/50”), or the other party to the date will be paying for the entire date (“them”). Optionally, fewer or additional options may be offered (e.g., the options may include each party will pay for what that party orders). The example user interface also displays the name and address of the date venue (the coffee house name and address in this example). Optionally, a given option (e.g., 50/50) may be preselected by default, and the user can keep the preselected option or may select another option. The user may activate a completion control (e.g., “go”) in order to indicate that the user has entered the requested data, and is to proceed to the next user interface.

Referring now to FIG. 19G, the example user interface optionally instructs the user to select one or more calendar dates for dates having the characteristics entered by the user via the prior user interfaces. Thus, optionally the user can post multiple dates to the same venue in a single date posting process, where each date may also have the same payment specification (e.g., me, 50/50, them) and/or the same number of wing guests. This technique makes posting numerous dates particularly efficient and easy. For example, if a user has two season tickets for a sports team, the user can specify dates for multiple games at the same time. In this example, the user can scroll through different months via an electronic calendar, and select (e.g., by touch if the user device has a touch screen) multiple days on which the date is to be posted. As a default, the user interface may present the current month to the user initially, and optionally highlight the current calendar day. In this example, the user has selected two days (June 19 and June 18). The user may activate a completion control (e.g., “go”) in order to indicate that the user has entered the requested data, and is to proceed to the next user interface.

Referring now to FIG. 19H, an example user interface is provided via which the user can set the time for the date(s). The user may activate a completion control (e.g., “go”) in order to indicate that the user has entered the requested data, and is to proceed to the next user interface.

Referring now to FIG. 19I, an example optional date summary user interface is generated and provided for display on the user device. The various date characteristics are compiled (e.g., venue name, address, how many wing guests, who is paying, time of the date, calendar date(s) of the date, etc.) and presented via a single user interface using icons and/or text. The user interface enables the user to review and edit various date characteristics prior to posting the date. Once the user is satisfied with the date characteristics, the user can activate a posting control (e.g., “Post Up!”), and the date will be stored and posted by the system for viewing and searching by other users, as described elsewhere herein.

Thus, as described herein, certain embodiments provide a fast and efficient way for people to meet and arrange dates. Certain embodiments process date trend information to identify to users popular dates. Certain embodiments facilitate the identification and provision of advertisements relevant to a given posted date. Certain embodiments enable date posting information to be populated via an API from a date venue or event.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The results of the disclosed methods may be stored in any type of computer data repository, such as relational databases and flat file systems that use volatile and/or non-volatile memory (e.g., magnetic disk storage, optical storage, EEPROM and/or solid state RAM).

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise. Optionally, user interfaces may be provided with editing tools, enabling users to select, cut, copy, paste, undo, redo, and otherwise edit user provided content and/or other content.

The user terminals described herein may be in the form of a mobile communication device (e.g., a cell phone), laptop, tablet computer, interactive television, game console, media streaming device, head-wearable display, networked watch, etc. User inputs may be provided and received via a mouse, touch pad, touch screen, voice, or otherwise.

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the invention can be practiced in many ways. As is also stated above, the use of particular terminology when describing certain features or aspects of certain embodiments should not be taken to imply that the terminology is being re-defined herein to be restricted to including any specific characteristics of the features or aspects of the invention with which that terminology is associated.

What is claimed is:

1. A matching and calendaring system, the system comprising:
at least one processing device;
a posting module stored in non-transitory memory and executable by the at least one processing device, the posting module configured to enable a user to specify via a first interface information for a date posting, including at least date posting information for a first date comprising:
a first date venue;
scheduling information for the first date;
an indication as to whether the first user is to cover expenses for the first date, whether a second user that agrees to be a second participant to the first date is to cover the expenses for the first date, or whether the first user and the second user will each pay for a portion of the first date;
an indication as to whether the first user will be accompanied by friends on the first date;
a date posting population module, stored in non-transitory memory and executable by the at least one processing device, configured to populate the first date posting with at least one image of the first user and at least a portion of the date posting information specified by the first user;
a search engine configured to identify a first plurality of users, each having a date posting, wherein the first plurality of users includes the first user associated with the first date posting, at least partly in response to an action of the second user, and to provide at least the first date posting, including at least a portion of the date posting information specified by the first user, and at least the image of the first user, for display to the second user;
a module, stored in non-transitory memory and executable by the at least one processing device, configured to:
cause an invitation control to be displayed to the second user in association with the first date posting;
detect whether the second user activated the invitation control;
at least partly in response to detecting that the second user activated the invitation control, cause an invitation, to go on the first date corresponding to the first date posting of the first user, to be presented to the first user;
detect whether the first user accepted the invitation;
at least partly in response to detecting that the first user accepted the invitation:
notify the second user regarding the acceptance, and
generate a first calendar entry for the first date for a calendar of the first user, wherein the first calendar entry provides the first user with access to:
a time and calendar day for the first date;
at least one image of the second user;
an identifier associated with the second user;
an indication as to whether the first user is to cover expenses for the first date, whether a second user is to cover the expenses for the first date, or whether the first user and the second user will each pay for a portion of the first date;
an indication as to whether the first user will be accompanied by friends on the first date;
generate a second calendar entry for the first date for a calendar of the second user, wherein the second calendar entry provides the second user with access to:
the time and calendar day for the first date;
at least one image of the first user;
an identifier associated with the first user;
an indication as to whether the first user is to cover expenses for the first date, whether a second user is to cover the expenses for the first date, or whether the first user and the second user will each pay for a portion of the first date;
an indication as to whether the first user will be accompanied by friends on the first date;
cause the first calendar entry to appear in the calendar of the first user;
cause the second calendar entry to appear in the calendar of the second user.

2. The system as defined in claim 1, wherein the system is configured to:
cause the invitation to automatically expire if not accepted by the first user within a default period of time;
after the first invitation is presented to the first user, detect if the second user is attempting to send a second invitation to the first user for the first date, and at least partly in response to detecting that the second user is attempting to send a second invitation to the first user for the first date, inhibiting issuance of the second invitation to the first user;
present a plurality of dates, in response to a search request, in chronological order, based on at least calendar dates associated with respective dates identified in response to the search request;
enable the second user to search for posted dates using at least the following criteria:
date location,
who is to pay for the date, and
how many friends will be attending the date, and
calendar date.

3. The system as defined in claim 1, wherein the system is configured to cause the invitation to automatically expire if not accepted by the first user within a default period of time.

4. The system as defined in claim 1, wherein the system is configured to detect if the second user is attempting to send a second invitation to the first user for the first date after the first invitation is presented to the first user, and at least partly in response to detecting that the second user is attempting to send a second invitation to the first user for the first date, inhibiting presentation of the second invitation to the first user.

5. The system as defined in claim 1, wherein the system is configured to detect if the second user is attempting to send a second invitation to the first user, and at least partly in response to detecting that the second user is attempting to send a second invitation to the first user, notifying the second user that the second user had previously sent at least one invitation to the first user.

6. The system as defined in claim 1, wherein the system is configured to determine if the first user is attempting to post a second date on the same day as the first date and at a different time, and to inhibit the first user from posting the second date if the second date time is within a first time period after the first date time.

7. The system as defined in claim 1, wherein the system is configured to enable the second user to rate the first user after the first date has occurred, and to present the rating to other users.

8. The system as defined in claim 1, wherein the search engine is configured to present a plurality of dates, in response to a search request, in chronological order, based on at least calendar dates associated with respective dates identified by the search engine in response to the search request.

9. The system as defined in claim 1, wherein the search engine is configured to enable a at least one user to search for posted dates using at least the following criteria:
date location,
who is to pay for the date,
how many friends will be attending the date, and
calendar date.

10. The system as defined in claim 1, wherein the system is configured to automatically identify date postings for dates specified to take place on a current day within a specified geographical area, and cause at least a portion of the identified dates specified to take place on the current day within the specified geographical area to be presented to the first user in association with images of the users that posted the presented dates.

11. The system as defined in claim 1, wherein the system is configured to enable the first user and the second user to communicate via a first messaging system a specified period of time prior to the first date.

12. The system as defined in claim 1, wherein the system is configured to enable a given user to specify:
(i) favorite date venues, or
(ii) favorite activities, or
(iii) both (i) and (ii),
without specifying associated calendar days; and
based at least in part on (i), (ii) or (iii), identify posted dates from other users that correspond to (i), (ii) or (iii).

13. The system as defined in claim 1, wherein the system is configured to enable a given user to specify a watch list including other users, and based at least in part on the watch list, identify date postings posted by users on the watch list in substantially real time.

14. The system as defined in claim 1, wherein the system is configured to:
enable the second user to cause a plurality of invitations for dates to be transmitted to respective different users for dates to occur at substantially the same time;
detect an acceptance of a first of the plurality of invitations; and
at least partly in response to detecting the acceptance of the first of the plurality of invitations, cause other of the plurality of invitations to lapse.

15. The system as defined in claim 1, wherein the system is configured to:
access a data store storing information, including at least address information, related to a plurality of venues including the first date venue;
populate the first date posting with at least the address information for the first date venue.

16. The system as defined in claim 1, wherein the posting module if further configured to enable the first user to indicate that the user does not want to provide an indication as to whether the first user is to cover expenses for the first date, whether a second user that agrees to be a second participant to the second date is to cover the expenses for the first date, or whether the first user and the second user will each pay for a portion of the first date.

17. A computer implemented method, the method comprising:
generating, by a computer system comprising hardware, a first user interface to enable a first user to specify information for a date posting, including at least date posting information for a first date comprising:
a first date venue;
scheduling information for the first date;
an indication as to whether the first user is to cover expenses for the first date, whether a second user that agrees to be a second participant to the first date is to cover the expenses for the first date, or whether the first user and the second user will each pay for a portion of the first date;
providing the first user interface for display on a terminal of the first user;
populating, by the computer system, the first date posting with at least one image of the first user and at least a portion of the date posting information specified by the first user via the first user interface;
at least partly in response to an action of the second user, identifying, by a search engine comprising hardware, a first plurality of users, each having a date posting, wherein the first plurality of users includes the first user associated with the first date posting;
providing, by the computer system, at least the first date posting, including at least a portion of the date posting information specified by the first user, and at least the image of the first user, for display to the second user;
causing an invitation control to be displayed to the second user in association with the first date posting;
detecting, by the computer system, whether the second user activated the invitation control;
at least partly in response to detecting that the second user activated the invitation control, causing, by the computer system, an invitation, to go on the first date corresponding to the first date posting of the first user, to be presented to the first user via the user terminal;
detecting, by the computer system, whether the first user accepted the invitation;
at least partly in response to detecting that the first user accepted the invitation:
notifying the second user regarding the acceptance, and
generating, by the computer system, a first calendar entry for the first date for a calendar of the first user, wherein the first calendar entry provides the first user with access to:
a time and calendar day for the first date;
at least one image of the second user;
an identifier associated with the second user;
an indication as to whether the first user is to cover expenses for the first date, whether a second user is to cover the expenses for the first date, or whether the first user and the second user will each pay for a portion of the first date;
generating, by the computer system, a second calendar entry for the first date for a calendar of the second user, wherein the second calendar entry provides the second user with access to:
the time and calendar day for the first date;
at least one image of the first user;
an identifier associated with the first user;
an indication as to whether the first user is to cover expenses for the first date, whether a second user is to cover the expenses for the first date, or whether the first user and the second user will each pay for a portion of the first date.

18. The method as defined in claim 17, the method further comprising:
causing the invitation to automatically expire if not accepted by the first user within a default period of time;
detecting if the second user is attempting to send a second invitation to the first user for the first date after the first invitation is presented to the first user, and at least partly in response to detecting that the second user is attempting to send a second invitation to the first user for the first date, inhibiting presentation of the second invitation to the first user;
presenting a plurality of dates, in response to a search request, in chronological order, based on at least calendar dates associated with respective dates identified in response to the search request;
enabling at least one user to search for posted dates using at least the following criteria:
date location,
who is to pay for the date, and
calendar date.

19. The method as defined in claim 17, the method further comprising causing the invitation to automatically expire if not accepted by the first user within a default period of time.

20. The method as defined in claim 17, the method further comprising detecting if the second user is attempting to send a second invitation to the first user for the first date after the first invitation is presented to the first user, and at least partly in response to detecting that the second user is attempting to send a second invitation to the first user for the first date, inhibiting presentation of the second invitation to the first user.

21. The method as defined in claim 17, the method further comprising detecting if the second user is attempting to send a second invitation to the first user, and at least partly in response to detecting that the second user is attempting to send a second invitation to the first user, notifying the second user that the second user had previously sent at least one invitation to the first user.

22. The method as defined in claim 17, the method further comprising determining if the first user is attempting to post a second date on the same day as the first date and at a different time, and to inhibit the first user from posting the second date if the second date time is within a first time period after the first date time.

23. The method as defined in claim 17, the method further comprising enabling the second user to rate the first user after the first date has occurred, and to present the rating to other users.

24. The method as defined in claim 17, wherein the search engine is configured to present a plurality of dates, in response to a search request, in chronological order, based on at least the calendar dates associated with respective dates identified by the search engine in response to the search request.

25. The method as defined in claim 17, wherein the search engine is configured to enable a given user to search for posted dates using at least the following criteria:
date location,
who is to pay for the date,
how many friends will be attending the date, and
calendar date.

26. The method as defined in claim 17, the method further comprising automatically identifying date postings for dates specified to take place on a current day within a specified geographical area, and cause at least a portion of the identified dates specified to take place on the current day within the specified geographical area to be presented to the first user in association with images of the users that posted the presented dates.

27. The method as defined in claim 17, the method further comprising enabling the first user and the second user to communicate via a first messaging system a specified period of time prior to the first date.

28. The method as defined in claim 17, the method further comprising enabling a given user to specify:
(i) favorite date venues, or
(ii) favorite activities, or
(iii) both (i) and (ii),
without specifying associated calendar days; and
based at least in part on (i), (ii) or (iii), identify posted dates from other users that correspond to (i), (ii) or (iii).

29. The method as defined in claim 17, the method further comprising enabling a given user to specify a watch list including other users, and based at least in part on the watch list, identify date postings posted by users on the watch list in substantially real time.

30. The method as defined in claim 17, the method further comprising:
enabling the second user to cause a plurality of invitations for dates to be transmitted to respective different users for dates to occur at substantially the same time;
detecting an acceptance of a first of the plurality of invitations; and
at least partly in response to detecting the acceptance of the first of the plurality of invitations, causing other of the plurality of invitations to lapse.

31. The method as defined in claim 17, the method further comprising:
accessing a data store storing information, including at least address information, related to a plurality of venues including the first date venue;
populating the first date posting with at least the address information for the first date venue.

32. A non-transitory computer-readable storage medium storing computer-executable instructions that when executed by a processor perform operations comprising:
generating a first user interface to enable a first user to specify information for a date posting, including at least date posting information for a first date comprising:
a first date venue;
scheduling information for the first date;
an indication as to whether the first user is to cover expenses for the first date, whether a second user that agrees to be a second participant to the first date is to cover the expenses for the first date, or whether the first user and the second user will each pay for a portion of the first date;
providing the first user interface for display on a terminal of the first user;
populating the first date posting with at least one image of the first user and at least a portion of the date posting information specified by the first user via the first user interface;
at least partly in response to an action of the second user, identifying a first plurality of users, each having a date posting, wherein the first plurality of users includes the first user associated with the first date posting;
providing at least the first date posting, including at least a portion of the date posting information specified by the first user, and at least the image of the first user, for display to the second user;
causing an invitation control to be displayed to the second user in association with the first date posting;
detecting whether the second user activated the invitation control;
at least partly in response to detecting that the second user activated the invitation control, causing an invitation, to go on the first date corresponding to the first date posting of the first user, to be presented to the first user via the user terminal;
detecting whether the first user accepted the invitation;
at least partly in response to detecting that the first user accepted the invitation:
notifying the second user regarding the acceptance, and
generating a first calendar entry for the first date for a calendar of the first user, wherein the first calendar entry provides the first user with access to:
a time and calendar day for the first date;
at least one image of the second user;
an identifier associated with the second user;
an indication as to whether the first user is to cover expenses for the first date, whether a second user is to cover the expenses for the first date, or whether the first user and the second user will each pay for a portion of the first date;
generating a second calendar entry for the first date for a calendar of the second user, wherein the second calendar entry provides the second user with access to:
the time and calendar day for the first date;
at least one image of the first user;
an identifier associated with the first user;
an indication as to whether the first user is to cover expenses for the first date, whether a second user is to cover the expenses for the first date, or whether the first user and the second user will each pay for a portion of the first date.
